(19) United States
(12) Patent Application Publication
(10) Pub. No.: US 2017/0153712 A1
(43) Pub. Date: Jun. 1, 2017

(54) INPUT SYSTEM AND INPUT METHOD

(71) Applicant: FUJITSU LIMITED, Kawasaki-shi (JP)

(72) Inventors: Jun Kawai, Kawasaki (JP); Toshiaki Ando, Yokohama (JP)

(73) Assignee: FUJITSU LIMITED, Kawasaki-shi (JP)

(21) Appl. No.: 15/360,132

(22) Filed: Nov. 23, 2016

(30) Foreign Application Priority Data
Nov. 26, 2015 (JP) 2015-230878

(51) Int. Cl. G06F 3/01; G06T 7/00; H04N 13/04

(52) U.S. Cl. CPC G06F 3/017; H04N 13/04; H04N 13/0422; G06T 7/0075

(57) ABSTRACT

An input system includes a display device configured to display a stereoscopic image including a display surface having a plurality of buttons in a three-dimensional space, a detector configured to detect an object inputting on the stereoscopic image, and an information processing device configured to notify a user of an amount in a depth direction of the display surface, from when an input state by the object is a provisional selection state to when the input state by the object is a determination state. The amount is an additional numerical value indicating how much the object has to move in the depth direction to set the input state to be the determination state, the provisional selection state is set when the object is in contact with a button among the plurality of buttons, and the determination state is set when the object is moved by the amount.

### CROSS-REFERENCE TO RELATED APPLICATION

This application is based upon and claims the benefit of priority of the prior Japanese Patent Application No. 2015-230878, filed on Nov. 26, 2015, the entire contents of which are incorporated herein by reference.

### FIELD

The embodiments discussed herein are related to an input device and method which inputs information.

### BACKGROUND

A device which determines an input by performing a predetermined operation on a stereoscopic image displayed on a three-dimensional space has been known as one of input devices (for example, see Japanese Laid-open Patent Publication No. 2012-248067 and Japanese Laid-open Patent Publication No. 2011-175623).

In this type of input device, in a case of detecting a predetermined real object such as a fingertip of an operator in a display space of a stereoscopic image, the position of the real object in the display space is calculated. The input device determines the presence or absence of a button that is selected as an operation target by the operator, based on the positional relationship between the display position of an operation button (hereinafter, simply referred to as a “button”) in the stereoscopic image and the position of the fingertip of the operator. When detecting the movement of the fingertip of the operator in the depth direction for a predetermined amount in a state where a certain button is selected as an operation target, the input device determines the input of information corresponding to the selected button.

### SUMMARY

According to an aspect of the invention, an input system performs a plurality of operations on a stereoscopic image displayed on a three-dimensional space. The input system includes a display device configured to display the stereoscopic image including a display surface having a plurality of buttons in the three-dimensional space, the plurality of buttons being associated with the plurality of operations, a detector configured to detect an object inputting on the stereoscopic image, and an information processing device comprising a memory and a processor configured to notify a user, who performs an inputting operation on the stereoscopic image, of an amount in a depth direction of the display surface, from when an input state by the object is a provisional selection state to when the input state by the object is a determination state. The amount is an additional numerical value indicating how much the object has to move in the depth direction to set the input state to be the determination state, the provisional selection state is set when the object is in contact with a button among the plurality of buttons, and the determination state is set when the object is moved by the amount.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a first configuration example of an input device;

FIG. 2 is a diagram illustrating a second configuration example of the input device;

FIG. 3 is a diagram illustrating a third configuration example of the input device;

FIG. 4 is a diagram illustrating a fourth configuration example of the input device;

FIG. 5 is a diagram illustrating an example of a stereoscopic image to be displayed in the input device according to the first embodiment;

FIG. 6 is a diagram illustrating an example of images of buttons in the stereoscopic image;

FIG. 7A is a diagram illustrating transition of a stereoscopic image when performing an operation to press a button (Part 1);

FIG. 7B is a diagram illustrating transition of the stereoscopic image when performing the operation to press the button (Part 2);

FIG. 8 is a diagram illustrating an example of operation display image data used for displaying the stereoscopic image;

FIG. 9 is a diagram illustrating an “input determination” range and a determination state maintenance range;

FIG. 10 is a diagram illustrating a functional configuration of the information processing device according to the first embodiment;

FIG. 11 is a diagram illustrating a functional configuration of a generated image designation unit according to the first embodiment;

FIG. 12 is a flowchart illustrating a process that the information processing device according to the first embodiment performs;

FIG. 13 is a flowchart illustrating a process of calculating the relative position between the button and the fingertip;

FIG. 14 is a diagram illustrating an example of a spatial coordinate system of the input device;

FIG. 15A is a diagram illustrating an example of display coordinates in a spatial coordinate system of the display device (Part 1);

FIG. 15B is a diagram illustrating an example of display coordinates in a spatial coordinate system of the display device (Part 2);

FIG. 16 is a diagram illustrating an example of another spatial coordinate system of the input device;

FIG. 17A is a flowchart illustrating an input state determination process in the first embodiment (Part 1);

FIG. 17B is a flowchart illustrating the input state determination process in the first embodiment (Part 2);

FIG. 17C is a flowchart illustrating the input state determination process in the first embodiment (Part 3);

FIG. 18A is a flowchart illustrating a generated image designation process in the first embodiment (Part 1);

FIG. 18B is a flowchart illustrating the generated image designation process in the first embodiment (Part 2);

FIG. 18C is a flowchart illustrating the generated image designation process in the first embodiment (Part 3);

FIG. 19 is a diagram illustrating a process to hide an adjacent button;

FIG. 20 is a diagram illustrating an example of a method of determining whether or not to hide the adjacent button;

FIG. 21 is a diagram illustrating an allowable range for the deviation of the fingertip coordinates during pressing;

FIG. 22 is a diagram illustrating another example of the images of the buttons of “provisional selection” and “during pressing”;

FIG. 23 is a diagram illustrating another example of a method of displaying the input determination frame;

FIG. 24A is a diagram illustrating an example of three-dimensional display of a button (Part 1);

FIG. 24B is a diagram illustrating an example of three-dimensional display of the button (Part 2);

FIG. 25 is a diagram illustrating another example of three-dimensional display of the button;

FIG. 26 is a diagram illustrating an example of movement during input determination;

FIG. 27 is a diagram illustrating another example of movement during input determination;

FIG. 28 is a diagram illustrating still another example of movement during input determination;

FIG. 29 is a diagram illustrating a modification example of a movement direction of a stereoscopic image;

FIG. 30 is a diagram illustrating a modification example of a display shape of a stereoscopic image;

FIG. 31 is a diagram illustrating an example of an input operation using a stereoscopic image including a plurality of operation screens;

FIG. 32 is a diagram illustrating an example of a hierarchical structure of an operation to select a meal menu;

FIG. 33 is a diagram illustrating a display example of operation screens of a second hierarchy and a third hierarchy when the button displayed on an operation screen of a first hierarchy is pressed;

FIG. 34 is a diagram illustrating an example of a screen transition when the operation to select the meal menu is performed;

FIG. 35 is a diagram illustrating an application example of the input device according to the first embodiment;

FIG. 36 is a diagram illustrating a functional configuration of the information processing device of the input device according to the second embodiment;

FIG. 37 is a diagram illustrating a functional configuration of the generated image designation unit according to the second embodiment;

FIG. 38A is a flowchart illustrating a process that the information processing device according to the second embodiment performs (Part 1);

FIG. 38B is a flowchart illustrating a process that the information processing device according to the second embodiment performs (Part 2);

FIG. 39A is a flowchart illustrating a generated image designation process in the second embodiment (Part 1);

FIG. 39B is a flowchart illustrating the generated image designation process in the second embodiment (Part 2);

FIG. 39C is a flowchart illustrating the generated image designation process in the second embodiment (Part 3);

FIG. 39D is a flowchart illustrating the generated image designation process in the second embodiment (Part 4);

FIG. 40 is a diagram illustrating a first example of a method of expanding the display size of a button;

FIG. 41 is a diagram illustrating a second example of a method of expanding the display size of the button;

FIG. 42 is a diagram illustrating a third example of a method of expanding the display size of the button;

FIG. 43A is a flowchart illustrating a process that an information processing device according to the third embodiment performs (Part 1);

FIG. 43B is a flowchart illustrating a process that the information processing device according to the third embodiment performs (Part 2);

FIG. 44 is a diagram illustrating a configuration example of an input device according to a fourth embodiment;

FIG. 45 is a graph illustrating an injection pattern of compressed air;

FIG. 46 is a diagram illustrating another configuration example of the input device according to the fourth embodiment; and

FIG. 47 is a diagram illustrating a hardware configuration of a computer.

### DESCRIPTION OF EMBODIMENTS

In the above input device, for example, in a case where the operator performs an operation to press the button that the operator selects as an operation target, the display size of the button is reduced depending on the amount of movement in the depth direction, which gives the operator a sense as if the button goes away.

However, in the above input device, the user feels only a sense of perspective depending on the display size of the button, and the user does not know which amount the user moves the fingertip in a depth direction when pressing the button in order to determine the input. There is no movement range in the depth direction in the operation to press the stereoscopic image (button) displayed in the three-dimensional space, unlike when the user presses the button of a real object. Therefore, in this type of input device, it is difficult to know the amount of movement of the fingertip for determining the input. Therefore, in a case where the user (operator) is inexperienced in the operation of this type of input device, it is difficult to smoothly perform an input, and an input error is likely to occur.

In an aspect, the object of the present disclosure is to improve the operability of the input device for inputting information by pressing a button that is three-dimensional displayed.

Configuration Examples of Input Device

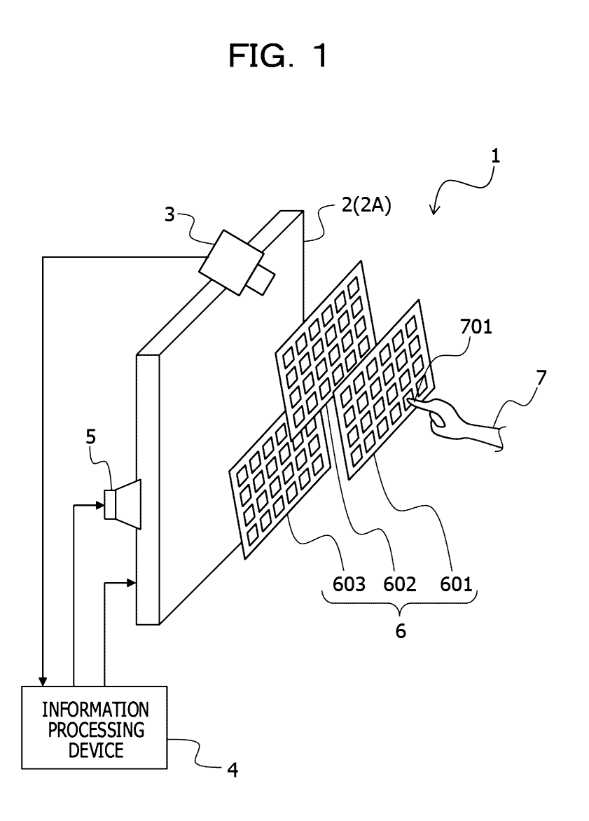

First, configuration examples of input devices according to the present disclosure will be described with reference to FIG. 1 to FIG. 4.

FIG. 1 is a diagram illustrating a first configuration example of the input device.

As illustrated in FIG. 1, an input device 1 of the first configuration example includes a display device 2 (2A), a distance sensor 3, an information processing device 4, and a speaker 5.

The display device 2A is a device that displays the stereoscopic image 6 (601, 602, 603) in the three-dimensional space outside the device. The display device 2A illustrated in FIG. 1 is a stereoscopic image display device such as a naked eye 3D liquid crystal display, and a liquid crystal shutter glasses-type 3D display. This type of display device 2A displays the stereoscopic image 6 in the space between the operator 7 and the display device 2A. The stereoscopic image 6 illustrated in FIG. 1 includes three planar operation screens 601, 602, and 603. A plurality of operation buttons are displayed on the respective operation screens 601, 602, and 603. The respective buttons are associated with the processes that the input device 1 (information processing device 4) performs.

The distance sensor 3 detects the presence or absence of the finger of the operator within a predetermined spatial area including a spatial area in which the stereoscopic image 6 is displayed, information concerning the distance from the stereoscopic image 6, and the like.

The information processing device 4 determines the input state corresponding to the operation that the operator performs, based on the detection result of the distance sensor 3, and generates the stereoscopic image 6 according to the determination result (input state). The information processing device 4 displays the generated stereoscopic image 6 on the display device 2. In a case where the operation that the operator performs corresponds to a predetermined input state, the information processing device 4 generates a sound corresponding to the predetermined input state, and outputs the sound to the speaker 5.

In the input device 1 of FIG. 1, if it is detected that the fingertip 701 of the operator 7 is in contact with the button image that is included in the stereoscopic image 6 (the operation screen 601, 602, and 603), the input state becomes “provisional selection”. Thereafter, if the fingertip 701, with which the operator 7 performs an operation to press the button image, reaches the input determination position, the input device 1 determines the input state as “input determination”. If the input state becomes “input determination”, the input device 1 performs the process that is associated with the button that the operator 7 presses.

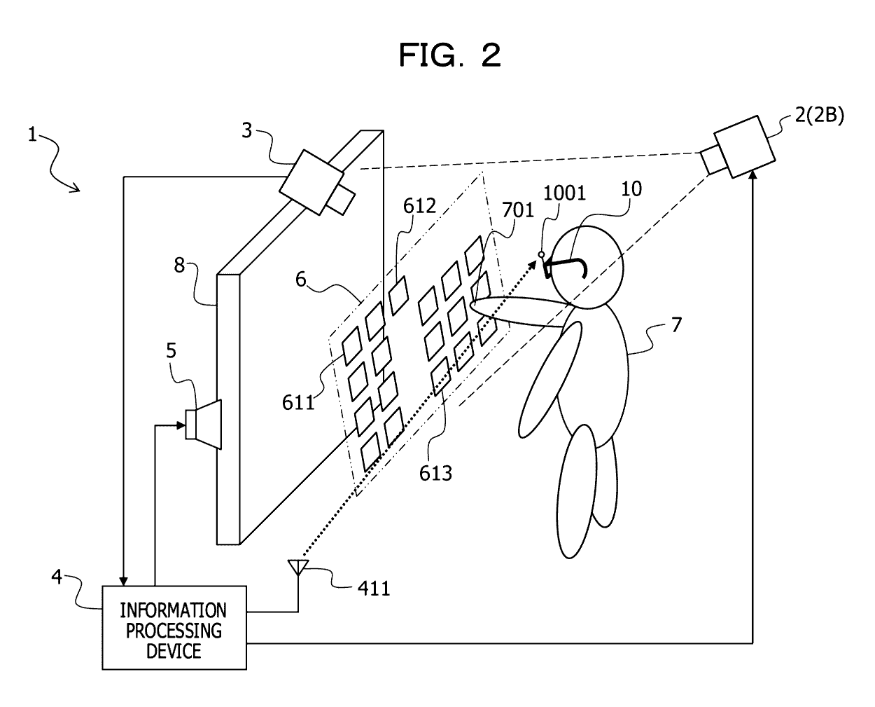

FIG. 2 is a diagram illustrating a second configuration example of the input device.

As illustrated in FIG. 2, an input device 1 of the second configuration example includes a display device 2 (2B), a distance sensor 3, an information processing device 4, a speaker 5, a screen 8, and stereoscopic glasses 10.

The display device 2B is a device that displays the stereoscopic image 6 in the three-dimensional space outside the device. The display device 2B illustrated in FIG. 2 is, for example, a 3D projector of a wearing glasses type such as a liquid crystal shutter type, and projects an image for the left eye and an image for the right eye while switching them at a predetermined time interval on the screen 8 from the rear of the operator who is opposed to the screen 8 with each other. This type of display device 2B displays the stereoscopic image 6 in the space between the operator 7 and the screen 8. Since the operator 7 observes a predetermined spatial area while wearing the stereoscopic glasses 10 that switch the state (ON) in which the image is viewed and the state (OFF) in which the image is not viewed in synchronism with the switching timing of the projection image of the display device 2B, this allows the operator to view the stereoscopic image 6. The stereoscopic image 6 illustrated in FIG. 2 is an image in which the images 611, 612, and 613 of operation buttons are two-dimensionally arranged in a predetermined plane. The images 611, 612, 613 of the buttons are associated with the processes that the input device 1 (information processing device 4) performs.

The distance sensor 3 detects the presence or absence of the finger of the operator within a predetermined spatial area including a spatial area in which the stereoscopic image 6 is displayed, information concerning the distance from the stereoscopic image 6, and the like.

The information processing device 4 determines the input state corresponding to the operation that the operator performs, based on the detection result of the distance sensor 3, and generates the stereoscopic image 6 according to the determination result (input state). The information processing device 4 displays the generated stereoscopic image 6 on the display device 2. In a case where the operation that the operator performs corresponds to a predetermined input state, the information processing device 4 generates a sound corresponding to the predetermined input state, and outputs the sound to the speaker 5.

The input device 1 of FIG. 2 performs wireless communication between the antenna 411 of the information processing device 4 and the antenna 1001 of the stereoscopic glasses 10 so as to control the operation of the stereoscopic glasses 10. The information processing device 4 and the stereoscopic glasses 10 may be connected through a communication cable.

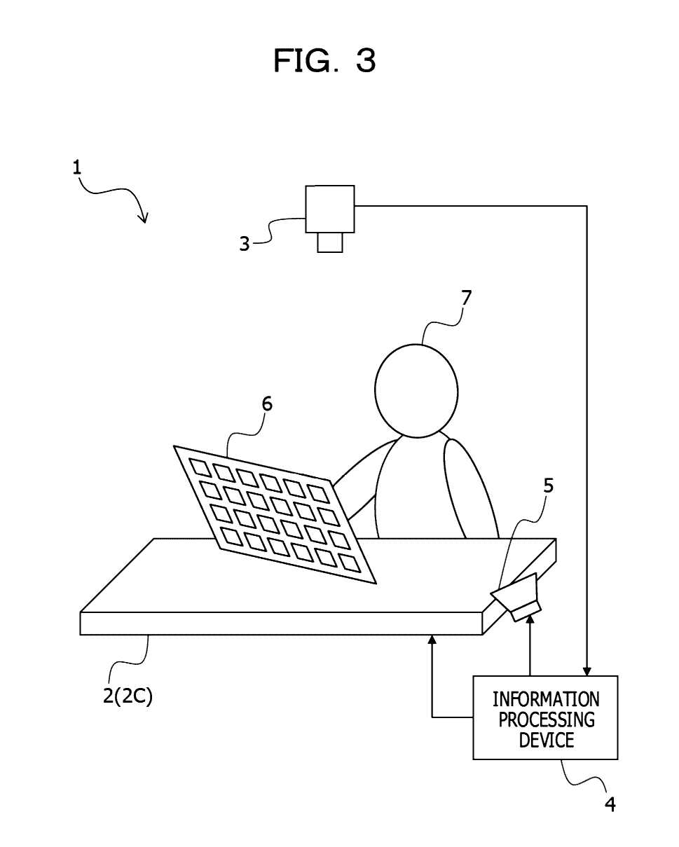

FIG. 3 is a diagram illustrating a third configuration example of the input device.

As illustrated in FIG. 3, an input device 1 of the third configuration example includes a display device 2 (2C), a distance sensor 3, an information processing device 4, and a speaker 5.

The display device 2C is a device that displays the stereoscopic image 6 in the three-dimensional space outside the device. The display device 2C illustrated in FIG. 3, for example, is a 3D projector of a wearing glasses type such as a liquid crystal shutter type, and is provided in the direction of displaying the stereoscopic image 6 on the upper side of the display device 2C. The stereoscopic image 6 illustrated in FIG. 3 is an image of a planar operation screen in which images of operation buttons are arranged two-dimensionally in a plane. The images of the buttons are associated with the processes that the input device 1 (information processing device 4) performs.

The distance sensor 3 detects the presence or absence of the finger of the operator within a predetermined spatial area including a spatial area in which the stereoscopic image 6 is displayed, information concerning the distance from the stereoscopic image 6, and the like.

The information processing device 4 determines the input state corresponding to the operation that the operator performs, based on the detection result of the distance sensor 3, and generates the stereoscopic image 6 according to the determination result (input state). The information processing device 4 displays the generated stereoscopic image 6 on the display device 2. In a case where the operation that the operator performs corresponds to a predetermined input state, the information processing device 4 generates a sound corresponding to the predetermined input state, and outputs the sound to the speaker 5.

The display device 2C of the input device 1 of FIG. 3 is, for example, disposed on the top plate of the table. Further, the distance sensor 3 is disposed above the top plate of the table.

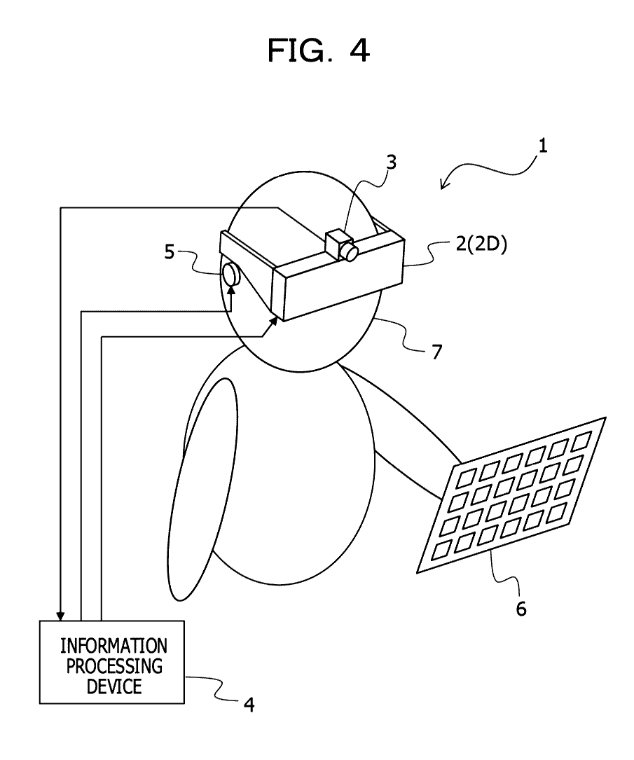

FIG. 4 is a diagram illustrating a fourth configuration example of the input device.

As illustrated in FIG. 4, an input device 1 of the fourth configuration example includes a display device 2 (2D), a distance sensor 3, an information processing device 4, and a speaker 5.

The display device 2D is a head mount display (HMD), and is a device that displays an image in which the stereoscopic image 6 is displayed in the three-dimensional space outside the device, to the operator 7. Since the input device 1 with this type of display device 2D displays, for example, a composite image in which the image of the outside of the device and the stereoscopic image 6 are combined, on a display device (an image display surface) provided in the display device 2D, which gives the operator 7 a sense as if the stereoscopic image 6 is present in the front. The stereoscopic image 6 illustrated in FIG. 4 is an image in which the images of operation buttons are two-dimensionally arranged in a plane. The images of the respective buttons are associated with the processes that the input device 1 (information processing device 4) performs.

The distance sensor 3 detects the presence or absence of the finger of the operator within a predetermined spatial area (within a spatial area in which the stereoscopic image 6 is displayed) which is displayed in the display device 2D, information concerning the distance from the stereoscopic image 6, and the like.

The information processing device 4 determines the input state corresponding to the operation that the operator performs, based on the detection result of the distance sensor 3, and generates the stereoscopic image 6 according to the determination result (input state). The information processing device 4 displays the generated stereoscopic image 6 on the display device 2. In a case where the operation that the operator performs corresponds to a predetermined input state, the information processing device 4 generates a sound corresponding to the predetermined input state, and outputs the sound to the speaker 5.

As described above, in a case where the operator 7 performs an operation to press down the button image included in the stereoscopic image 6 which is displayed in the three-dimensional space outside the display device 2, the input device 1 determines the input state, and performs the process according to the determination results. In addition, the detection of the presence or absence of the finger of the operator and the information concerning the distance from the stereoscopic image 6 in the input device 1 is not only performed by the distance sensor 3, and can be performed by using a stereo camera or the like. In the present specification, the input state is determined according to a change in the position of the fingertip 701 of the operator, but without being limited to the fingertip 701, the input device 1 can also determine the input state according to a change in the tip position of a rod-like real object.

### First Embodiment

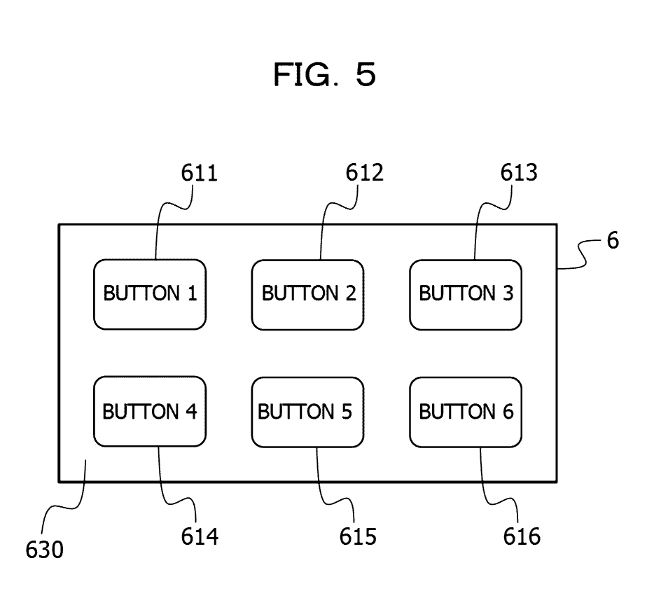

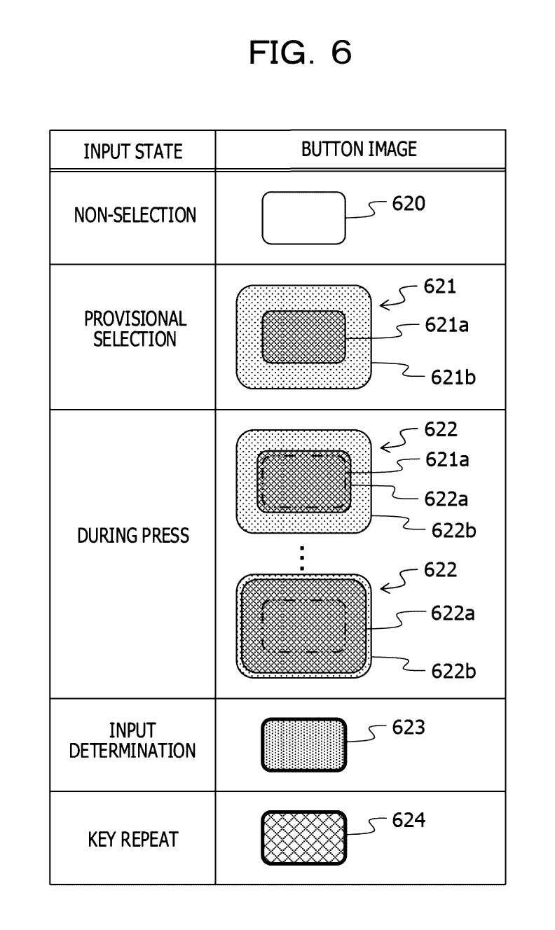

FIG. 5 is a diagram illustrating an example of a stereoscopic image to be displayed in the input device according to the first embodiment. FIG. 6 is a diagram illustrating an example of images of buttons in the stereoscopic image.

For example, the stereoscopic image 6 as illustrated in FIG. 5 is displayed in the three-dimensional space, in the input device 1 of the first embodiment. The stereoscopic image 6 illustrated in FIG. 5 includes six buttons (611, 612, 613, 614, 615, and 616), and a background 630. Respective predetermined processes are assigned to the six buttons (611, 612, 613, 614, 615, and 616). If the operator 7 performs an operation of touching and pressing any of the buttons with the fingertip 701 or the like, the input device 1 detects the operation and changes the button image depending on the input state. As illustrated in FIG. 6, the input state includes “non-selection”, “provisional selection”, “during press”, “input determination”, and “key repeat”.

“Non-selection” is the input state in which the fingertip 701 of the operator 7 or the like is not in contact. The button image 620 of which the input state is “non-selection” is an image of a predetermined size, and of a color that indicates “non-selection”.

“Provisional selection” is an input state where the button is touched with the fingertip 701 of the operator 7 or the like to become a candidate for the press operation, in other words, the button is selected as an operation target. The button image 621 in a case where the input state is “provisional selection” is an image having a larger size than the button image 620 of “non-selection”, and includes an area 621a indicating “provisional selection” in the image. The area 621a has the same shape as and a different color from the button image 620 of “non-selection”. The outer periphery 621b of the button image 621 of “provisional selection” functions as an input determination frame.

“During press” is an input state where the target of press operation (input operation) is selected by the operator 7 and an operation to press a button is being performed by the operator 7. The button image 622 in the case where the input state is “during press” has the same size as the button image 621 of “provisional selection”, and includes an area 621b indicating “during press” in the image. The area 621b has the same color as and a different size from the area 621a of the button image 621 of “provisional selection”. The size of the area 622a of the button image 622 of “during press” changes depending on the press amount of the button, and the larger the press amount is, the larger the size of the area 622a is. An outer periphery 622b of the button image 622 of “during press” functions as the input determination frame described above. In other words, the outer periphery 622b of the button image 622 indicates that if the outer periphery of the area 622a overlaps with the outer periphery 622b, the input is determined.

“Input determination” is an input state where the fingertip 701 of the operator 7 who performs an operation to press the button reaches a predetermined “input determination” point, and the input of information associated with the button is determined. The button image 623 of which the input state is “input determination” has the same shape and the same size as the button image 620 of “non-selection”. The button image 623 of “input determination” has a different color from the button image 620 of “non-selection” and the button image 621 of “provisional selection”. Further, the button image 623 of “input determination” has a thicker line of the outer periphery, as compared with, for example, the button image 620 of “non-selection” and the button 621 of “provisional selection”.

“Key repeat” is an input state where the fingertip 701 of the operator 7 remains in a predetermined determination state continue range for a predetermined period of time or more after input is determined, and the input of information is repeated. The button image 624 in a case where the input state is “key repeat” has the same shape and the same size as the button image 624 of “input determination”. The button image 623 of “input determination” has the different color from the button image 624 of “input determination”, as well as the button image 620 of “non-selection” and the button 621 of “provisional selection”.

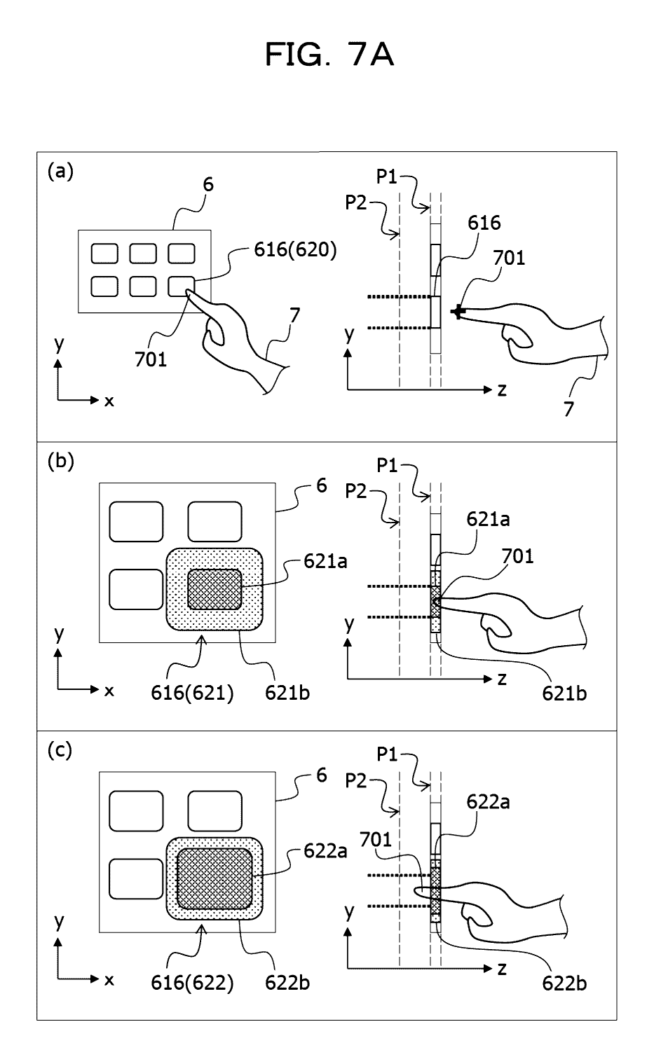

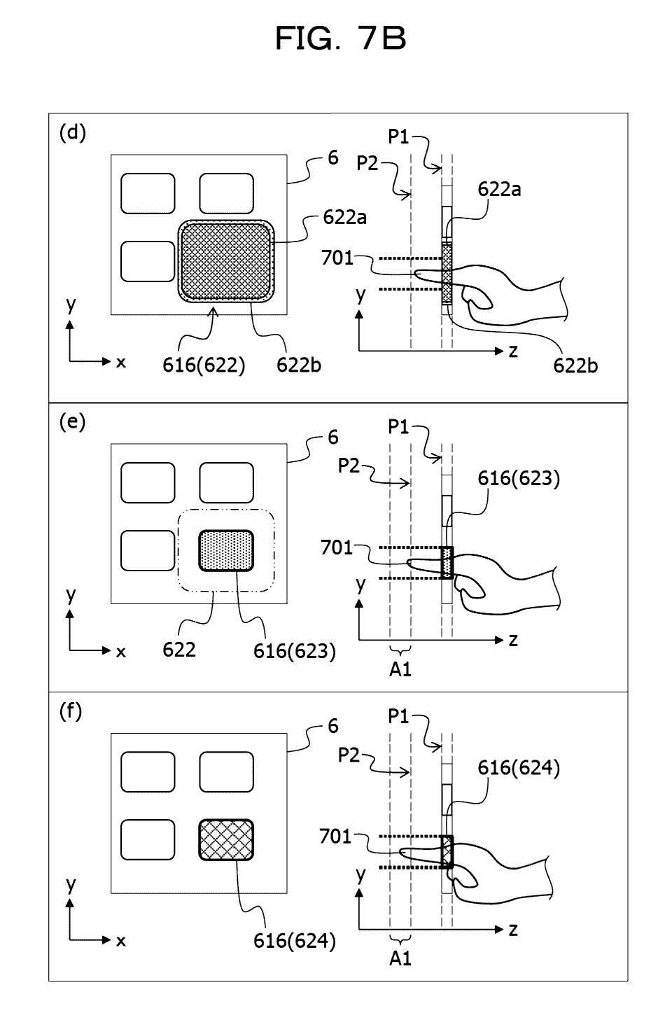

FIG. 7A is a diagram illustrating transition of a stereoscopic image when performing an operation to press a button (Part 1). FIG. 7B is a diagram illustrating transition of the stereoscopic image when performing the operation to press the button (Part 2). In (a), (b), and (c) of FIG. 7A and (d), (e), and (f) of FIG. 7B, the drawings on the left side is a drawing of an xy plane illustrating the stereoscopic image viewed from the operator, and the drawings on the right side is a drawing of an yz plane orthogonal to the xy plane.

First, the input device 1 (the information processing device 4) according to the present embodiment generates a stereoscopic image 6 of which the input states of all buttons are “non-selection” and displays the stereoscopic image 6 in the three-dimensional space, as illustrated in (a) of FIG. 7A. An input determination point (input determination surface) P2 is set on the far side in the depth direction of the display surface P1 of the stereoscopic image 6, as viewed from the operator 7. As illustrated in (a) of FIG. 7A, even in a case where the fingertip 701 of the operator 7 points the button 616 of the stereoscopic image 6, only if the position of the fingertip 701 is within a predetermined depth range including the display surface P1, the button 616 has still the button image 620 of “non-selection”.

If the fingertip 701 of the operator 7 enters the provisional selection area, the input device 1 changes the image of the button 616 that is touched by the fingertip 701 from the button image 620 of “non-selection” to the button image 621 of “provisional selection”, as illustrated in (b) of FIG. 7A. Further, if the fingertip 701 of the operator 7 is moved in a direction (−z direction) to press the button, as illustrated in (c) of FIG. 7A and (d) of FIG. 7B, the image of the button 616 which is designated (selected) by the fingertip 701 is changed at any time to the button image 622 of “during press” according to the amount of movement of the fingertip.

If the fingertip 701 of the operator 7 reaches the input determination point P2, the input device 1 changes the image of the button 616 that is designated (selected) by the fingertip 701 from the button image 622 of “during press” to the button image 623 of “input determination”, as illustrated in (e) of FIG. 7B. Further, after the input is determined, in a case where the fingertip 701 of the operator 7 remains for a predetermined period of time or more in a determination state maintenance range A1, the input device 1 changes the image of the button 616 that is designated (selected) by the fingertip 701 to the button image 624 of “key repeat”, as illustrated in (f) of FIG. 7B.

In this way, the input device 1 of the present embodiment displays an input determination frame for the button of which the input state is “provisional selection” or “during press”. Further, the input device 1 changes the size of the area 622a that is included in the button image 622 according to the press amount, for the button of “during press”. Therefore, the operator 7 can intuitively recognize that the button is selected as an operation target, and a distance that the user is to press a button in order to determine an input.

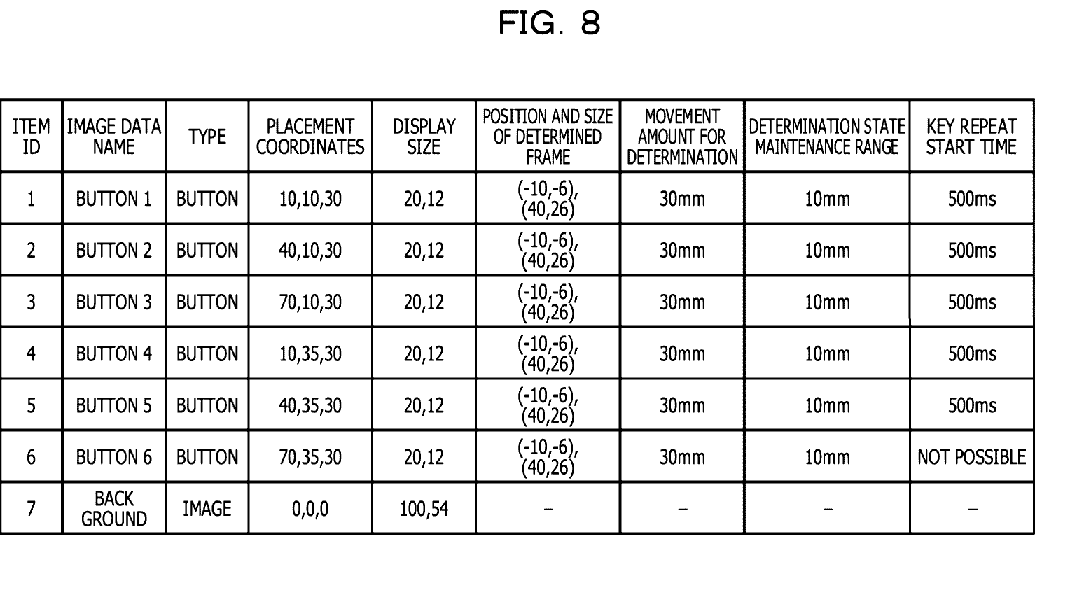

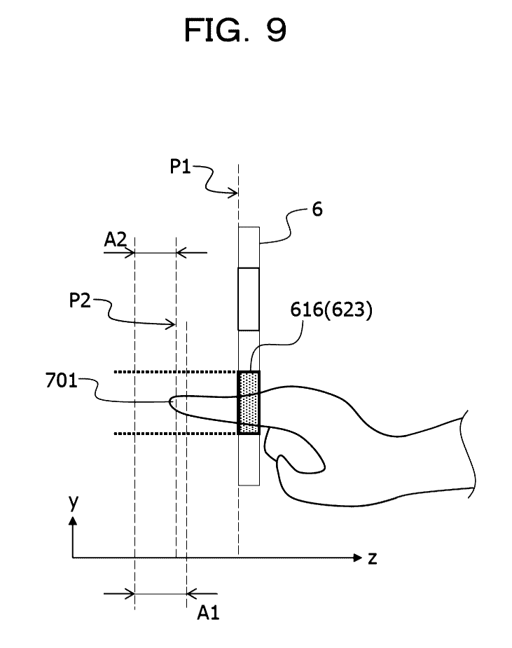

FIG. 8 is a diagram illustrating an example of operation display image data used for displaying the stereoscopic image. FIG. 9 is a diagram illustrating an “input determination” range and the determination state maintenance range.

The information processing device 4 of the input device 1 generates the stereoscopic image 6 as illustrated in FIG. 5, for example, by using operation display image data, and displays the stereoscopic image 6 on the display device 2. The operation display image data includes, for example, as illustrated in FIG. 8, an item ID, an image data name, a type, placement coordinates, and a display size. Further, the operation display image data includes the position and size of a determination frame, a movement amount for determination, and a determination state maintenance range, and a key repeat start time.

The item ID is a value for identifying elements (images) that are included in the stereoscopic image 6. The image data name and type is information for designating the type of the image of each item. The placement coordinates and the display size are information for respectively designating the display position and the display size of each item in the stereoscopic image 6. The position and the size of a determination frame are information for designating the display position and the display size of the input determination frame which is displayed in a case where the input state is “provisional selection” or “during press”. The movement amount for determination is information indicating which distance the finger of the operator is moved by in the depth direction after the input state transitions to “provisional selection” in order to change the input state to “input determination”. The determination state maintenance range is information for designating a range of the position of the fingertip which is maintained at the state of “input determination” after the input state transitions to “input determination”. The key repeat start time is information indicating a time from the input state is shifted to “input determination” until the start of “key repeat”. The movement amount for determination of the operation display image data represents, for example, as illustrated in FIG. 9, a distance in the depth direction from the display surface P1 of the stereoscopic image 6 to the input determination point P2. In other words, if the fingertip 701 of the operator 7 passes through the button 616 indicated by the display surface P1 and reaches the input determination point P2, the input device 1 determines the input of information associated with the button 616. However, there is no object to block the movement of the fingertip 701 of the operator 7 in the depth direction in the input determination point P2. Therefore, it is difficult for the operator to stop the movement of the fingertip when it reaches the input determination point P2, and the fingertip 701 is likely to move further towards the depth far beyond the input determination point P2. Therefore, as illustrated in FIG. 9, a predetermined range from the input determination point P2 to a further side in the depth direction is assumed to an input determination range A2, and if the movement of the fingertip 701 in the depth direction (the pressing direction) is stopped in an input determination range A2, the input state may be “input determination”. In this case, the input determination range A2 may be added to the operation image display data illustrated in FIG. 9.

Further, in a case of continuing the state of “input determination”, the operator 7 has to maintain the position of the fingertip 701 in the determination state maintenance range A1 in the three-dimensional space, but it is difficult to fix the position of the fingertip in the three-dimensional space. Therefore, the determination state maintenance range A2 to measure the continuation time of the input determination state may be included on the front side (+z direction) of the depth direction than the input determination point P2 as illustrated in FIG. 9.

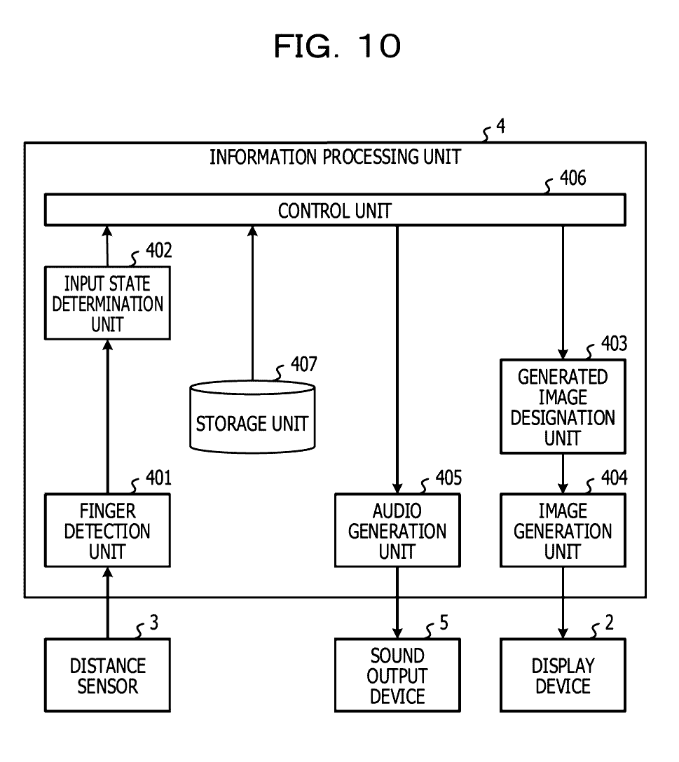

FIG. 10 is a diagram illustrating a functional configuration of the information processing device according to the first embodiment.

As illustrated in FIG. 10, the information processing device 4 according to the first embodiment includes a finger detection unit 401, an input state determination unit 402, a generated image designation unit 403, an image generation unit 404, an audio generation unit 405, a control unit 406, and a storage unit 407.

The finger detection unit 401 determines the presence or absence of the finger of the operator, and calculates a distance from the stereoscopic image 6 to the fingertip in a case where the finger is present, based on the information obtained from the distance sensor 3.

The input state determination unit 402 determines the current input state, based on the detection result from the finger detection unit 401 and the immediately preceding input state. The input state includes “non-selection”, “provisional selection”, “during press”, “input determination”, and “key repeat”. The input state further includes “movement during input determination”. “Movement during input determination” is a state of moving the stereoscopic image 6 including a button for which the state of “input determination” is continued, in the three-dimensional space.

The generated image designation unit 403 designates an image generated based on the immediately preceding input state and the current input state, in other words, the information for generating the stereoscopic image 6 to be displayed.

The image generation unit 404 generates the display data of the stereoscopic image 6 according to designated information from the generated image designation unit 403, and outputs the display data to the display device 2.

The audio generation unit 405 generates a sound signal to be output when the input state is a predetermined state. For example, when the input state is changed from “during press” to “input determination” or when the input determination state continues for a predetermined period of time, the audio generation unit 405 generates a sound signal.

The control unit 406 controls the operations of the generated image designation unit 403 and the audio generation unit 405, based on the immediately preceding input state and the determination result of the input state determination unit 402. The immediately preceding input state is stored in a buffer provided in the control unit 406, or is stored in the storage unit 407. When causing the display device 2 to display an image indicating the change in the press amount of the button depending on the change in the position of the finger that the finger detection unit 401 detects, the control unit 406 controls the display device 2 to display how much the press amount of the button is relative to the press amount for determining input of the button.

The storage unit 407 stores an operation display image data group, and an output sound data group. The operation display image data group is a set of a plurality of pieces of operation display image data (see FIG. 8) which are prepared for each stereoscopic image 6. The output sound data group is a set of data used when the audio generation unit 405 generates a sound.

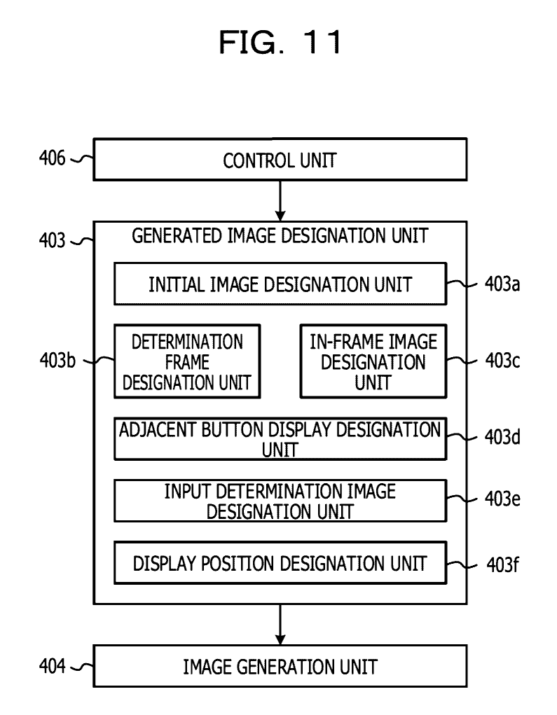

FIG. 11 is a diagram illustrating a functional configuration of the generated image designation unit according to the first embodiment.

The generated image designation unit 403 designates information for generating the stereoscopic image 6 to be displayed, as described above. As illustrated in FIG. 11, the generated image designation unit 403 includes an initial image designation unit 403a, a determination frame designation unit 403b, an in-frame image designation unit 403c, an adjacent button display designation unit 403d, an input determination image designation unit 403e, and a display position designation unit 403f.

The initial image designation unit 403a designates information for generating the stereoscopic image 6 in the case where the input state is the “non-selection”. The determination frame designation unit 403b designates information about an input determination frame of an image of the button of which input state is “provisional selection” or “during press”. The in-frame image designation unit 403c designates information about the input determination frame of the image of the button of which the input state is “provisional selection” or “during press”, in other words, information about the area 621a of the button image 621 of “provisional selection” and the area 622a of the button image 622 of “during press”. The adjacent button display designation unit 403d designates the display/non-display of other buttons which are adjacent to the button of which the input state is “provisional selection” or “during press”. The input determination image designation unit 403e designates the information about the image of the button of which the input state is “input determination”. The display position designation unit 403f designates the display position of the stereoscopic image including the button of which the input state is “movement during input determination” or the like.

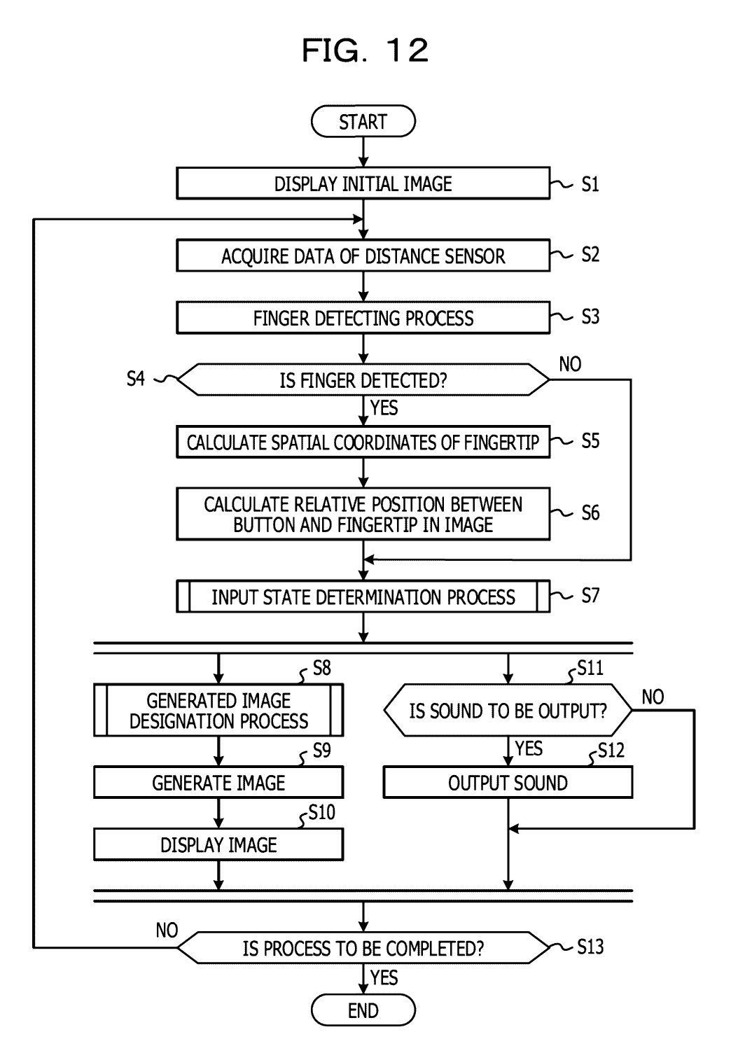

FIG. 12 is a flowchart illustrating a process that the information processing device according to the first embodiment performs.

As illustrated in FIG. 12, the information processing device 4 according to the first embodiment first displays an initial image (step S1). In step S1, in the information processing device 4, the initial image designation unit 403a of the generated image designation unit 403 designates information for generating the stereoscopic image 6 in a case where the input state is “non-selection”, and the image generation unit 404 generates display data of the stereoscopic image 6. The initial image designation unit 403a designates the information for generating the stereoscopic image 6 by using an operation display image data group of the storage unit 407. The image generation unit 404 outputs the generated display data to the display device 2 so as to display the stereoscopic image 6 on the display device 2.

Next, the information processing device 4 acquires data that the distance sensor 3 outputs (step S2), and performs a finger detecting process (step S3). The finger detection unit 401 performs steps S2 and S3. The finger detection unit 401 checks whether or not the finger of the operator 7 is present within a detection range including a space in which the stereoscopic image 6 is displayed, based on the data acquired from the distance sensor 3. After step S3, the information processing device 4 determines whether or not the finger of the operator 7 is detected (step S4).

In a case where the finger of the operator 7 is detected (step S4; Yes), next, the information processing device 4 calculates the spatial coordinates of the fingertip (step S5), and calculates the relative position between the button and the fingertip (step S6). The finger detection unit 401 performs steps S5 and S6. The finger detection unit 401 performs the process of steps S5 and S6 by using a spatial coordinate calculation method and a relative position calculation method, which are known. After steps S5 and S6, the information processing device 4 performs an input state determination process (step S7). In contrast, in a case where the finger of the operator 7 is not detected (step S4; No), the information processing device 4 skips the process of steps S5 and S6, and performs the input state determination process (step S7).

The input state determination unit 402 performs the input state determination process of step S7. The input state determination unit 402 determines the current input state, based on the immediately preceding input state and the result of the process of steps S3 to S6 by the finger detection unit 401.

If the input state determination process (step S7) is completed, next, the information processing device 4 performs a generated image designation process (step S8). The generated image designation unit 403 performs the generated image designation process. The generated image designation unit 403 designates information for generating the stereoscopic image 6 to be displayed, based on the current input state.

If the generated image designation process of step S8 is completed, the information processing device 4 generates display data of the image to be displayed (step S9), and displays the image on the display device 2 (step S10). The image generation unit 404 performs steps S9 and S10. The image generation unit 404 generates the display data of the stereoscopic image 6, based on the information designated by the generated image designation unit 403, and outputs the generated image data to the display device 2.

After the input state determination process (step S7), the information processing device 4 determines whether or not to output the sound in parallel with the process of steps S8 to S10 (step S11). For example, the control unit 406 performs the determination of step S11, based on the current input state. In a case of outputting the sound (step S11; Yes), the control unit 406 controls the audio generation unit 405 so as to generate sound data, and controls the sound output device 5 to output the sound (step S12). In contrast, in a case of not outputting the sound (step S11; No), the control unit 406 skips the process of step S12.

If the process of steps S8 to S10 and the process of steps S11 and S12 are completed, the information processing device 4 determines whether to complete the process (step S13). In a case of completing the process (step S13; Yes), the information processing device 4 completes the process.

In contrast, in a case of continuing the process (step S13; No), the process to be performed by the information processing device 4 returns to the process of step S2. Hereinafter, the information processing device 4 repeats the process of steps S2 to S12 until the process is completed.

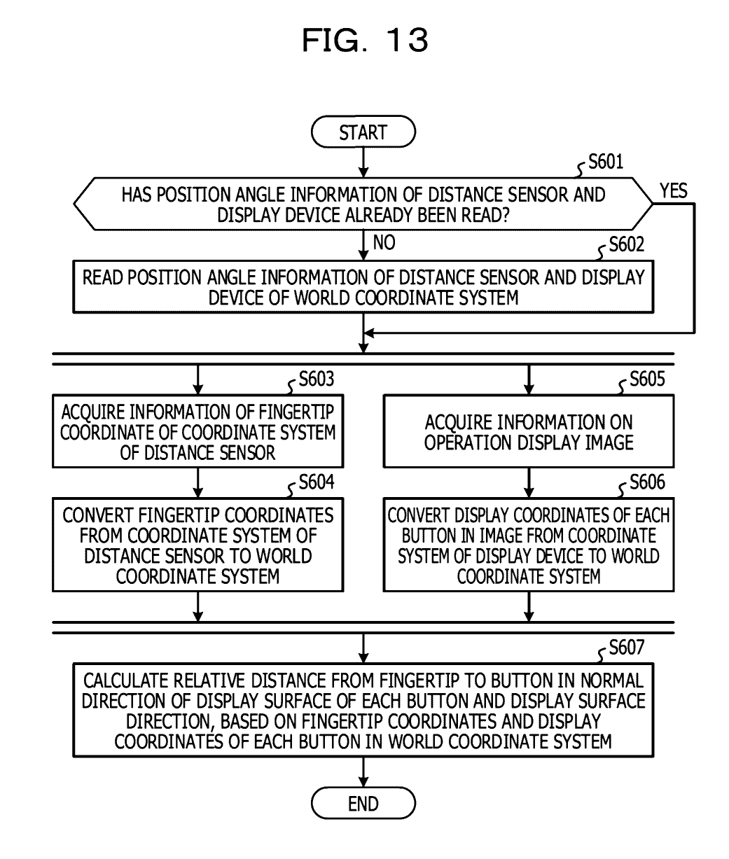

FIG. 13 is a flowchart illustrating a process of calculating the relative position between the button and the fingertip.

In the process of step S6 for calculating the relative position between the button and the fingertip, as illustrated in FIG. 13, the finger detection unit 401 first checks whether or not the position angle information of the distance sensor and the display device has already been read (step S601). The position angle information of the distance sensor is information illustrating a conversion relationship between the world coordinate system and the spatial coordinate system that is designated in the distance sensor. The position angle information of the display device is information illustrating a conversion relationship between the world coordinate system and the spatial coordinate system that is designated in the display device.

In a case where the position angle information of the distance sensor and the display device has not already been read (step S601; No), the finger detection unit 401 reads the position angle information of the distance sensor and the display device from the storage unit 407 (step S602). In a case where the position angle information of the distance sensor and the display device has already been read (step S601; Yes), the finger detection unit 401 skips step S602.

Next, the finger detection unit 401 acquires information of the fingertip coordinates in the spatial coordinate system of the distance sensor (step S603), and converts the acquired fingertip coordinates from the coordinate system of the distance sensor to the world coordinate system (step S604). Hereinafter, the fingertip coordinates are referred to as a fingertip spatial coordinate.

The finger detection unit 401 acquires information on the operation display image (step S605), and converts the display coordinates of each button from the spatial coordinate system of the display device to the world coordinate system, in parallel with the process of steps S603 and S604 (step S606). Hereinafter, the display coordinates are also referred to as display spatial coordinates.

Thereafter, the finger detection unit 401 calculates a relative distance from the fingertip to the button in the normal direction of the display surface of each button and the display surface direction, based on the fingertip coordinates and the display coordinates of each button in the world coordinate system (step S607).

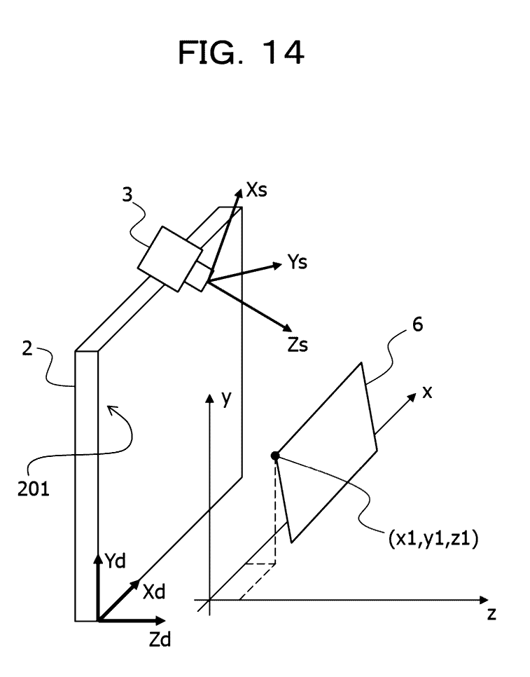

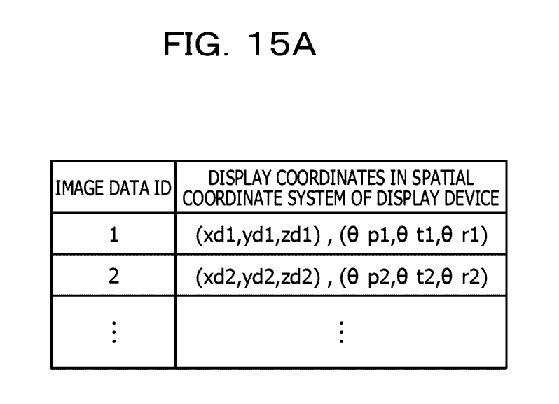

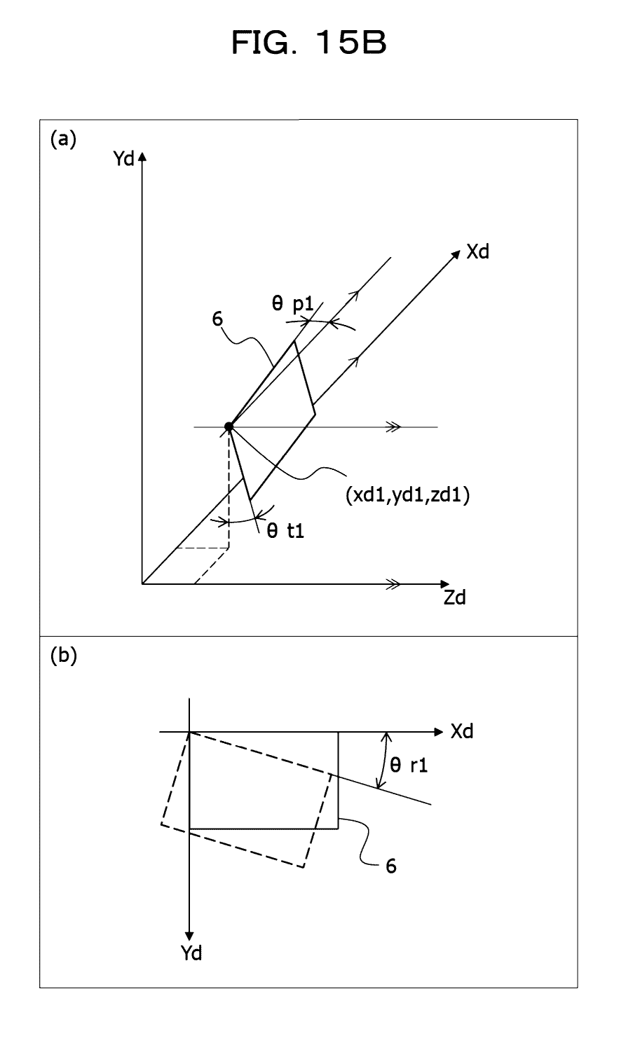

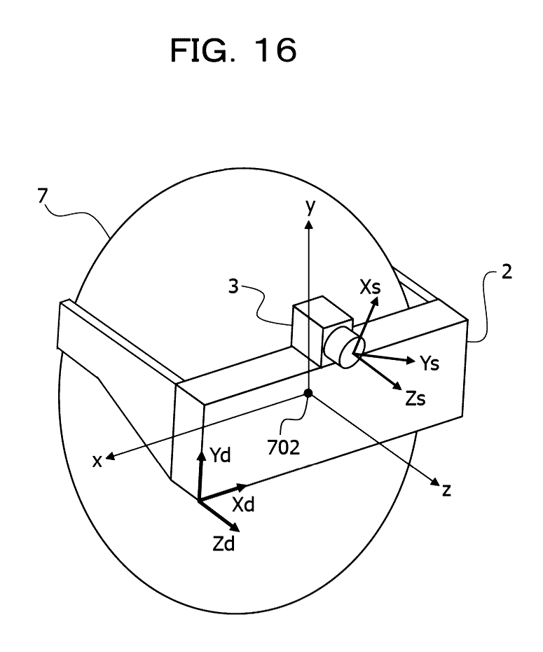

FIG. 14 is a diagram illustrating an example of a spatial coordinate system of the input device. FIG. 15A is a diagram illustrating an example of display coordinates in a spatial coordinate system of the display device (Part 1). FIG. 15B is a diagram illustrating an example of display coordinates in a spatial coordinate system of the display device (Part 2). FIG. 16 is a diagram illustrating an example of another spatial coordinate system of the input device.

As illustrated in FIG. 14, in the input device 1, there are three spatial coordinate systems: a spatial coordinate system (Xd, Yd, Zd) of the display device 2, a spatial coordinate system (Xs, Ys, Zs) of the distance sensor 3, and a world coordinate system (x, y, z). The spatial coordinate system (Xd, Yd, Zd) of the display device 2 is, for example, a three-dimensional orthogonal coordinate system in which the lower left corner of the display surface 201 of the display device 2 is the origin, and the normal direction of the display surface 201 is the Zd direction. The spatial coordinate system (Xs, Ys, Zs) of the distance sensor 3 is, for example, a three-dimensional orthogonal coordinate system in which the center of the sensor surface of the distance sensor 3 is the origin, and a direction toward the center of the detection range is the Zs direction. The world coordinate system (x, y, z) is a three-dimensional orthogonal coordinate system in which any position in the real space is the origin, the vertically upward direction is the +y direction.

The coordinates of the upper left corner of the stereoscopic image 6 illustrated in FIG. 14 are (x1, y1, z1) in the world coordinate system. However, in the display data for displaying the stereoscopic image 6 on the display device 2, for example, as illustrated in FIG. 15A and FIG. 15B, the display position of the stereoscopic image 6 is designated as the value in the spatial coordinate system (Xd, Yd, Zd) of the display device 2. That is, the coordinates of the upper left corner of the stereoscopic image 6 are expressed as (xd1, yd1, zd1), with the display device as a reference. Further, in the data the distance sensor 3 outputs, the point (x1, y1, z1) in the world coordinate system is expressed as a value in another spatial coordinate system (Xs, Ys, Zs). Therefore, the finger detection unit 401 of the information processing device 4 converts the coordinates in the spatial coordinate system (Xd, Yd, Zd) of the display device 2 and the coordinates in the spatial coordinate system (Xs, Ys, Zs) of the distance sensor 3 into the coordinates in the world coordinate system (x, y, z). Thus, it is possible to express the display position of the button in the stereoscopic image 6 and the position of the fingertip detected by the distance sensor 3 in the same spatial coordinate system, this makes it possible to calculate the relative position between the button and the fingertip.

The origin of the world coordinate system (x, y, z) can be set to any position in the real space, as described above. Therefore, in a case of using the head-mounted display as the display device 2, the world coordinate system (x, y, z) may use the point 702 of view of the operator 7 (for example, the intermediate point between left and right eyes, or the like) as illustrated in FIG. 16 as the origin.

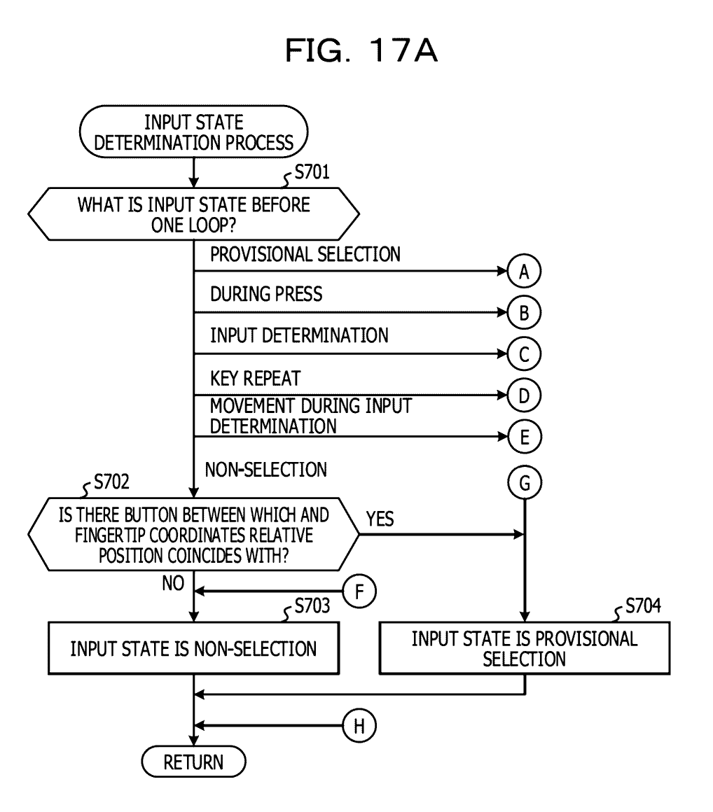

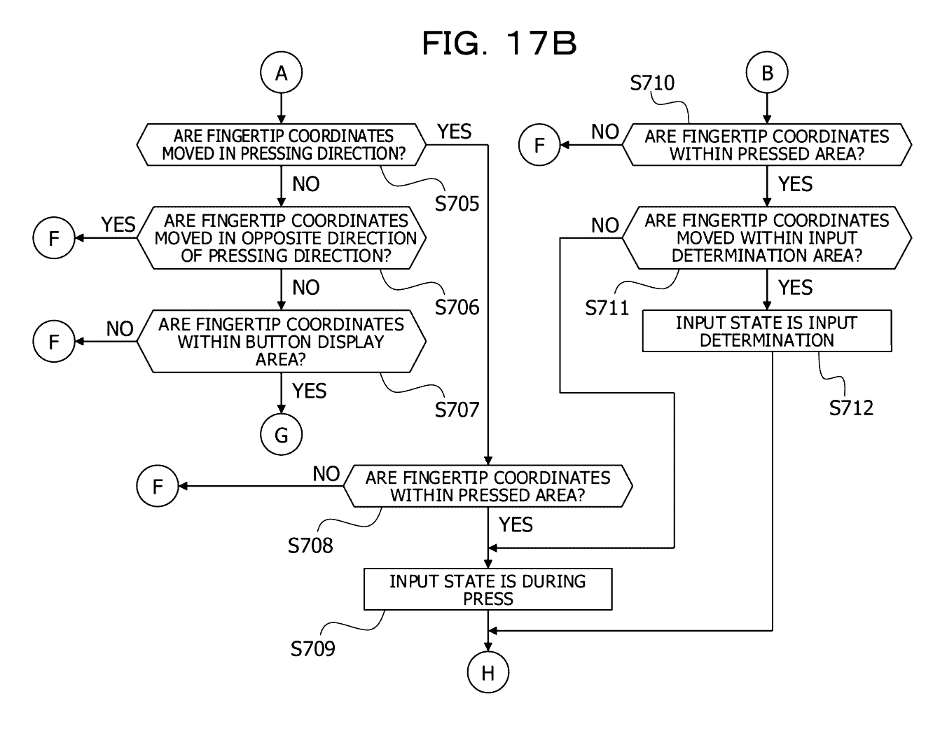

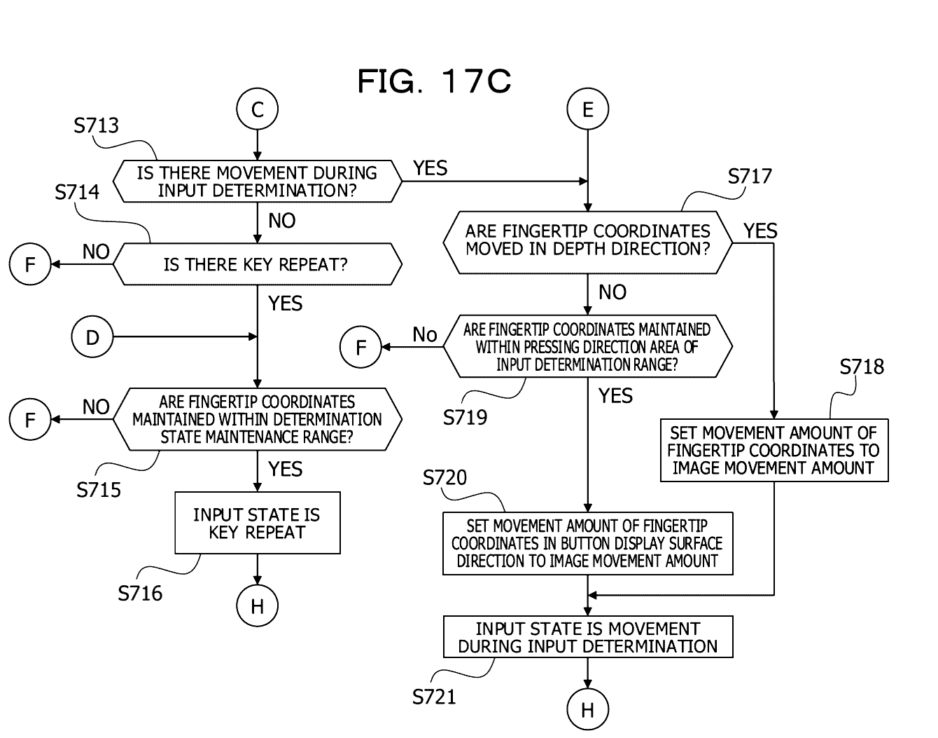

Next, step S7 (input state determination process) of FIG. 12 will be described with reference to FIG. 17A to FIG. 17C.

FIG. 17A is a flowchart illustrating the input state determination process in the first embodiment (Part 1). FIG. 17B is a flowchart illustrating the input state determination process in the first embodiment (Part 2). FIG. 17C is a flowchart illustrating the input state determination process in the first embodiment (Part 3).

The input state determination unit 402 performs the input state determination process of step S7. As illustrated in FIG. 17A, first, the input state determination unit 402 determines an input state before one loop (immediately preceding input state) (step S701).

In a case where the immediately preceding input state is determined to “non-selection” in step S701, next, the input state determination unit 402 determines whether or not there is a button between which and the fingertip coordinates the relative position coincides with (step S702). The determination in step S702 is performed based on the relative position between the button and the fingertip, which is calculated in step S6. If there is a button between which and the fingertip the relative position (distance) is a predetermined threshold or less, the input state determination unit 402 determines that there is a button between which and the fingertip coordinates the relative position coincides with. In a case where there is no button between which and the fingertip coordinates the relative position coincides with (step S702; No), the input state determination unit 402 determines the current input state as “non-selection” (step S703). In contrast, in a case where there is a button between which and the fingertip coordinates the relative position coincides with (step S702; Yes), the input state determination unit 402 determines the current input state as “provisional selection” (step S704).

In a case where it is determined that the immediately preceding input state is “provisional selection” in step S701, after step S701, as illustrated in FIG. 17B, the input state determination unit 402 determines whether or not the fingertip coordinates are moved in the pressing direction (step S705). In a case where the fingertip coordinates are not moved in the pressing direction (step S705; No), the input state determination unit 402 next determines whether or not the fingertip coordinates are moved in the opposite direction of the pressing direction (step S706). In a case where fingertip coordinates are moved in the opposite direction of the pressing direction, the fingertip is moved to the front side in the depth direction and is away from the button. Therefore, in a case where the fingertip coordinates are moved in the opposite direction of the pressing direction (step S706; Yes), the input state determination unit 402 determines the current input state as “non-selection” (step S703). In a case where the fingertip coordinates are not moved in the opposite direction of the pressing direction (step S706; No), next, the input state determination unit 402 determines whether or not the fingertip coordinates are within a button display area (step S707). In a case where the fingertip coordinates are outside the button display area, the fingertip is away from the button. Therefore, in a case where the fingertip coordinates are not within the button display area (step S706; No), the input state determination unit 402 determines the current input state as “non-selection” (step S703). Meanwhile, in a case whether the fingertip coordinates are within the button display area, the input state determination unit 402 determines the current input state as “provisional selection” (step S704).

In a case where the immediately preceding input state is “provisional selection” and the fingertip coordinates are moved in the pressing direction (step S705; Yes), next, the input state determination unit 402 determines whether or not the fingertip coordinates are within the pressed area (step S708). In a case where the fingertip coordinates are within the pressed area (step S708; Yes), the input state determination unit 402 determines the input state as “during press” (step S709). Meanwhile, in a case where the fingertip coordinates are not within the pressed area (step S708; No), the input state determination unit 402 determines the current input state as “non-selection” (step S703).

In a case where it is determined that the immediately preceding input state is “during press” in step S701, after step S701, as illustrated in FIG. 17B, the input state determination unit 402 determines whether or not the fingertip coordinates are within a pressed area (step S710). In a case where the fingertip coordinates are not within the pressed area (step S710; No), the input state determination unit 402 determines the current input state as “non-selection” (step S703). In a case where the fingertip coordinates are within the pressed area (step S710; Yes), next, the input state determination unit 402 determines whether or not the fingertip coordinates are moved within the input determination area (step S711). In a case where the fingertip coordinates are moved within the input determination area (step S711; Yes), the input state determination unit 402 determines the current input state as “input determination” (step S712). In a case where the fingertip coordinates are not moved within the input determination area (step S711; No), the input state determination unit 402 determines the current input state as “during press” (step S709).

In a case where it is determined that the immediately preceding input state is “input determination” in step S701, after step S701, as illustrated in FIG. 17C, the input state determination unit 402 determines whether or not there is a movement during input determination (step S713). In step S713, the input state determination unit 402 determines whether or not the operation to move the stereoscopic image 6 in the three-dimensional space is performed. In a case where there is no “movement during input determination” (step S713; No), the input state determination unit 402 then determines whether or not there is a key repeat (step S714). In step S714, the input state determination unit 402 determines whether or not the button which is a determination target of an input state is a key repeat-possible button. Whether or not the button is the key repeat-possible button is determined with reference to the operation display image data as illustrated in FIG. 7. In a case where key repeat is not possible (step S714; No), the input state determination unit 402 determines the current input state as “non-selection” (step S703). Further, in a case where key repeat is possible (step S714; Yes), the input state determination unit 402 next determines whether or not the fingertip coordinates are maintained within the determination state maintenance range (step S715). In a case where the fingertip coordinates are maintained within the determination state maintenance range (step S715; Yes), the input state determination unit 402 determines the current input state as “key repeat” (step S716). In a case where the fingertip coordinates are moved to the outside of the determination state maintenance range (step S715; No), the input state determination unit 402 determines the current input state as “non-selection” (step S703).

In addition, in a case where the immediately preceding input state is “input determination” and the there is “movement during input determination” (step S713; Yes), as illustrated in FIG. 17C, the input state determination unit 402 performs the same determination process as in the case where the immediately preceding input state is “movement during input determination”.

In a case where it is determined that the immediately preceding input state is “key repeat” in step S701, after step S701, as illustrated in FIG. 17C, the input state determination unit 402 determines whether or not the fingertip coordinates are maintained within the determination state maintenance range (step S715). In a case where the fingertip coordinates are maintained within the determination state maintenance range (step S715; Yes), the input state determination unit 402 determines the current input state as “key repeat” (step S716). Meanwhile, in a case where the fingertip coordinates are moved to the outside of the determination state maintenance range (step S715; No), the input state determination unit 402 determines the current input state as “non-selection” (step S703).

In a case where it is determined that the immediately preceding input state is “movement during input determination” in step S701, after step S701, as illustrated in FIG. 17C, the input state determination unit 402 determines whether or not the fingertip coordinates are moved in the depth direction (step S717). In a case where the fingertip coordinates are moved in the depth direction (step S717; Yes), the input state determination unit 402 sets the movement amount of the fingertip coordinates to the movement amount of the stereoscopic image (step S718). The movement amount that the input state determination unit 402 sets in step S718 includes a moving direction and a moving distance.

In a case where the fingertip coordinates are not moved in the depth direction (step S717; No), next, the input state determination unit 402 determines whether or not the fingertip coordinates are maintained within the pressing direction area of the input determination range (step S719). The pressing direction area is a spatial area included in the input determination range when the pressed area is extended to the input determination range side. In a case where the fingertip coordinates are moved to the outside of the pressing direction area (step S719; No), the input state determination unit 402 determines the current input state as “non-selection” (step S703). Meanwhile, in a case where the fingertip coordinates are maintained within the pressing direction area (step S719; Yes), the input state determination unit 402 sets the movement amount of the fingertip coordinates in the button display surface direction to the movement amount of the stereoscopic image (step S720).

After the movement amount of the stereoscopic image is set in step S718 or S720, the input state determination unit 402 determines the current input state as “movement during input determination” (step S721).

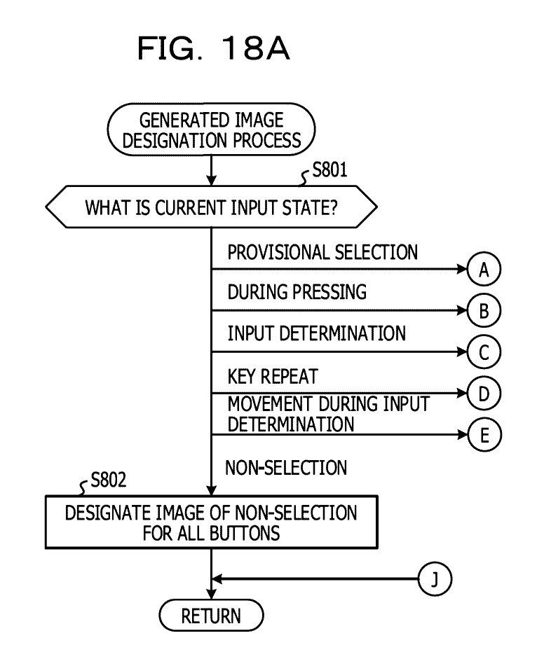

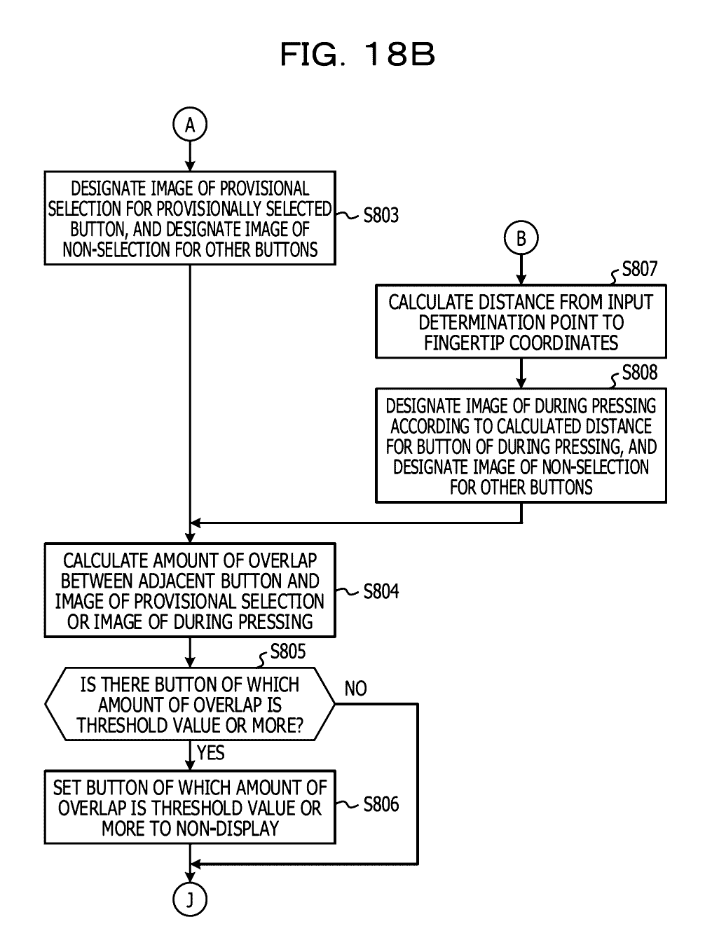

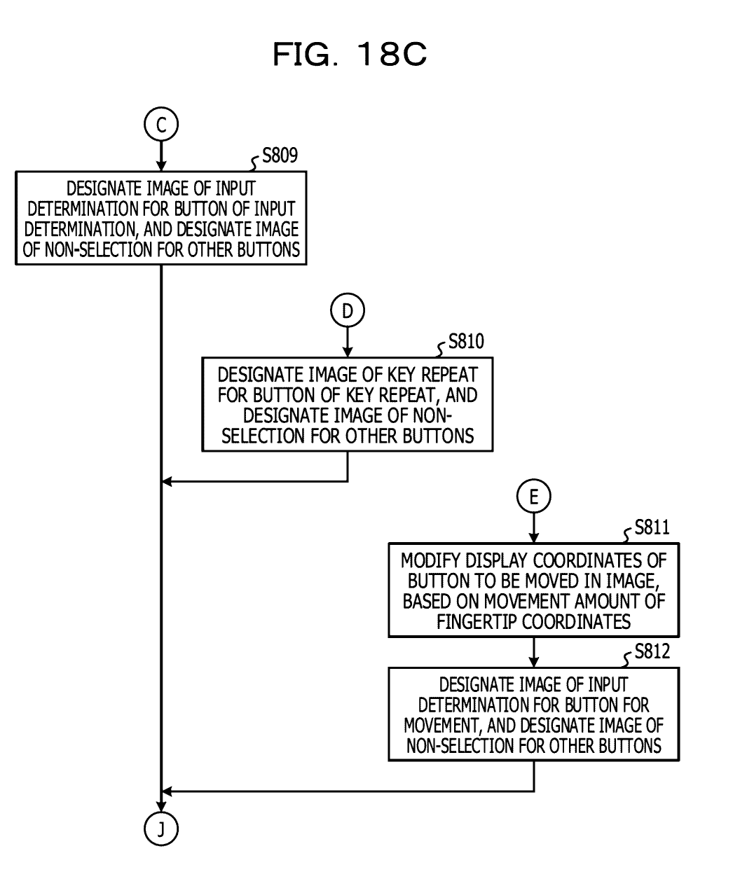

Next, step S8 of FIG. 12 (generated image designation process) will be described with reference to FIG. 18A to FIG. 18C.

FIG. 18A is a flowchart illustrating a generated image designation process in the first embodiment (Part 1). FIG. 18B is a flowchart illustrating the generated image designation process in the first embodiment (Part 2). FIG. 18C is a flowchart illustrating the generated image designation process in the first embodiment (Part 3).

The generated image designation unit 403 performs the generated image designation process of step S8. First, the generated image designation unit 403 determines the current input state, as illustrated in FIG. 18A (step S801).

In a case where the current input state is determined as “non-selection” in step S801, the generated image designation unit 403 designates the image of the button of “non-selection” for all buttons (step S802). The initial image designation unit 403a performs the designation of step S802.

In a case where the current input state is determined to “provisional selection” in step S801, after step S801, as illustrated in FIG. 18B, the generated image designation unit 403 designates the button image of “provisional selection” for the provisionally selected button, and the button image of “non-selection” for other buttons (step S803). The initial image designation unit 403a, the determination frame designation unit 403b, and the in-frame image designation unit 403c perform the designation of step S803.

In a case where the current input state is determined to “during press” in step S801, after step S801, as illustrated in FIG. 18B, the generated image designation unit 403 calculates a distance from the input determination point to the fingertip coordinates (step S807). Subsequently, the generated image designation unit 403 designates the button image of “during press” according to the distance which is calculated for the button of “during press”, and designates the button image of “non-selection” for other buttons (step S808). The initial image designation unit 403a, the determination frame designation unit 403b, and the in-frame image designation unit 403c perform the designation of step S808.

Further, in a case where the current input state is “provisional selection” or “during press”, after step S803 or S808, the generated image designation unit 403 calculates the amount of overlap between the button image of “provisional selection” or “during press” and the adjacent button (step S804). The adjacent button display designation unit 403d performs step S804. If the amount of overlap is calculated, next, the adjacent button display designation unit 403d determines whether or not there is button of which the amount of overlap is a threshold value or more (step S805). In a case where there is button of which the amount of overlap is a threshold value or more (step S805; Yes), the adjacent button display designation unit 403d sets the corresponding button to non-display (step S806). Meanwhile, in a case where there is no button of which the amount of overlap is a threshold value or more (step S805; No), the adjacent button display designation unit 403d skips the process of step S806.

In a case where the current input state is determined to “input determination” in step S801, after step S801, as illustrated in FIG. 18C, the generated image designation unit 403 designates the button image 623 of “input determination” for the button of “input determination”, and designates the button image of “non-selection” for other buttons (step S809). The input determination image designation unit 403e performs step S809.

In a case where the current input state is determined to “key repeat” in step S801, after step S801, as illustrated in FIG. 18C, the generated image designation unit 403 designates the button image 624 of “key repeat” for the button of “key repeat”, and designates the button image 620 of “non-selection” for other buttons (step S810). For example, the input determination image designation unit 403e performs step S810.

In a case where the current input state is determined to “movement during input determination” in step S801, after step S801, as illustrated in FIG. 17C, the generated image designation unit 403 modifies the display coordinates of the button in the stereoscopic image, based on the movement amount of the fingertip coordinates (step S811). Thereafter, the generated image designation unit 403 designates the button image 623 of “input determination” for the button of which the display position is moved, and designates the button image 620 of “non-selection” for other buttons (step S812). The input determination image designation unit 403e and the display position designation unit 403f perform steps S811 and S812.

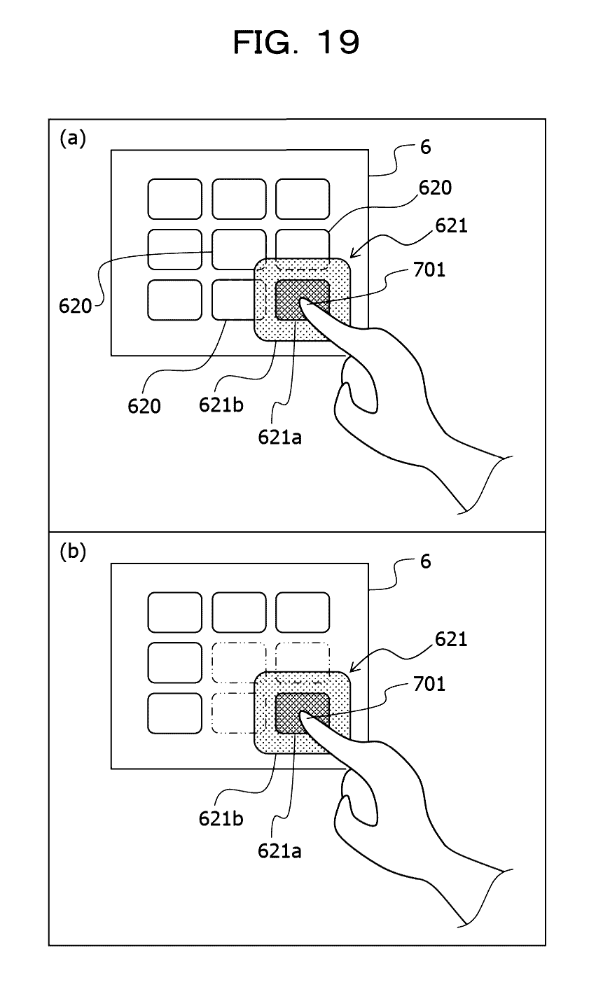

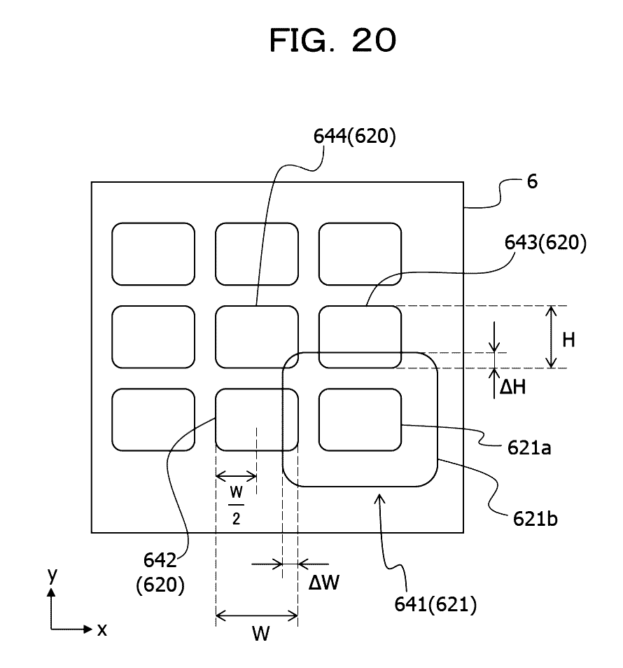

FIG. 19 is a diagram illustrating a process to hide the adjacent button. FIG. 20 is a diagram illustrating an example of a method of determining whether or not to hide the adjacent button.

In the generated image designation process according to the present embodiment, as described above, in a case where the current input state is “provisional selection” or “during press”, the button image 621 of “provisional selection” or the button image 622 of “during press” is designated. As illustrated in FIG. 6, the button image 621 of “provisional selection” and the button image 622 of “during press” is an image that contains input determination frame, and is larger as compared to the button image 620 of “non-selection” in the size. Therefore, as illustrated in (a) of FIG. 19, in a case where the arrangement interval between buttons in the stereoscopic image 6 is narrow, the outer peripheral portion of the button image 621 of “provisional selection” may overlap with the button (button image 620 of “non-selection”). In this way, in a case where the outer peripheral portions of the button image 621 of “provisional selection” or the button image 622 of “during press” overlaps with the adjacent button, if the amount of overlap is large, it is difficult to see the outer peripheries of the button images 621 and 622, and it is likely to be difficult to recognize the position of the input determination frame. Therefore, in the generated image designation process according to the present embodiment, as described above, in a case where the amount of overlap between the button image 621 of “provisional selection” and the button image 622 of “during press” and the adjacent button is the threshold value or more, as illustrated in (b) of FIG. 19, the adjacent button is hidden. Thus, it becomes easier to know the outer peripheries of the button image 621 of “provisional selection” and the button image 622 of “during press”, and becomes easier to know the press amount for input determination.

The threshold of the amount of overlap used to determine whether or not to hide the adjacent button is assumed as, for example, half the dimension of adjacent button (the button image 620 of “non-selection”) in the adjacent direction. As illustrated in FIG. 20, it is considered a case where total of nine buttons of 3×3 are displayed in the stereoscopic image 6 and the button 641 in the lower right corner of the nine buttons are designated to the button image 621 of “provisional selection”. In this case, if the area 621a representing the button body of the button image 621 which is displayed as the button 641 is displayed in the same size as the other buttons, the outer peripheral portion of the button image 621 may overlap with the adjacent buttons 642, 643, and 644.

Here, if it is assumed that the dimension in the adjacent direction of the button 642 which is in the left next to the button 641 is W and the amount of overlap between the button 641 and the button 642 in the adjacent direction is ΔW, it is determined in step S805 whether or not it is established that, for example, ΔW≧W/2. As illustrated in FIG. 20, in a case where it is established that ΔW<W/2, the adjacent button display designation unit 403d of the generated image designation unit 403 determines to display the button 642 which is in the left next to the button 641. Similarly, if it is assumed that the dimension in the adjacent direction of the button 643 which is in the top next to the button 641 is H and the amount of overlap between the button 641 and the button 642 in the adjacent direction is ΔW, it is determined in step S805 whether or not it is established that, for example, ΔH≧H/2. As illustrated in FIG. 20, in a case where it is established that ΔW<W/2, the adjacent button display designation unit 403d of the generated image designation unit 403 determines to display the button 643 which is in the top next to the button 641. With respect to an adjacent button 644 which is in the upper left side of the button 641, for example, the adjacent direction is divided into a left and right direction and a up and down direction, and it is determined whether or not it is established that ΔW≧W/2 and ΔH≧H/2 for the amount of overlap ΔW in the left and right direction and the amount of overlap ΔH in the up and down direction. It is determined to hide the button 644 only in a case where it is established that, for example, ΔW≧W/2 and ΔH≧H/2.

The threshold of the amount of overlap used to determine whether or not to hide the adjacent button may be any value, and may be set based on the dimension of the button image 620 which is in the state of “non-selection” and the arrangement interval between buttons.

Further, although the adjacent button is hidden in the above example, without being limited thereto, for example, the display of the adjacent button may be changed so as not to be noticeable by a method of increasing the transparency, thinning the color thereof, or the like.

As described above, in the input device 1 according to the first embodiment, an input determination frame surrounding the button is displayed for a button that is touched by the fingertip 701 of the operator 7 and becomes the state of “provisional selection” (a state of being selected as an operation target) among buttons displayed in the stereoscopic image 6. The size of the area indicating the button body in the input determination frame is changed depending on the press amount, for the button of which the input state is “during press” and on which the operator 7 performs a pressing operation. In addition, in the button of which the input state is “during press”, the size of the area indicating the button body is changed in proportion to the press amount, and in a manner that the outer periphery of the area indicating the button body substantially coincides with the input determination frame immediately before the pressing fingertip reaches the input determination point P2. Therefore, when the operator 7 presses the button displayed on the stereoscopic image 6, the operator 7 can intuitively recognize that the button is selected as the operation target, and which distance the fingertip 701 is to be moved to the far side in the depth direction to determine the input.

In the input device 1 according to the first embodiment, it is possible to hide the adjacent buttons of “non-selection” when displaying the button image 621 of “provisional selection” and the button image 622 of “during press” including the input determination frame. Therefore, it becomes easier to view the button image 621 of “provisional selection” and the button image 622 of “during press”. In particular, it becomes easier to recognize a distance the fingertip is to be moved in order to determine the input, for the button image 622 of “during press”. Therefore, it is possible to reduce input errors, for example, due to a failure in input determination caused by an excessive amount of movement of the fingertip, or the erroneous press of the button in another stereoscopic image located on the far side in the depth direction.

Although the input determination frame is displayed in a case where the input state is “provisional selection” and “during press” in this embodiment, without being limited thereto, for example, the state of “provisional selection” is the state of “during press” of which the press amount is 0, and the input determination frame may be displayed only in a case where the input state is “during press”.

The input state determination process illustrated in FIG. 17A, FIG. 17B, and FIG. 17C is only an example, and a part of the process may be changed if it is desired. For example, the determination of steps S708 and S710 may be performed in consideration of the deviation of the fingertip coordinates occurring in “during press”.

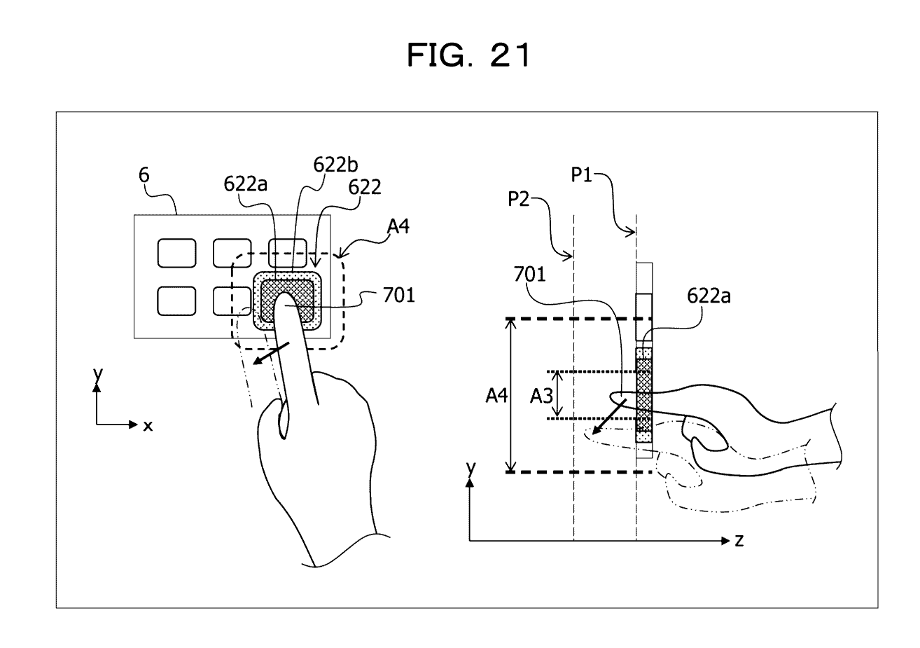

FIG. 21 is a diagram illustrating an allowable range for the deviation of the fingertip coordinates during press.

If the operator performs an operation to press the button which is displayed in the stereoscopic image 6, as illustrated in FIG. 21, the button image 622 of “during press” is displayed in the stereoscopic image 6. At this time, the line of sight of the operator 7 is likely not to be parallel to the normal direction of the display surface P1. In addition, the operator 7 moves the fingertip 701 in the depth direction in the three-dimensional space which is not a real object. Therefore, when moving the fingertip 701 in the depth direction, there is a possibility that the fingertip 701 comes out to the outside of the pressed area. Here, the pressed area A3 is a cylindrical area which is surrounded by the locus of the outer periphery of the button image 620 when moving the button image 620 displayed in a case where the input state is “non-selection” in the depth direction.

In the process illustrated in FIG. 17A and FIG. 17B, before the fingertip 701 of pressing the button reaches the input determination point P2, if the fingertip 701 comes out to the outside of the pressed area A3, the input state becomes “non-selection”. Therefore, the operator 7 performs again the operation to press the button. To reduce this situation, as illustrated in FIG. 21, a press determination area A4 having an allowable range around the pressed area A3 may be set. The size of the allowable range is arbitrary, for example, the size of the input determination frame, or an area 622b indicating the button body of the button image 622 of “during press”. Further, the allowable range may be, for example, a larger value than the input determination frame 622b, as illustrated in FIG. 21. In a case of making the allowable range larger than the input determination frame 622b, for example, the allowable range can be a range to a thickness of a standard finger or to the outer periphery of the adjacent button, or overlapping with the adjacent button with a predetermined amount of overlap, from the outer periphery of the button.

The button image 621 of “provisional selection” and the button image 622 of “during press” illustrated in FIG. 6 are only examples, and it is possible to use an image combined with a stereoscopic change by utilizing the fact of the stereoscopic image 6.

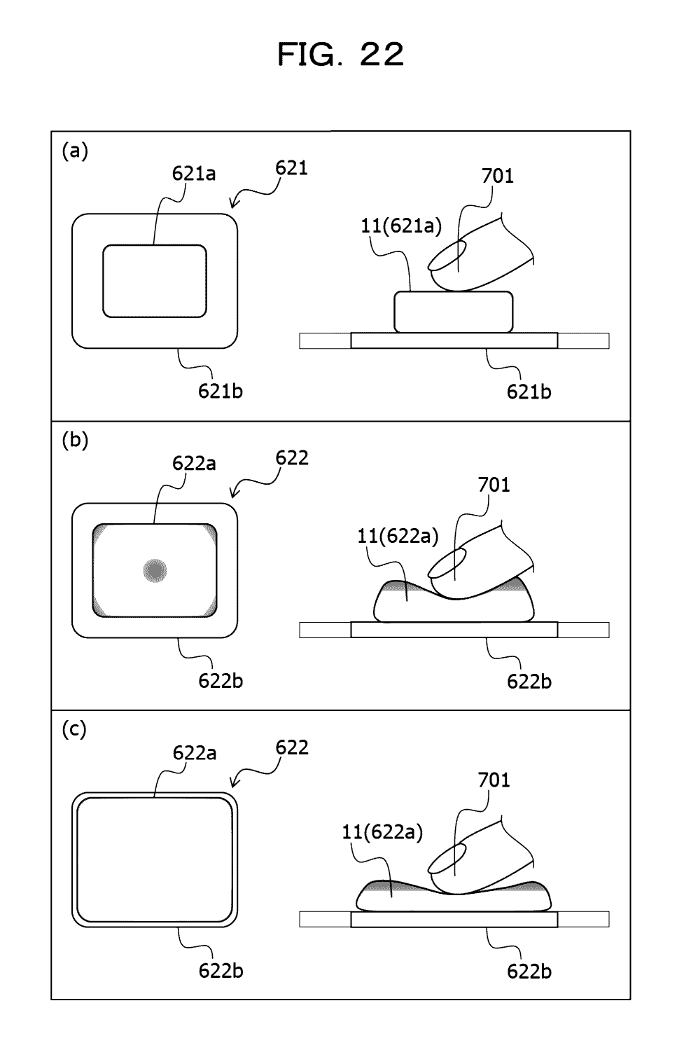

FIG. 22 is a diagram illustrating another example of the images of the buttons of “provisional selection” and “during press”. FIG. 22 illustrates an image combined with a shape change when a rubber member 11 formed into a substantially rectangular parallelepiped button-like is pressed with a finger, as another example of the button image of “during press”. The rubber member 11 formed into a button shape has a uniform thickness in a state of being lightly touched with the fingertip (in other words, the pressing load is 0 or significantly small), as illustrated in (a) of FIG. 22. Therefore, with respect to the button image 621 of “provisional selection”, an entire area indicating the button body is represented in the same color.

If the rubber member 11 formed into a button shape is pressed down with the fingertip, in the rubber member 11, the thickness of the center portion to which the pressing load is applied from the fingertip 701 is thinner than the thickness of the outer periphery portion, as illustrated in (b) and (c) of FIG. 22. Further, since the rubber member 11 extends in the plane by receiving the pressing load from the fingertip 701, the size of the rubber member 11 as viewed in a plan is larger than the size before pressing with the finger. The button image 622 of “during press” may be a plurality of types of images in which the color and the size of the area 622a indicating the button body are changed in a stepwise manner so as to reflect a gradual change in the thickness and the plan size of the rubber member 11. In a case of using such an button image 622 of “during press”, the image of the area 622a indicating the button body changes in three dimensions, in conjunction with the operation of the operator 7 to press the button. Thus, the operator 7 can feel sensation (visual sense) when performing an operation to press the button closer to the sensation the operator feels when pressing the button of a real object.

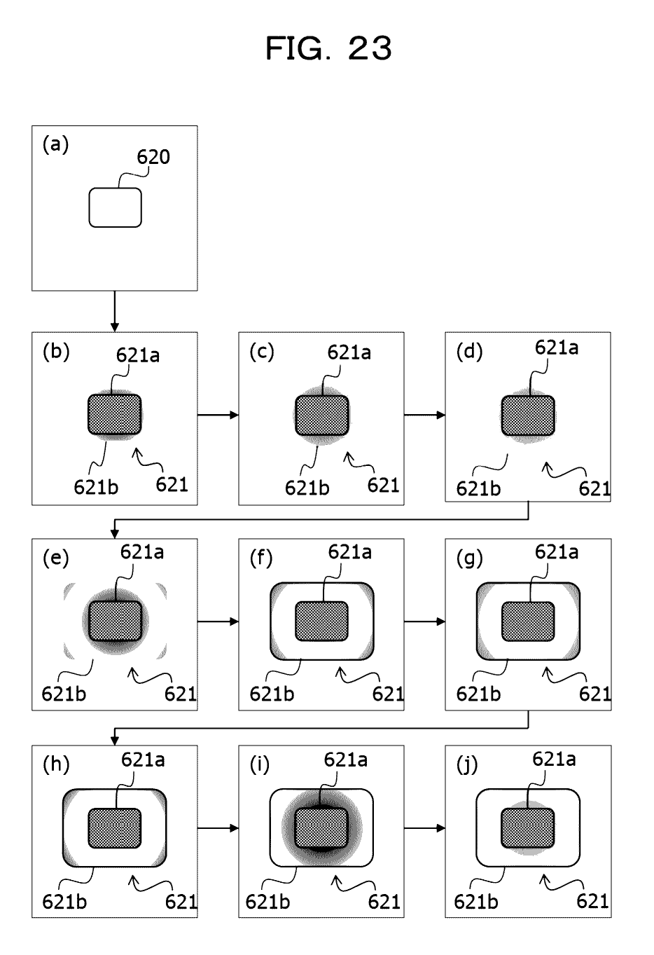

Further, when displaying the input determination frame, instead of switching from the button image 620 of “non-selection” to the button image 621 of “provisional selection” illustrated in FIG. 6, for example, as illustrated in FIG. 23, it is possible to adopt a display method in which the input determination frame spreads out from the outer periphery of the button.

FIG. 23 is a diagram illustrating another example of a method of displaying the input determination frame. (a) of FIG. 23 is the button image 620 of “non-selection”. If the button image 620 is touched with the fingertip 701 of the operator 7 and the input state is switched to “provisional selection”, first, as illustrated in (b) to (f) of FIG. 23, a belt-shaped area surrounding the area 621a gradually spreads to the outside of the area 621a indicating the button body of the button image 621 of “provisional selection”. If the external dimension of the spread belt-shaped area is the size of the input determination frame which is specified in the operation display image data, the spread of the belt-shaped area is stopped. In addition, the change in the width of the belt-shaped area from (b) to (f) of FIG. 23 is represented by a color that simulates ripples spread from the center of the area 621a indicating the button, and as illustrated in (g) to (j) of FIG. 23, even after the stop of the spread of the belt-shaped area, the change is represented by the color that simulates ripples for a certain period of time. Thus, it is possible to change the button image three-dimensionally by representing the input determination frame by a gradual change that simulates ripples, which enables the display of the stereoscopic image 6 with high visual effect.

The button image 621 of “provisional selection” or the button image 622 of “during press” is not limited to the flat plate-shaped image illustrated in FIG. 7A, or the like, and may be a three-dimensional image that simulates the shape of the button.

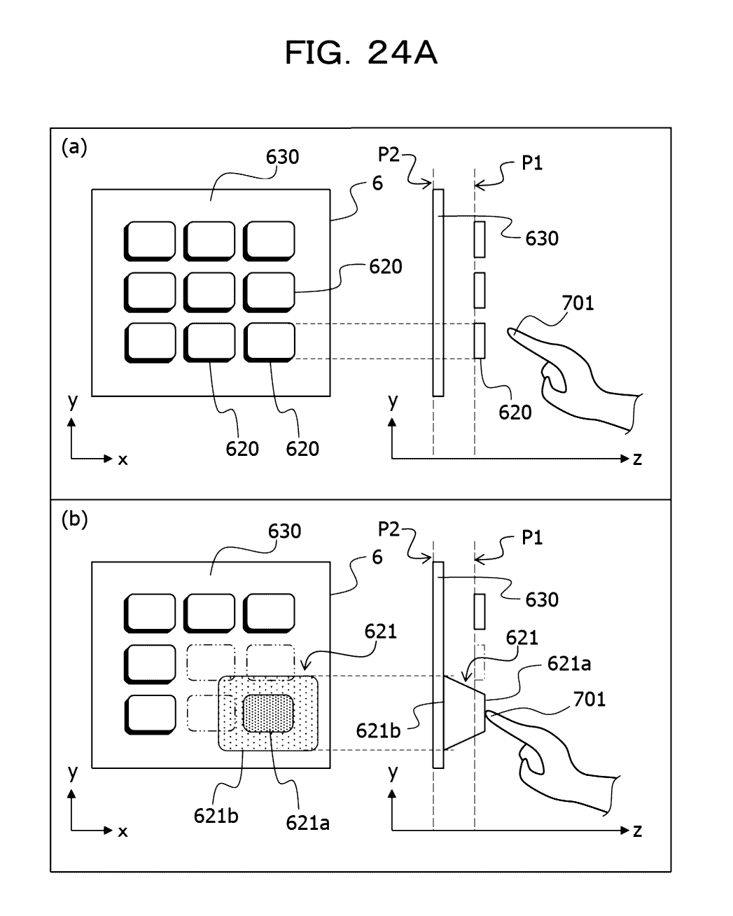

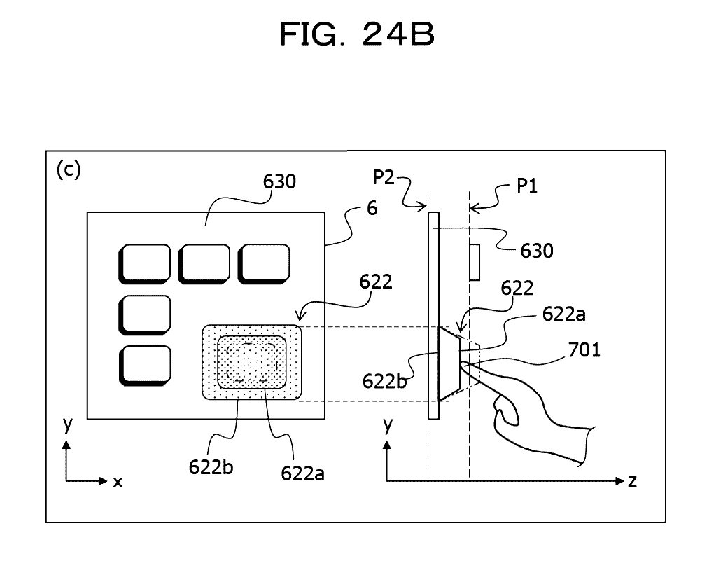

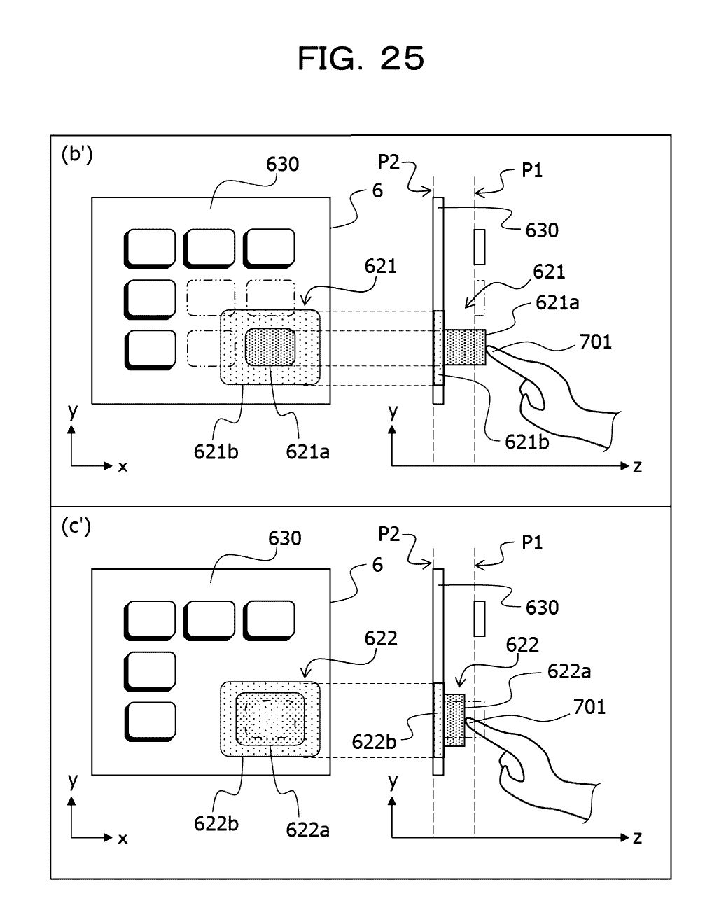

FIG. 24A is a diagram illustrating an example of three-dimensional display of the button (Part 1). FIG. 24B is a diagram illustrating an example of three-dimensional display of the button (Part 2). FIG. 25 is a diagram illustrating another example of three-dimensional display of the button.

The stereoscopic image 6 which is displayed based on the operation display image data described above (see FIG. 8) is, for example, an image in which each button and the background are flat plate-shaped, as illustrated in (a) of FIG. 24A. In other words, since the display position of each button is located closer to the operator side (the front side in the depth direction) than the display position of the background, a stereoscopic image is expressed. In a case where the button displayed in the stereoscopic image 6 is touched with the fingertip of the operator, in the example illustrated in FIG. 7A, the flat plate-shaped button image 620 of “non-selection” is changed to the flat plate-shaped button image 621 of “provisional selection”. However, the button image 621 of “provisional selection” is not limited to the flat plate-shaped button image, and may be a truncated pyramid-shaped image as illustrated in FIG. 24A. In this way, in a case of displaying a truncated pyramid-shaped button image 621, for example, it is assumed that an upper bottom surface (a bottom surface on the operator side) has the same size as the button of “non-selection” and the upper bottom surface has the size of the input determination frame. In a case of performing an operation to press the truncated pyramid-shape button, as illustrated in (c) of FIG. 24B, the button image 622 of “during press” is displayed in which the shape of the area 622a indicating the button body changes depending on the press amount. At this time, with respect to the area 622a indicating the button body, the size of the upper bottom surface is changed in a manner that is proportional to the press amount in a positive proportionality constant, and a distance from the upper bottom surface to the input determination point P2 is changed in a manner that is proportional to the press amount in a negative proportionality constant. In this way, since the images 621 and 622 of the buttons of which the input states are “provisional selection” and “during press” are formed into the stereoscopic images, the operator 7 can feel sensation (visual sense) when performing an operation to press the button closer to the sensation the operator feels when pressing the button of a real object.

The stereoscopic images of the images 621 and 622 of the buttons of “provisional selection” and “during press” are not limited to the truncated pyramid shape, but may have other stereoscopic shapes such as a rectangular parallelepiped shape as illustrated in FIG. 25.

(b′) of FIG. 25 illustrates another example of the stereoscopic image of the button image 621 of “provisional selection”. In this another example, an area for presenting the input determination frame 621b is displayed in the background 630 which is displayed in the input determination point P2, and the area 621a indicating the button body is three-dimensionally displayed in a manner that erected from the area to the operator side. If the operator 7 performs an operation to press the area 621a indicting the button body of the button image 621 of “provisional selection” with the fingertip 701, as illustrated in (c′) of FIG. 25, the button image 622 of “during press” is displayed in which the shape of the area 622a indicating the button body changes depending on the press amount. At this time, with respect to the area 622a indicating the button body, the size (size of the xy plane) of the bottom surface is changed in a manner that is proportional to the press amount in a positive proportionality constant, and a height (size in the z direction) is changed in a manner that is proportional to the press amount in a negative proportionality constant.

Next, a description will be given on an example of movement during input determination in the input device 1 according to the present embodiment.

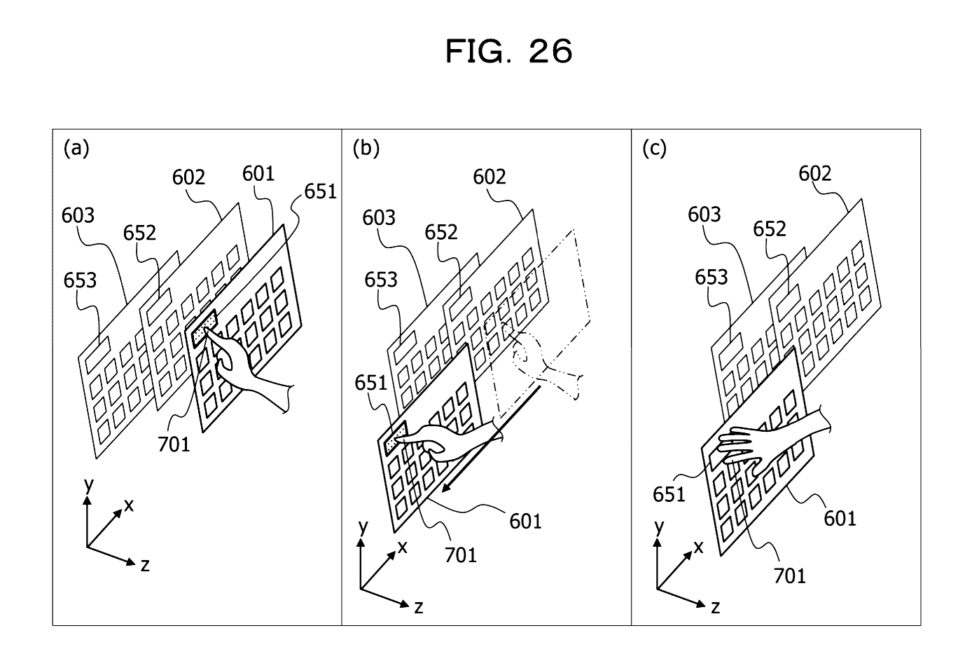

FIG. 26 is a diagram illustrating an example of movement during input determination. (a) to (c) of FIG. 26 illustrate a stereoscopic image 6 in which three operation screens 601, 602, and 603 are three-dimensionally arranged. Further, respective movement buttons 651, 652, and 653 for performing a process of moving the screens in the three-dimensional space are displayed on the respective operation screens 601, 602, and 603.

As illustrated in (a) of FIG. 26, the operator 7 performs an operation to press the movement button 651 of the operation screen 601 which is displayed on the most front side (operator side) in the depth direction, and if the input state becomes “input determination”, the movement button 651 is the button image of “input determination”. Thereafter, if the fingertip coordinates of the operator 7 are maintained within a determination maintenance range, the information processing device 4 determines the input state for the movement button 651 of the operation screen 601 as “movement during input determination”. Thus, the operation screen 601 becomes a movable state in the three-dimensional space. After the operation screen 601 becomes the movable state, as illustrated in (b) of FIG. 26, if the operator 7 performs an operation to horizontally move the operation screen 601 in the display surface, only the operation screen 601 including the movement button 651 of which the input state is “movement during input determination” is horizontally moved. After moving the operation screen 601, for example, if the operator 7 performs an operation to separate the fingertip 701 from the movement button 651, the input state for the movement button 651 becomes a non-selection state, and the movement button 651 is changed to the button image of “non-selection”. Thus, it is possible to make easier to view another display screen displayed on the far side in the depth direction of the moved operation screen by moving independently any of a plurality of operation screens overlapping in a plurality of depth directions.

In a case where the stereoscopic image 6 (operation screen 601) is movable in the depth direction when the input state is “movement during input determination” as illustrated in FIG. 17C, if the operator performs an operation to separate the fingertip 701 from the movement button 651, the operation screen 601 moves along with the movement of the fingertip 701. Therefore, in a case where the stereoscopic image 6 is movable in the depth direction, for example, if the finger of the operator is moved in a way different from when moving the stereoscopic image 6 (operation screen 601) as illustrated in (c) of FIG. 26, the input state is changed from “movement during input determination” to “non-selection”.

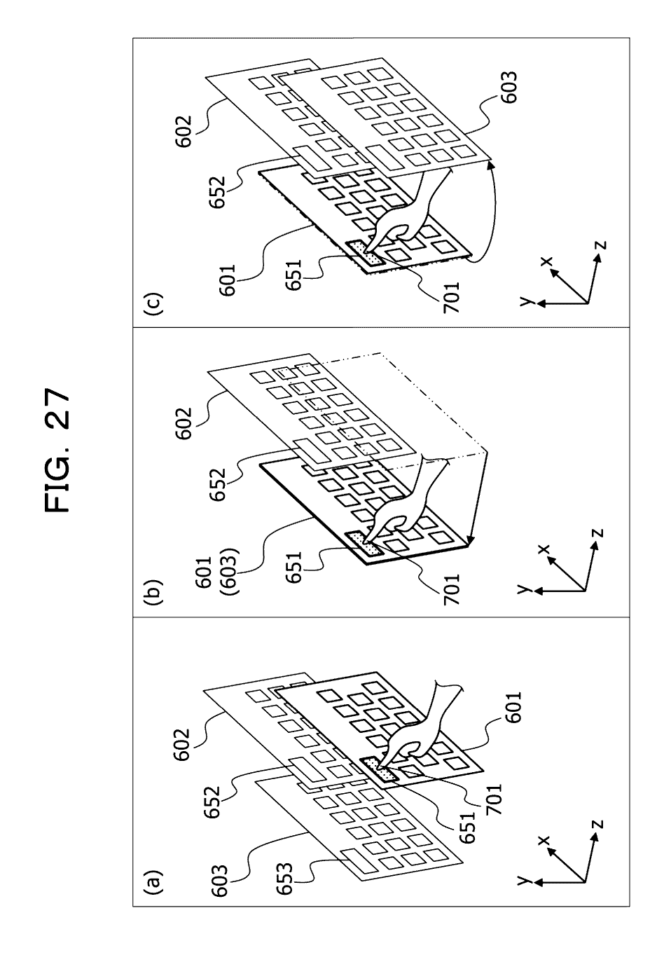

FIG. 27 is a diagram illustrating another example of movement during input determination. (a) to (c) of FIG. 27 illustrate a stereoscopic image 6 in which three operation screens 601, 602, and 603 are three-dimensionally arranged. Further, respective movement buttons 651, 652, and 653 for performing a process of moving the screens in the three-dimensional space are displayed on the respective operation screens 601, 602, and 603.

As illustrated in (a) of FIG. 27, the operator 7 performs an operation to press the movement button 651 of the operation screen 601 which is displayed on the most front side (operator side) in the depth direction, and if the input state becomes “input determination”, the movement button 651 is the button image of “input determination”. Thereafter, if the fingertip coordinates of the operator 7 are maintained within a determination maintenance range, the information processing device 4 determines the input state for the movement button 651 of the operation screen 601 as “movement during input determination”. Thus, the operation screen 601 becomes a movable state in the three-dimensional space. After the operation screen 601 becomes the movable state, as illustrated in (b) of FIG. 27, if the operator 7 performs an operation to move the operation screen 601 in the depth direction, only the operation screen 601 including the movement button 651 of which the input state is “movement during input determination” is moved in the depth direction. At this time, as illustrated in (b) of FIG. 27, if the operation screen 601 is moved to the vicinity of another operation screen 603, the display surfaces P1 and the input determination points P2 of the buttons in two operation screens 601 and 603 come to close to each other. Therefore, in a case where the finger detection unit 401 of the information processing device 4 detects the fingertip 701 of the operator 7, it is difficult to determine which button of the button in the operation screen 601 and the button in the operation screen 603 the manipulation (operation) is performed on. Thus, in a case where the operation screen 601 while moving comes close to the operation screen 603, for example, the information processing device 4 moves the display position of another operation screen 603 to a position away from the operation screen 601 while moving, as illustrated in (c) of FIG. 27. Further, although the display position of the operation screen 603 is moved to the display position of the operation screen 601 before movement in the example illustrated in (c) of FIG. 27, without being limited thereto, the display position may be moved to the far side in the depth direction. The replacement of the display positions of the operation screens 601 and 603 illustrated in FIG. 27 may be performed, for example, as an operation for displaying the operation screen 603 which is displayed on the far side in the depth direction on the front side in the depth direction. Thus, for example, even in the case where the movement button 653 of the operation screen 603 is hidden by other operation screens 601 and 602 which are on the front side, the operator 7 can easily move the operation screen 603 to the position in which the operation screens are easily viewed.

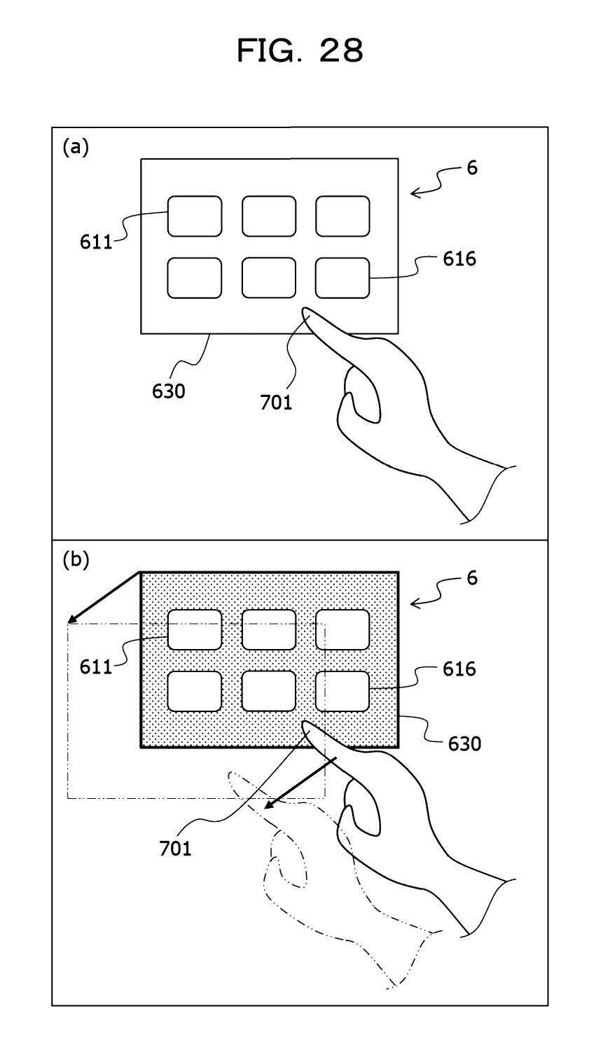

FIG. 28 is a diagram illustrating still another example of movement during input determination.

In the stereoscopic image 6 illustrated in FIG. 26 and FIG. 27, movement buttons 651, 652, and 653 for moving the screens are displayed in the respective operation screens 601, 602, and 603. However, the movement of the stereoscopic image 6 is not limited to the movement using the movement button, and for example, may be associated with the operation to press an area such as a background other than the button in the stereoscopic image 6. In this example, the input state determination unit 402 of the information processing device 4 performs the input state determination as in the button for the background 630 in the stereoscopic image 6. At this time, as illustrated in (a) of FIG. 28, in a case where the background 630 in the stereoscopic image 6 (operation screen) is touched with the fingertip 701 of the operator 7, the input state for the background 630 is changed from “non-selection” to “provisional selection”. Thereafter, for example, if a state in which the input state for the background 630 is “provisional selection” continues for a predetermined period of time, the input state determination unit 402 changes the input state for the background 630 to “movement during input determination”. Upon receipt of the change of the input state, the generated image designation unit 403 and the image generation unit 404 generate, for example, a stereoscopic image 6 in which the image of the background 630 is changed to an image indicating “movement during input determination”, and display the generated stereoscopic image 6 on the display device 2, as illustrated in (b) of FIG. 28. Thus, the operator 7 is able to know that the stereoscopic image 6 is movable in the three-dimensional space. Then, if the operator 7 performs an operation to move the fingertip 701, the stereoscopic image 6 is moved depending on the movement amount of the fingertip 701. Further, if the operator 7 performs an operation to separate the fingertip 701 from the stereoscopic image 6 (the background 630), or an operation to change the shape of the finger, the information processing device 4 changes the input state for the background 630 from “movement during input determination” to “non-selection”, and the display position of the stereoscopic image 6 is fixed.

Although the movement of the stereoscopic image 6 illustrated in FIG. 26 to FIG. 28 is the movement in the surface parallel to the display surface, or in the depth direction (the normal direction of the display surface), without being limited thereto, the stereoscopic image 6 may move the stereoscopic image 6 with a certain point such as the point of view of the operator 7 as a reference.

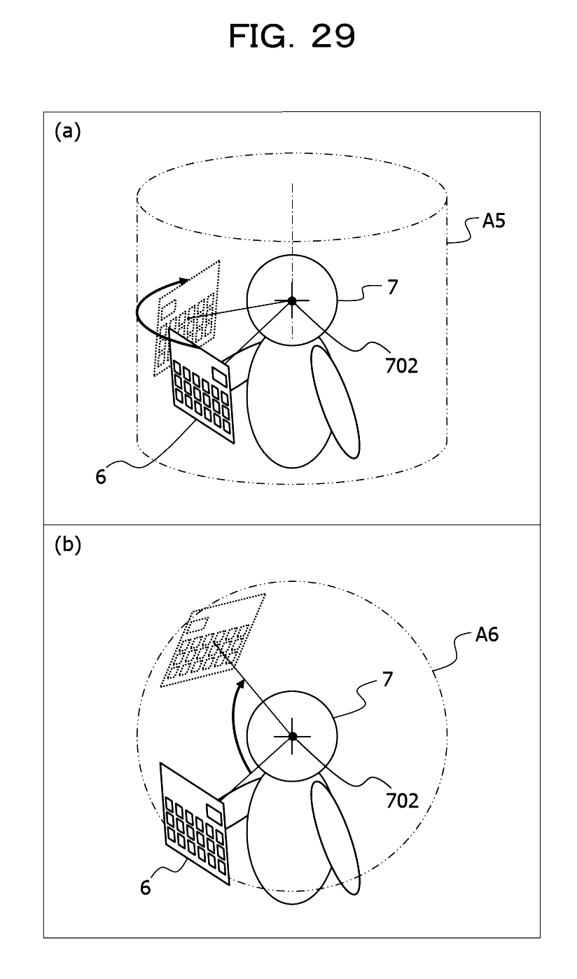

FIG. 29 is a diagram illustrating a modification example of a movement direction of a stereoscopic image.

In a case of moving the stereoscopic image 6, for example, as illustrated in (a) in FIG. 29, the stereoscopic image 6 may be moved along the peripheral surface of a columnar spatial area. In this case, for example, the display position and the movement amount are set such that the axial direction coincides with a vertical direction, a columnar spatial area A5 of a radius R is set of which the axis passes through the point of view 702 of the operator 7, and the coordinates (x1, y1, z1) designating the display position of the stereoscopic image are on the peripheral surface of the columnar spatial area A5. In a case of moving the stereoscopic image 6 along the peripheral surface of the columnar spatial area, for example, a world coordinate system is a columnar coordinate system (r, e, z) with the point of view 702 of the operator 7 as an origin, and the spatial coordinates with the display device as a reference and the distance sensor as a reference are converted into columnar coordinates to designate a display position.

In a case of moving the stereoscopic image 6, for example, as illustrated in (b) in FIG. 29, the stereoscopic image 6 may be moved along the spatial surface of a spherical spatial area. In this case, for example, the display position and the movement amount are set such that a spherical spatial area A6 of a radius R with the point of view 702 of the operator 7 as a center is set, and the coordinates (x1, y1, z1) designating the display position of the stereoscopic image are on the spatial surface of the spherical spatial area. In a case of moving the stereoscopic image 6 along the spatial surface of the spherical spatial area A6, for example, a world coordinate system is a polar coordinate system (r, θ, φ) with the point of view 702 of the operator 7 as an origin, and the spatial coordinates with the display device as a reference and the distance sensor as a reference are converted into polar coordinates to designate a display position.

In this way, since the stereoscopic image 6 is moved along the peripheral surface of the columnar spatial area or the spatial surface of the spherical spatial area, it is possible to spread the movement range of the stereoscopic image 6 in a state where the operator 7 is in a predetermined position. Further, it is possible to reduce a difference between the angles of viewing the stereoscopic image 6 before and after the movement when moving the stereoscopic image 6, thereby avoiding the display content of the stereoscopic image 6 from becoming hard to view.

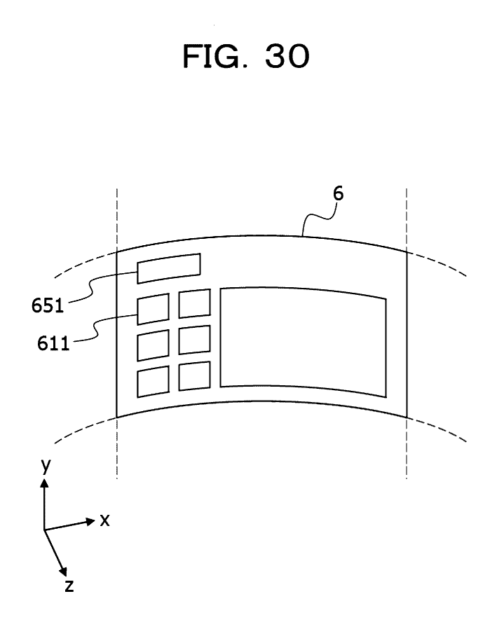

FIG. 30 is a diagram illustrating a modification example of a display shape of a stereoscopic image.

Although the stereoscopic image 6 (operation screen) which is illustrated in the drawings which are referred to in the previous description has a planar shape (a flat plate shape), without being limited thereto, the stereoscopic image 6 may be, for example, a curved surface as illustrated in FIG. 30. Since the stereoscopic image 6 (operation screen) is a curved shape, for example, the distance between respective points in the operation screen from the point of view of the operator 7 can be made substantially the same. Therefore, it is possible to suppress degradation of the display quality such as image blurring in a partial area in the operation screen due to a difference in the distance from the point of view of the operator 7. Further, in a case of moving the stereoscopic image 6 along the peripheral surface of the columnar spatial area or the spatial surface of the spherical spatial area as illustrated in FIG. 29, since the stereoscopic image 6 such as the operation screen has a curved shape, it is possible to visually view the movement direction of the stereoscopic image 6 and uncomfortable feeling at the time of movement can be reduced.

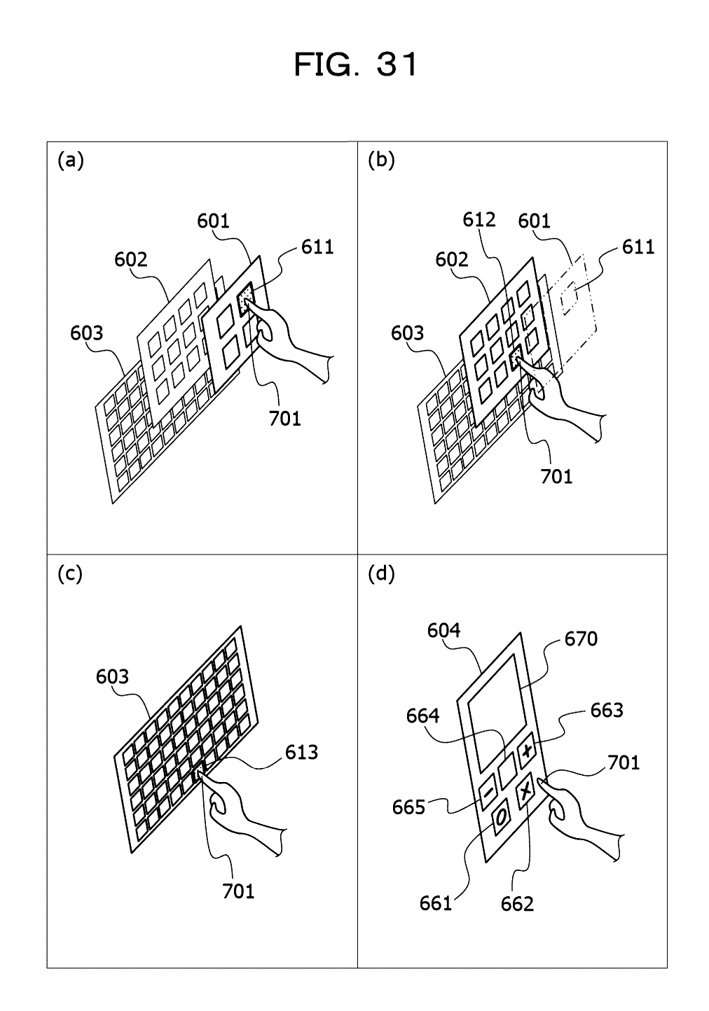

FIG. 31 is a diagram illustrating an example of an input operation using a stereoscopic image including a plurality of operation screens.

In the input device according to the present embodiment, in a case of displaying the stereoscopic image including the plurality of operation screens and performing an input operation, it is of course that separate independent input operations are assigned to the respective operation screens, and it is possible to assign hierarchical input operations to the plurality of operation screens. For example, as illustrated in (a) of FIG. 31, it is assumed that the operator 7 presses the button in the operation screen 601 that is displayed on the forefront in a state where the stereoscopic image 6 including three operation screens 601, 602, and 603 is displayed. Then, as illustrated in (b) of FIG. 31, the operation screen 601 is hidden. In this state, if the operator 7 continues the operation to press the button in the second operation screen 602, as illustrated in (c) of FIG. 31, the operation screen 602 is also hidden. Further, from this state, if the operator 7 performs an operation to press the button in the third operation screen 603, for example, as illustrated in (d) of FIG. 31, the operation screen 603 is also hidden, and a fourth operation screen 604 other than the operation screens 601, 602, and 603 is displayed. For example, operation buttons (661, 662, 663, 664, and 665), and a display portion 670 for displaying input information are displayed on the Fourth operation screen 604. Input information corresponding to the buttons which are pressed in the operation screens 601, 602, and 603 is displayed on the display portion 670. Further, operation buttons (661, 662, 663, 664, and 665) are, for example, a button to determine the input information, a button to redo the input, or the like. After checking the input information displayed on the display portion 670, the operator 7 presses any one of the operation buttons (661, 662, 663, 664, and 665). For example, in a case where there is no error in the input information, the operator 7 presses the button to determine the input information. Thus, the information processing device 4 performs a process according to the input information corresponding to the button that the operator 7 presses from the respective operation screens 601, 602, and 603. Further, in a case where there is no error in the input information, the operator 7 presses a button to redo an input. Thus, the information processing device 4 hides the fourth operation screen 604, and returns to any display state of (a) to (c) of FIG. 31.

A hierarchical input operation using such a plurality of operation screens can be applied, for example, to an operation to select a meal menu in a restaurant or the like.

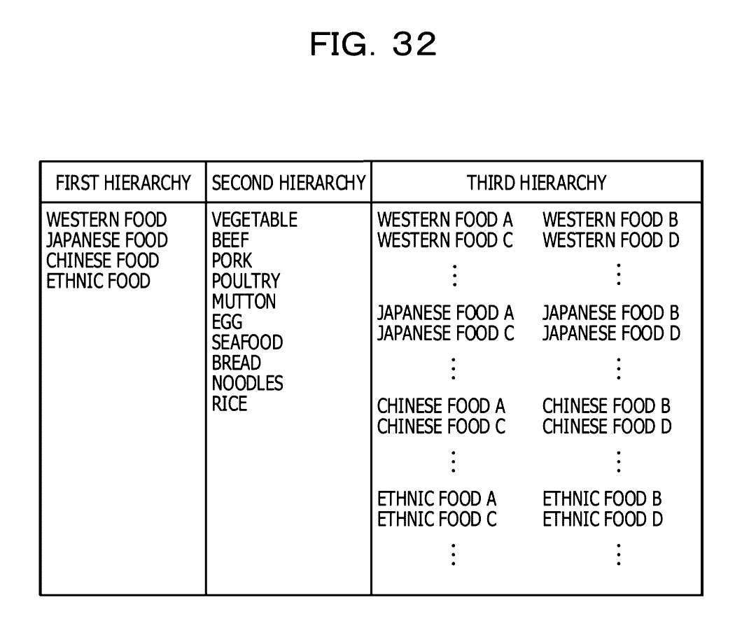

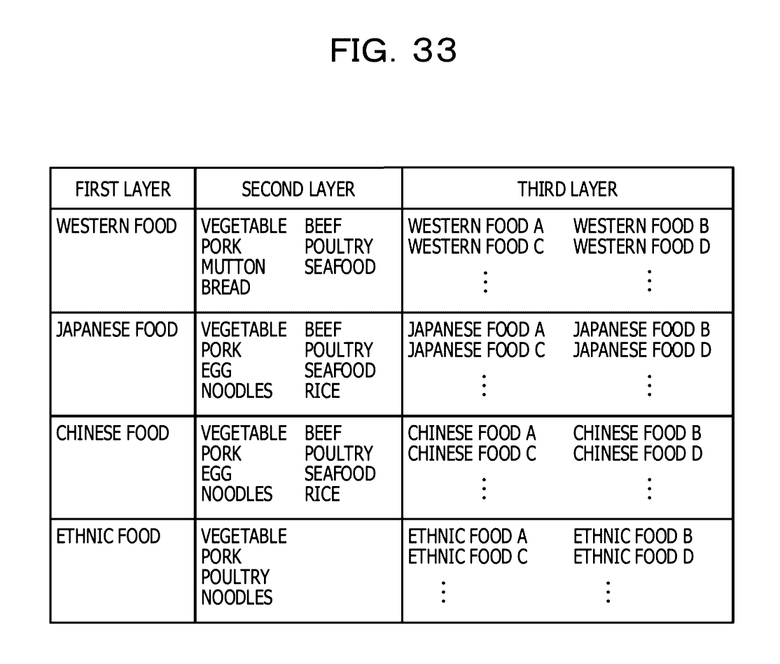

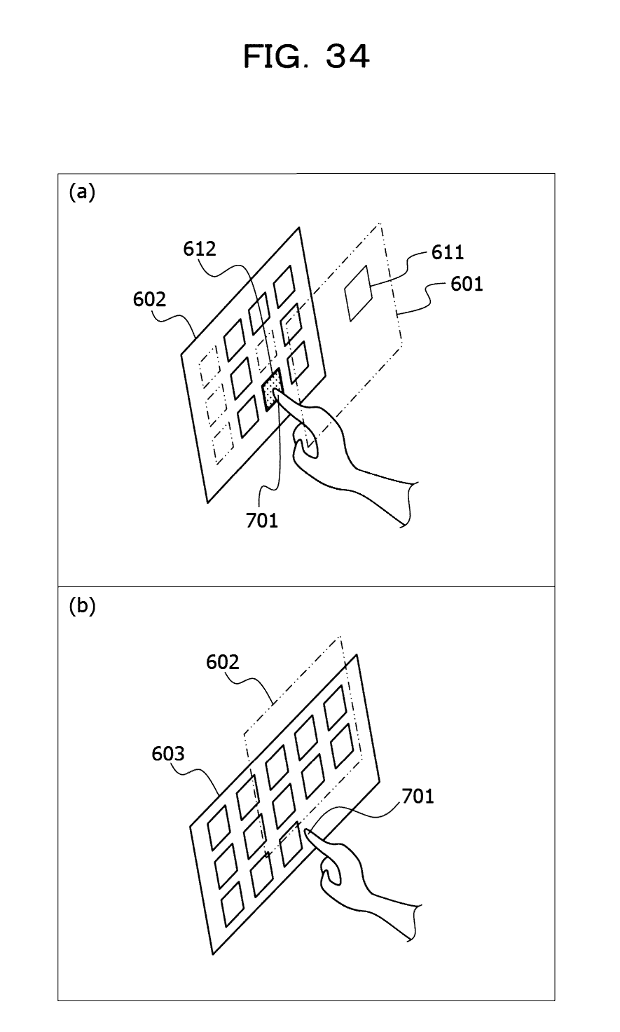

FIG. 32 is a diagram illustrating an example of a hierarchical structure of an operation to select a meal menu. FIG. 33 is a diagram illustrating a display example of the operation screens of a second hierarchy and a third hierarchy when the button displayed on an operation screen of a first hierarchy is pressed. FIG. 34 is a diagram illustrating an example of a screen transition when the operation to select the meal menu is performed.

In a case of performing an operation to select a hierarchical meal menu using three operation screens, for example, as illustrated in FIG. 32, a first hierarchy (the first operation screen 601) is assumed to an operation screen for selecting a food genre. A second hierarchy (the second operation screen 602) is assumed to an operation screen for selecting food materials to be used, and a third hierarchy (the third operation screen 603) is assumed to an operation screen for selecting a specific dish name. Further, in the operation to select a meal menu, for example, as illustrated in FIG. 33, in a case where a food genre is designated in the first hierarchy, a selectable food material is narrowed down in the second hierarchy, and a selectable food name is narrowed down in the third hierarchy, according to the selected food genre. In addition, Western food A, Western food B, Japanese food A, Chinese food A, ethnic food A and the like in FIG. 32 and FIG. 33 are actually specific food names (for example, the Western A is hamburger, the Western B is stew, and the Japanese food A is sushi, or the like).

In a case of performing a operation to select a meal menu based on the hierarchical structures illustrated in FIG. 32 and FIG. 33, first, buttons of all items are displayed on the respective operation screens 601, 602, and 603. In other words, the total number of selectable food genre and four buttons of the same number are displayed on the first operation screen 601. Further, the total number of selectable food materials and ten buttons of the same number are displayed on the second operation screen 602, and the total number of selectable dish names and a plurality of buttons of the same number are displayed on the third operation screen 603.

In this state, if the operator 7 performs an operation to press a button of Western food which is displayed on the first operation screen 601, the operation screen 601 is hidden, and the second operation screen 602 is displayed on the forefront. At this time, as illustrated in (a) of FIG. 34, only buttons corresponding to seven food materials which are selectable among ten food materials in the case where Western food is designated are displayed on the operation screen 602. Here, if the operator 7 performs an operation to press one of the seven buttons displayed on the operation screen 602, the operation screen 602 is hidden, and it becomes a state in which only the third operation screen 603 is displayed. At this time, as illustrated in (b) of FIG. 34, only buttons corresponding to the food names which are Western foods and use food materials designated in the second hierarchy, among all the food names registered in the third hierarchy are displayed on the operation screen 603. Here, if the operator 7 performs an operation to press one of the 13 buttons displayed on the operation screen 603, the operation screen 603 is hidden, and a fourth operation screen 604 illustrated in (d) of FIG. 31 is displayed. At this time, for example, the food genre designated in the first hierarchy, food materials designated in the second hierarchy, and food name designated in the third hierarchy are displayed on the fourth operation screen 604. Then, if the operator 7 performs an operation to press the button for determining the input information that is displayed on the fourth operation screen 604, for example, the order of the dish of the dish name designated in the third hierarchy is determined.

Further, in the above operation to select the hierarchical meal menu, for example, it is possible to omit the designation (selection) of food genre of the first hierarchy (the first operation screen 601), and the designation (selection) of food genre of the second hierarchy (the second operation screen 602).

For example, the operator 7 can press one of buttons of all food materials displayed on the second operation screen 602, in a state where three operation screens 601, 602, and 603 are displayed. In this case, if one of buttons of all food materials displayed on the second operation screen 602 is pressed, the first operation screen 601 and the second operation screen 602 are hidden. Then, only buttons corresponding to the food names using the food materials corresponding to the button pressed on the second operation screen 602 is displayed on the third operation screen. Further, the operator 7 can press one of buttons of all food names displayed on the third operation screen 603, in a state where three operation screens 601, 602, and 603 are displayed.

Further, in the hierarchical input operation, it is also possible to press a plurality of buttons displayed on a single operation screen. For example, in contrast, in a case where the fingertip of the operator 7 is moved to the front side in the depth direction (the opposite side of the second operation screen 602) after determining the input by pressing the button on the first operation screen 601, the designation of the food genre is to be continued. Then, in a case where the fingertip of the operator 7 is moved to the far side in the depth direction (the second operation screen 602 side) after determining the input by pressing the button on the first operation screen 601, the designation of the food genre is completed, and the operation screen 601 is hidden. Thus, it is possible to select two or more types of food genre from the first hierarchy (the first operation screen 601).

Further, the above operation to select the hierarchical meal menu is only an example of an hierarchical input operation using a plurality of operation screens, and it is possible apply the same hierarchical input operation to other selection operations or the like.

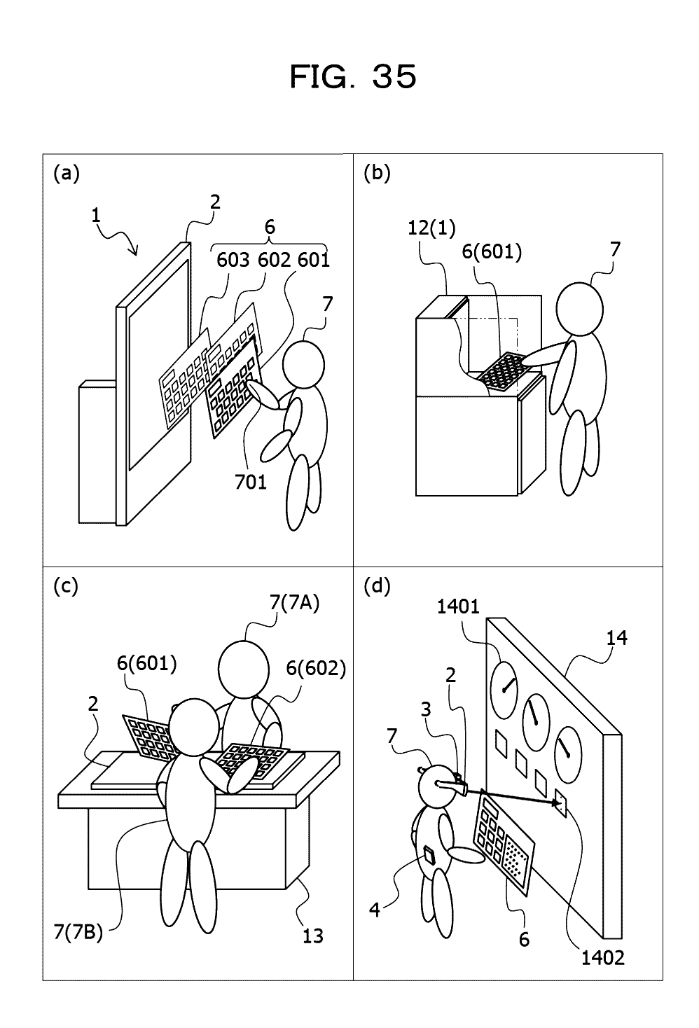

FIG. 35 is a diagram illustrating an application example of the input device according to the first embodiment.

The input device 1 according to the present embodiment is applicable to, for example, an information transmission system referred to as a digital signage. In the digital signage, for example, as illustrated in (a) of FIG. 35, a display device 2 which is equipped with a distance sensor, an information processing device, a sound output device (a speaker), and the like is provided in streets, public facilities, or the like, and provides information about maps, stores, facilities and the like in the neighborhood. In the digital signage, for example, a stereoscopic image display device in which a stereoscopic image can be view with naked eye is used as the display device 2. If the user (operator 7) stops for a certain time in the vicinity of the display device 2, the information processing device 4 generates a stereoscopic image 6 including operation screens 601, 602, and 603, which are used for information search and displays the generated stereoscopic image 6 on the display device 2. The operator 7 acquires desired information by repeating an operation to press the button in the displayed stereoscopic image 6 to determine an input.

Among the users of the digital signage, many users may not be experienced with the operation to press the button in the stereoscopic image 6, and may not be able to smoothly obtain desired information due to an input error. Meanwhile, in the input device 1 according to the present embodiment, since the input determination frame is included in the button image of “provisional selection” and the button image of “during press” as described above, an inexperienced user is also able to intuitively recognize a press amount suitable to determine the input. Therefore, it is possible to reduce input errors by the user, and provide information desired by the user smoothly by applying the input device 1 according to the present embodiment to the digital signage.

Furthermore, the input device 1 according to the present embodiment can also be applied to, for example, automatic transaction machine (for example, an automated teller machine (ATM)) and an automatic ticketing machine. In a case of applying to the automatic transaction machine, for example, as illustrated in (b) FIG. 35, the input device 1 is built into a trading machine body 12. In the automatic transaction machine, for example, a stereoscopic image display device in which a stereoscopic image can be view with naked eye is used as a display device 2. The user (operator 7) performs a desired transaction by repeating an operation to press the button in the stereoscopic image 6 displayed over the display device 2 of the automatic transaction machine to determine an input.

Among users of the automatic transaction machine, many users are experienced in the operation procedure of performing the transaction, but are inexperienced in the operation to press the button in the stereoscopic image 6, and thus there is a possibility that the trade is not able to be performed smoothly due to input errors. In contrast, in the input device 1 according to the present embodiment, since the input determination frame is included in the button image of “provisional selection” and the button image of “during press” as described above, an inexperienced user is also able to intuitively recognize a press amount suitable to determine the input. Therefore, it is possible to reduce input errors by the user, and perform the transaction the user desires smoothly by applying the input device 1 according to the present embodiment to the automatic transaction machine.

In addition, it is possible to apply the input device 1 according to the present embodiment to the customer-facing businesses which are performed, for example, at the counters of financial institutions, government agencies, or the like. In a case of applying to the customer-facing businesses, for example, as illustrated in (c) of FIG. 35, the input device 1 is built into the table 13 which is provided in the counter. In the ATM, for example, a stereoscopic image display device in which a stereoscopic image can be view with naked eye is used as a display device 2. In addition, the display device 2 is placed on the top plate of the table 13 such that the display surface faces upward. Desired information is displayed by the user (operator 7) repeating an operation to press the button in the stereoscopic image 6 displayed over the display device 2 to determine an input.

In the customer-facing business at the counter, even though the user in charge of that business is experienced in the operation to press a button in the stereoscopic image 6, the user who visits the other counter is likely to be inexperienced in the operation. Therefore, input errors occur when the inexperienced user to the operation (manipulation) performs an input operation, and there is a possibility that it is difficult to smoothly display desired information. In contrast, in the input device 1 according to the present embodiment, since the input determination frame is included in the button image of “provisional selection” and the button image of “during press” as described above, an inexperienced user is also able to intuitively recognize a press amount suitable to determine the input. Therefore, it is possible to reduce input errors, and smoothly display desired information by applying the input device 1 according to the present embodiment to the customer-facing businesses.

In addition, it is also possible to apply the input device 1 according to the present embodiment, for example, to a maintenance work of the facility in a factory or the like. In a case of apply to the maintenance work, for example, as illustrated in (d) of FIG. 35, a head-mounted display is used as the display device 2, and smart phones or tablet-type terminals capable of wireless communication are used as the information processing device 4.

For example, a task of recording the numerical value of a meter 1401 may be performed as the maintenance work of the facility 14 in some cases. Therefore, in a case of applying the input device 1 to the maintenance work, the information processing device 4 generates and displays a stereoscopic image 6 including a screen for inputting the current operating status or the like of the facility 14. It is possible to reduce input errors, and perform the maintenance work smoothly, by also applying the input device 1 according to the present embodiment to such a maintenance work.

In addition, in the input device 1 applied to a maintenance work, for example, a small camera, not illustrated, is mounted in the display device 2, and it is also possible to display information that the AR marker 1402 provided in the facility 14 has, as the stereoscopic image 6. At this time, the AR marker 1402 can have, for example, information such as the operation manuals of the facility 14.

Incidentally, the input device 1 according to the present embodiment can be applied to various input devices or businesses, without being limited to the application examples illustrated (a) to (d) of FIG. 35.

### Second Embodiment

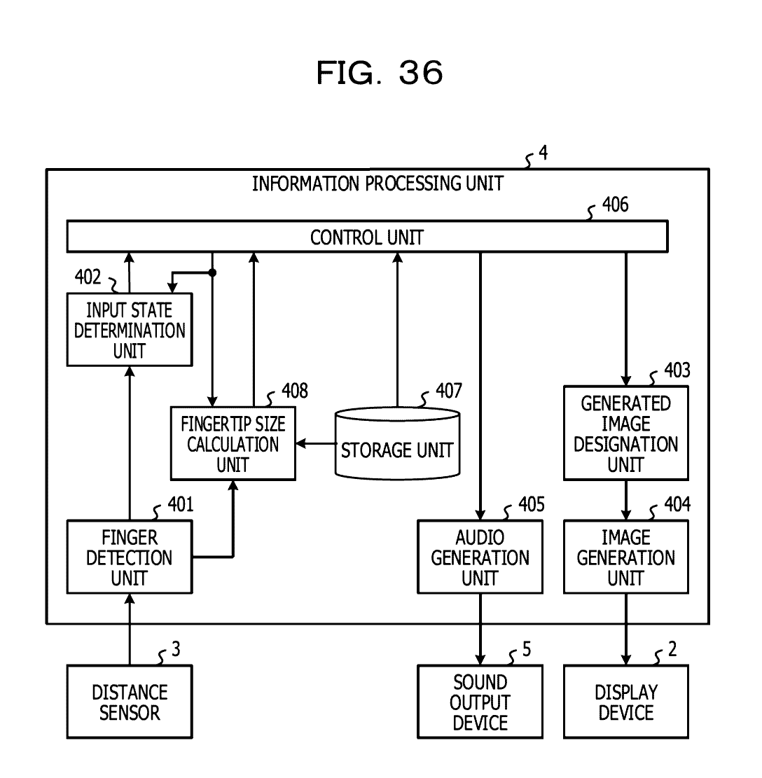

FIG. 36 is a diagram illustrating a functional configuration of an information processing device of an input device according to a second embodiment.

An input device 1 according to the present embodiment includes a display device 2, a distance sensor 3, an information processing device 4, and a sound output device (speaker) 5, similar to the input device 1 exemplified in the first embodiment. As illustrated in FIG. 36, the information processing device 4 in the input device 1 according to the first embodiment includes a finger detection unit 401, an input state determination unit 402, a generated image designation unit 403, an image generation unit 404, an audio generation unit 405, a control unit 406, and a storage unit 407. The information processing device 4 in the input device 1 according to the first embodiment includes a fingertip size calculation unit 408 in addition to the respective units described above.

The finger detection unit 401 determines the presence or absence of the finger of the operator, and calculates a distance from the stereoscopic image 6 to the fingertip in a case where the finger is present, based on the information obtained from the distance sensor 3. The finger detection unit 401 of the information processing device 4 according to the present embodiment measures the size of the fingertip based on the information acquired from the distance sensor 3, in addition to the process described above.

The fingertip size calculation unit 408 calculates the relative fingertip size in a display position, based on the size of the fingertip which is detected by the finger detection unit 401, and the standard fingertip size which is stored in the storage unit 407.

The input state determination unit 402 determines the current input state, based on the detection result from the finger detection unit 401 and the immediately preceding input state. The input state includes “non-selection”, “provisional selection”, “during press”, “input determination”, and “key repeat”. The input state further includes “movement during input determination”. “Movement during input determination” is a state of moving the stereoscopic image 6 including a button for which the state of “input determination” is continued, in the three-dimensional space.

The generated image designation unit 403 designates an image generated based on the immediately preceding input state, the current input state, and the fingertip size calculated by the fingertip size calculation unit 408, in other words, the information for generating the stereoscopic image 6 to be displayed.

The image generation unit 404 generates the display data of the stereoscopic image 6 according to designated information from the generated image designation unit 403, and outputs the display data to the display device 2.

The audio generation unit 405 generates a sound signal to be output when the input state is a predetermined state. For example, when the input state is changed from “during press” to “input determination” or when the input determination state continues for a predetermined period of time, the audio generation unit 405 generates a sound signal.

The control unit 406 controls the operations of the generated image designation unit 403, the audio generation unit 405, and the fingertip size calculation unit 408, based on the immediately preceding input state and the determination result of the input state determination unit 402. The immediately preceding input state is stored in a buffer provided in the control unit 406, or is stored in the storage unit 407. Further, the control unit 406 controls the allowable range or the like of deviation of the fingertip coordinates in the input state determination unit 402, based on information such as the size of the button in the displayed stereoscopic image 6.

The storage unit 407 stores an operation display image data group, an output sound data group, and a standard fingertip size. The operation display image data group is a set of a plurality of pieces of operation display image data (see FIG. 8) which are prepared for each stereoscopic image 6. The output sound data group is a set of data used when the audio generation unit 405 generates a sound.

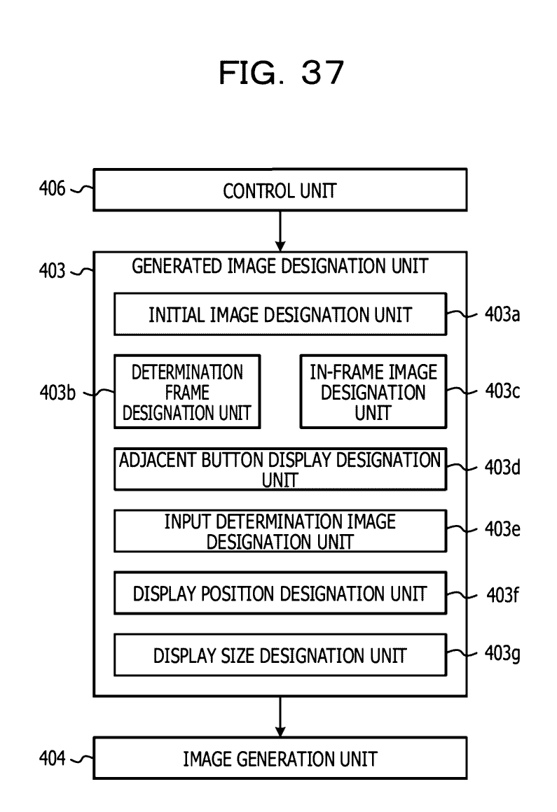

FIG. 37 is a diagram illustrating a functional configuration of the generated image designation unit according to the second embodiment.

The generated image designation unit 403 designates information for generating the stereoscopic image 6 to be displayed, as described above. The generated image designation unit 403 includes an initial image designation unit 403a, a determination frame designation unit 403b, an in-frame image designation unit 403c, an adjacent button display designation unit 403d, an input determination image designation unit 403e, and a display position designation unit 403f, as illustrated in FIG. 37. The generated image designation unit 403 according to this embodiment further includes a display size designation unit 403g.

The initial image designation unit 403a designates information for generating the stereoscopic image 6 in a case where the input state is “non-selection”. The determination frame designation unit 403b designates information about the input determination frame of the image of the button of which the input state is “provisional selection” or “during press”. The in-frame image designation unit 403c designates information about the input determination frame of the image of the button of which the input state is “provisional selection” or “during press”, in other words, information about the area 621a of the button image 621 of “provisional selection” and the area 622a of the button image 622 of “during press”. The adjacent button display designation unit 403d designates the display/non-display of other buttons which are adjacent to the button of which the input state is “provisional selection” or “during press”. The input determination image designation unit 403e designates the information about the image of the button of which the input state is “input determination”. The display position designation unit 403f designates the display position of the stereoscopic image including the button of which the input state is “movement during input determination” or the like. The display size designation unit 403g designates the display size of image of the button included in the stereoscopic image 6 to be displayed or the entire stereoscopic image 6, based on the fingertip size calculated by the fingertip size calculation unit 408.

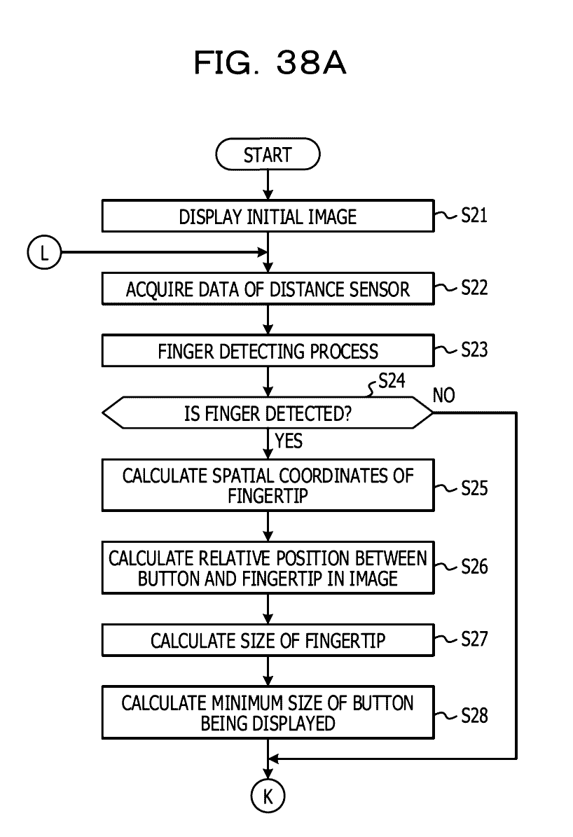

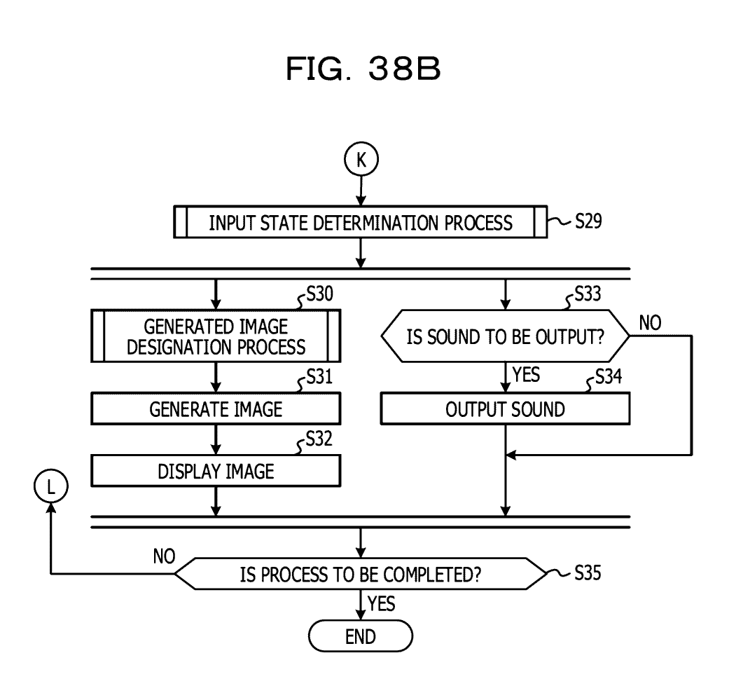

FIG. 38A is a flowchart illustrating a process that the information processing device according to the second embodiment performs (Part 1). FIG. 38B is a flowchart illustrating a process that the information processing device according to the second embodiment performs (Part 2).

As illustrated in FIG. 38A, first, the information processing device 4 according to the present embodiment displays an initial image (step S21). In step S21, in the information processing device 4, the initial image designation unit 403a of the generated image designation unit 403 designates information for generating the stereoscopic image 6 in a case where the input state is “non-selection”, and the image generation unit 404 generates display data of the stereoscopic image 6. The initial image designation unit 403a designates the information for generating the stereoscopic image 6 by using an operation display image data group of the storage unit 407. The image generation unit 404 outputs the generated display data to the display device 2, and displays the stereoscopic image 6 on the display device 2.

Next, the information processing device 4 acquires data that the distance sensor 3 outputs (step S22), and performs a finger detecting process (step S23). The finger detection unit 401 performs steps S22 and S23. The finger detection unit 401 checks whether or not the finger of the operator 7 is present within a detection range including a space in which the stereoscopic image 6 is displayed, based on the data acquired from the distance sensor 3. After step S23, the information processing device 4 determines whether or not the finger of the operator 7 is detected (step S24).

In a case where the finger of the operator 7 is detected (step S24; Yes), next, the information processing device 4 calculates the spatial coordinates of the fingertip (step S25), and calculates the relative position between the button and the fingertip (step S26). The finger detection unit 401 performs steps S25 and S26. The finger detection unit 401 performs the process of steps S25 and S26 by using a spatial coordinate calculation method and a relative position calculation method, which are known. The finger detection unit 401 performs, for example, a process of steps S601 to S607 illustrated in FIG. 13, as step S26.

After steps S25 and S26, the information processing device 4 calculates the size of the fingertip (S27), and calculates the minimum size of the button being displayed (step S28). The fingertip size calculation unit 408 performs steps S27 and S28. The fingertip size calculation unit 408 calculates the width of the fingertip in the display space, based on the detection information which is input from the distance sensor 3 through the finger detection unit 401. Further, the fingertip size calculation unit 408 calculates the minimum size of button in the display space, based on image data for the stereoscopic image 6 which is displayed, which is input through the control unit 406.

In a case where the finger of the operator 7 is detected (step S24; Yes), if the process of steps S25 to S28 is completed, as illustrated in FIG. 38B, the information processing device 4 performs the input state determination process (step S29). In contrast, in a case where the finger of the operator 7 is not detected (step S24; No), the information processing device 4 skips the process of steps S25 and S28, and performs the input state determination process (step S29).

The input state determination unit 402 performs the input state determination process of step S27. The input state determination unit 402 determines the current input state, based on the immediately preceding input state and the result of the process of steps S25 to S28. The input state determination unit 402 of the information processing device 4 according to the present embodiment determines the current input state, by performing, for example, the process of steps S701 to S721 illustrated in FIG. 17A to FIG. 17C.

If the input state determination process (step S29) is completed, next, the information processing device 4 performs a generated image designation process (step S30). The generated image designation unit 403 performs the generated image designation process. The generated image designation unit 403 designates information for generating the stereoscopic image 6 to be displayed, based on the current input state.

If the generated image designation process of step S30 is completed, the information processing device 4 generates display data of the image to be displayed (step S31), and displays the image on the display device 2 (step S32). The image generation unit 404 performs steps S31 and S32. The image generation unit 404 generates the display data of the stereoscopic image 6, based on the information designated by the generated image designation unit 403, and outputs the generated image data to the display device 2.

After the input state determination process (step S29), the information processing device 4 determines whether or not to output the sound in parallel with the process of steps S30 to S32 (step S33). For example, the control unit 406 performs the determination of step S33, based on the current input state. In a case of outputting the sound (step S33; Yes), the control unit 406 controls the audio generation unit 405 so as to generate sound data, and controls the sound output device 5 to output the sound (step S34). For example, in a case where the input state is “input determination” or “key repeat”, the control unit 406 determines to output the sound. In contrast, in a case of not outputting the sound (step S33; No), the control unit 406 skips the process of step S33.

If the process of steps S30 to S32 and the process of steps S33 and S34 are completed, the information processing device 4 determines whether to complete the process (step S35). In a case of completing the process (step S35; Yes), the information processing device 4 completes the process.

In contrast, in a case of continuing the process (step S35; No), the process to be performed by the information processing device 4 returns to the process of step S22. Hereinafter, the information processing device 4 repeats the process of steps S22 to S34 until the process is completed.

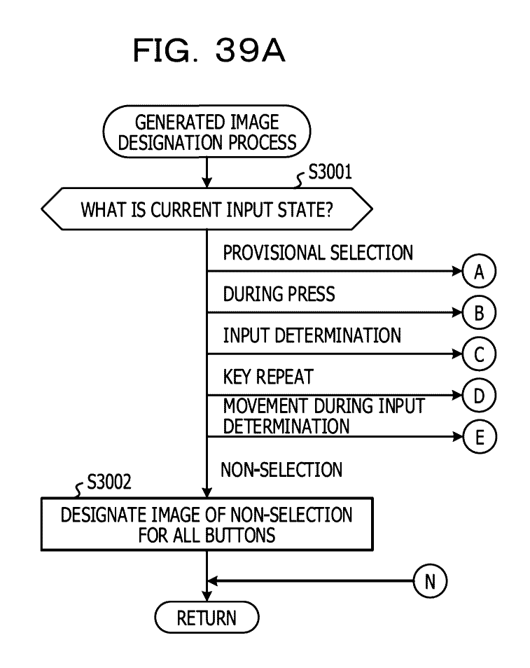

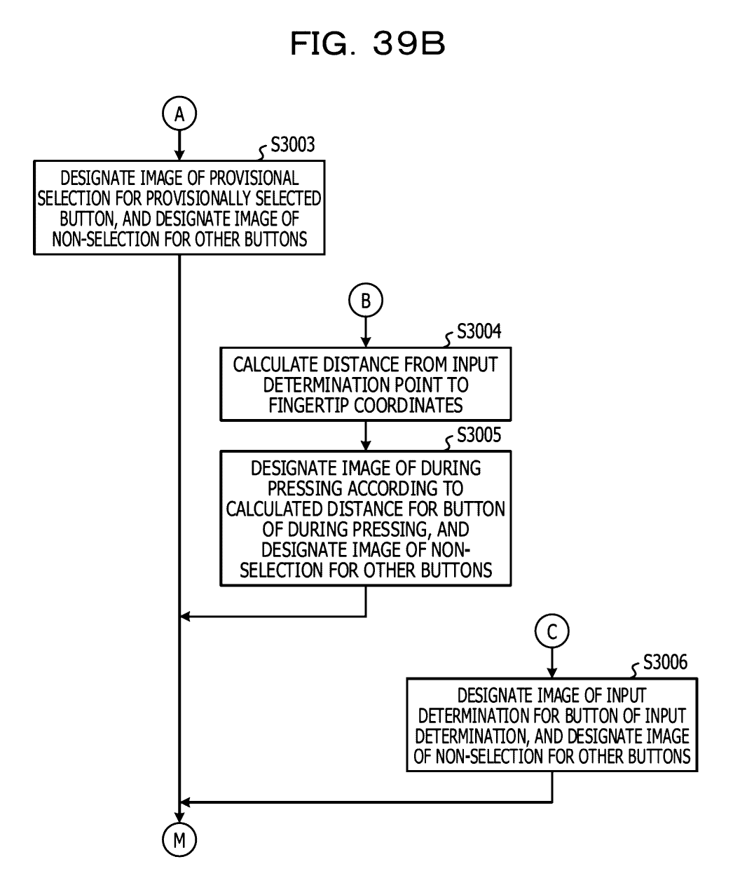

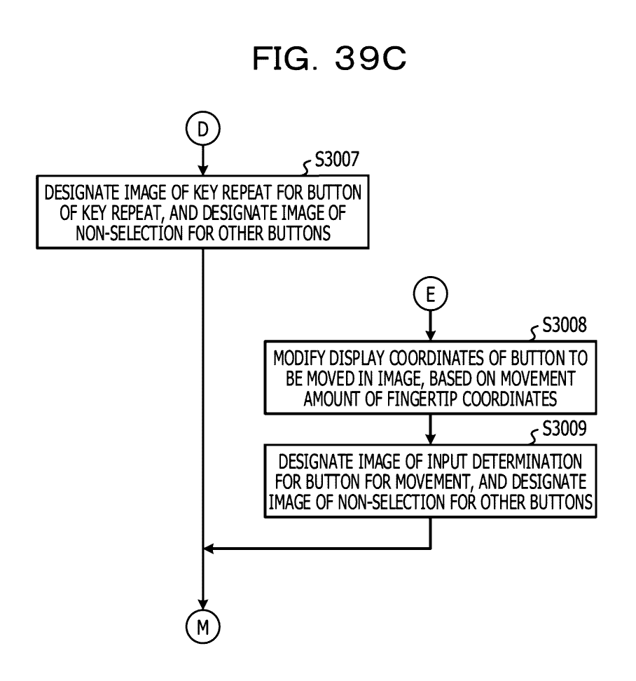

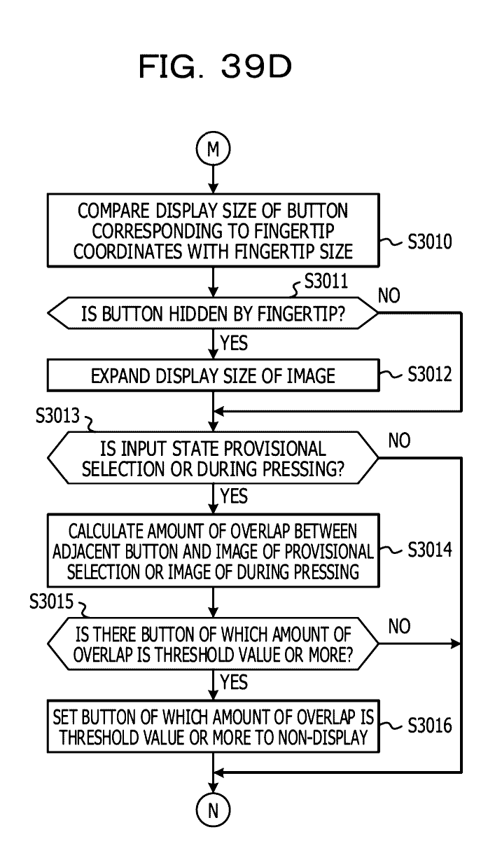

FIG. 39A is a flowchart illustrating a generated image designation process in the second embodiment (Part 1). FIG. 39B is a flowchart illustrating the generated image designation process in the second embodiment (Part 2). FIG. 39C is a flowchart illustrating the generated image designation process in the second embodiment (Part 3). FIG. 39D is a flowchart illustrating the generated image designation process in the second embodiment (Part 4).

The generated image designation unit 403 performs the generated image designation process of step S30. First, the generated image designation unit 403 determines the current input state, as illustrated in FIG. 39A (step S3001).

In a case where the current input state is determined as “non-selection” in step S3001, the generated image designation unit 403 designates the button image of “non-selection” for all buttons (step S3002). The initial image designation unit 403a performs the designation of step S3002.

In a case where the current input state is determined to “provisional selection” in step S3001, after step S3001, as illustrated in FIG. 39B, the generated image designation unit 403 designates the button image of “provisional selection” for the provisionally selected button, and the button image of “non-selection” for other buttons (step S3003). The initial image designation unit 403a, the determination frame designation unit 403b, and the in-frame image designation unit 403c perform the designation of step S3003. Further, in a case where the current input state is determined to “provisional selection” in step S3001, after step S3003, as illustrated in FIG. 39D, the generated image designation unit 403 performs a process of step S3010 to step S3016.

In a case where the current input state is determined to “during press” in step S3001, after step S3001, as illustrated in FIG. 39B, the generated image designation unit 403 calculates a distance from the input determination point to the fingertip coordinates (step S3004). Subsequently, the generated image designation unit 403 designates the button image of “during press” according to the distance which is calculated for the button of “during press”, and designates other buttons to the button image of “non-selection” (step S3005). The initial image designation unit 403a, the determination frame designation unit 403b, and the in-frame image designation unit 403c perform the designation of step S3005. In a case where the current input state is determined to “during press” in step S3001, after step S3003, as illustrated in FIG. 39D, the generated image designation unit 403 performs the processes of steps S3010 to S3016.

In a case where the current input state is determined to “input determination” in step S3001, after step S3001, as illustrated in FIG. 39B, the generated image designation unit 403 designates the button image 623 of “input determination” for the button of “input determination”, and designates the button image of “non-selection” for other buttons (step S3006). The input determination image designation unit 403e performs step S3006. In a case where the current input state is determined to “input determination” in step S3001, after step S3003, the generated image designation unit 403 performs the processes of steps S3010 to S3013 illustrated in FIG. 39D.

In a case where the current input state is determined to “key repeat” in step S3001, after step S3001, as illustrated in FIG. 39C, the generated image designation unit 403 designates the button image 624 of “key repeat” for the button of “key repeat”, and designates the button image 620 of “non-selection” for other buttons (step S3007). For example, the input determination image designation unit 403e performs step S3007. In a case where the current input state is determined to “key repeat” in step S3001, after step S3007, the generated image designation unit 403 performs the processes of steps S3010 to S3013 illustrated in FIG. 39D.

In a case where the current input state is determined to “movement during input determination” in step S3001, after step S3001, as illustrated in FIG. 39C, the generated image designation unit 403 modifies the display coordinates of the button in the stereoscopic image, based on the movement amount of the fingertip coordinates (step S3008). Thereafter, the generated image designation unit 403 designates the button image 623 of “input determination” for the button of which the display position is moved, and designates the button image of “non-selection” for other buttons (step S3009). The input determination image designation unit 403e and the display position designation unit 403f perform steps 3008 and 3009. In a case where the current input state is determined to “movement during input determination” in step S3001, after step S3003, the generated image designation unit 403 performs the processes of steps S3010 to S3013 illustrated in FIG. 39D.

In a case where the current input state is a state other than “non-selection”, as described above, the generated image designation unit 403 designates the image or the display position of the button to be displayed, and then performs step S3010 and the subsequent process illustrated in FIG. 39D. In other words, the generated image designation unit 403 compares the display size of the button corresponding to fingertip spatial coordinates with the fingertip size (step S3010), and determines whether or not the button is hidden by the fingertip in a case of displaying the button in the current display size (step S3011). The display size designation unit 403g performs steps S3010 and step S3011. The display size designation unit 403g calculates, for example, a difference between the fingertip size calculated in step S27 and the display size of the button calculated in step S28, and determines whether or not the difference is a threshold or more.

In a case where it is determined that the button is hidden by the fingertip (step S3011; Yes), the display size designation unit 403g expands the display size of the button (step S3012). In step S3012, the display size designation unit 403g designates the display size of the entire stereoscopic image 6, or only the display size of each button in the stereoscopic image 6. After the display size designation unit 403g expands the display size of the button, the generated image designation unit 403 determines whether or not the input state is “provisional selection” or “during press” (step S3013). In contrast, in a case where it is determined that the button is not hidden (step S3011; No), the display size designation unit 403g skips the process of step S3012, and performs the determination of step S3013.

In a case where the current input state is “provisional selection” or “during press” (step S3013; Yes), next, the generated image designation unit 403 calculates the amount of overlap between the adjacent button and the button image of “provisional selection” or “during press” (step S3014). The adjacent button display designation unit 403d performs step S3014. If the amount of overlap is calculated, next, the adjacent button display designation unit 403d determines whether or not there is a button of which the amount of overlap is the threshold value or more (step S3015). In a case where there is a button of which the amount of overlap is the threshold value or more (step S3015; Yes), the adjacent button display designation unit 403d sets the corresponding button to non-display (step S3016). In contrast, in a case where there is no button of which the amount of overlap is the threshold value or more (step S3015; No), the adjacent button display designation unit 403d skips the process of step S3016.

In addition, in a case where the current input state is nether “provisional selection” nor “during press” (step S3013; No), the generated image designation unit 403 skips step S3014 and the subsequent process.

In this way, in a case where the input state is “provisional selection” or “during press” and it is determined that the button is hidden by the fingertip, the information processing device 4 in the input device 1 of this embodiment expands the display size of the button. Thus, when performing an operation to press the button, the operator 7 can press a button while viewing the position (pressed area) of the button. Therefore, it is possible to reduce input errors caused by moving the fingertip to the outside of the pressed area during the press operation.

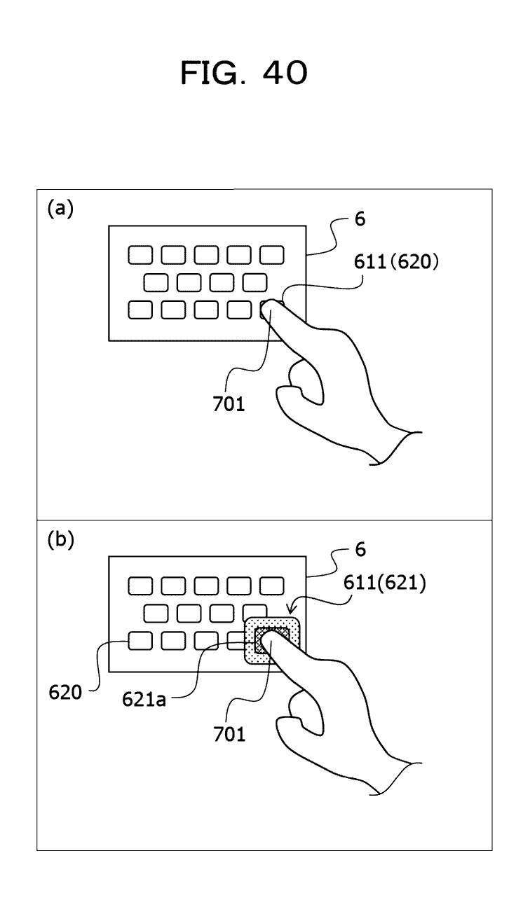

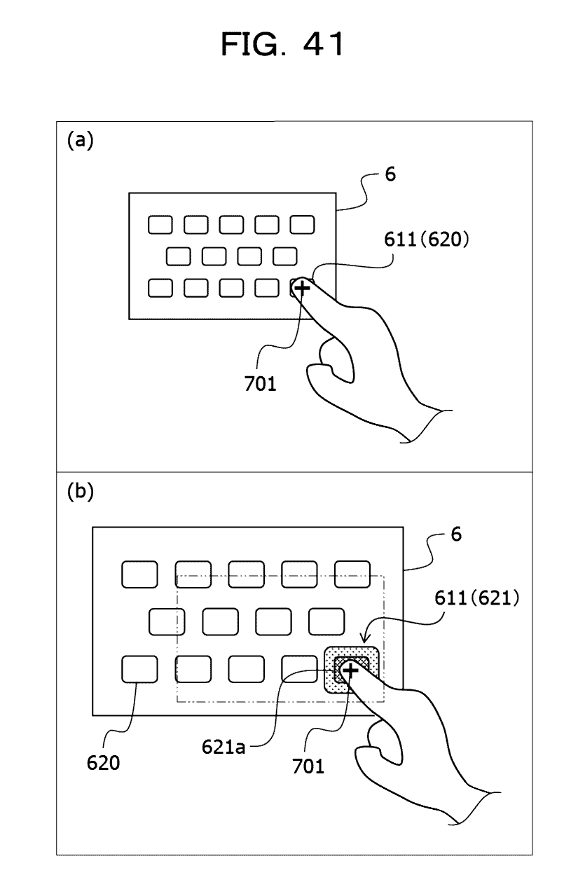

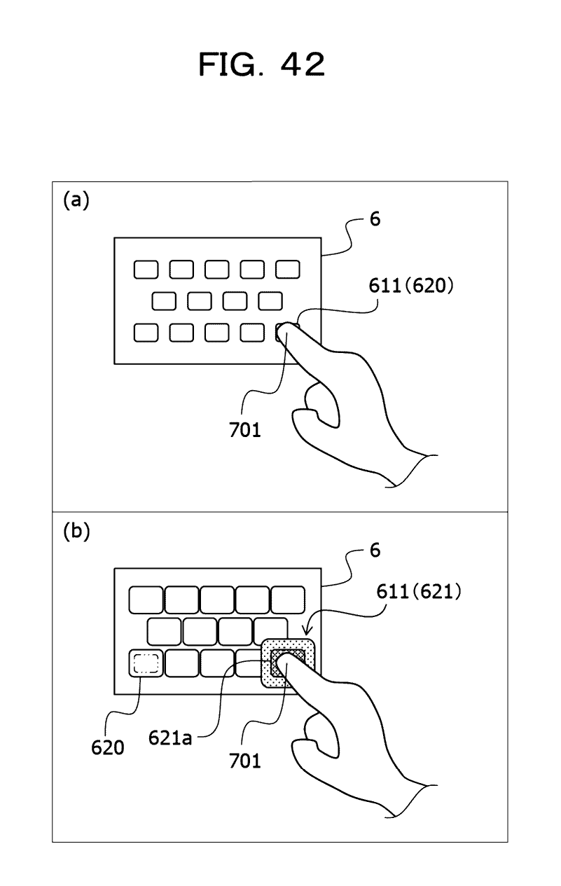

FIG. 40 is a diagram illustrating a first example of a method of expanding the display size of a button. FIG. 41 is a diagram illustrating a second example of a method of expanding the display size of the button. FIG. 42 is a diagram illustrating a third example of a method of expanding the display size of the button.

In the input device 1 according to the present embodiment, there are several types of methods of expanding the display size of the button. For example, as illustrated in FIG. 40, there is a method of expanding only the display size of the button of which the input state is “provisional selection” or “during press”, without changing the display size of the stereoscopic image 6. It is assumed that the stereoscopic image 6 illustrated in (a) of FIG. 40 is displayed, for example, in the display size which is designated in the operation display image data (see FIG. 8). In this case, if the size (width) of the fingertip 701 of the operator 7 is thicker than the standard size, when the button is pressed down with the fingertip 701, the button is hidden by the fingertip 701. In this way, if the button is hidden by the fingertip 701, when the fingertip 701 is moved in the depth direction, it is difficult to know the pressed area, and the fingertip while moving is likely to come out to the outside of the pressed area. In other words, in a case where the button is hidden by the fingertip 701, it is considered that the operator 7 may view at least the button 645 that the operator 7 intends to press. Therefore, in the first example of the expansion method, as illustrated in (b) of FIG. 40, only the display size of the button is expanded and displayed.

Further, when expanding the display size of the button, for example, as illustrated in FIG. 41, the display size of the entire stereoscopic image 6 may be expanded. It is assumed that the stereoscopic image 6 illustrated in (a) of FIG. 41 is displayed in the display size which is designated in, for example, the operation display image data (see FIG. 8). In this case, if the size (width) of the fingertip 701 of the operator 7 is thicker than the standard size, when the button is pressed down with the fingertip 701, the button is hidden by the fingertip 701. In this case, for example, as illustrated in (b) of FIG. 41, if the display size of the entire stereoscopic image 6 is expanded, the size of each button in the stereoscopic image 6 is expanded. Thus, it is possible to avoid the button from being hidden by the fingertip 701. Further, in a case of expanding the entire stereoscopic image 6, for example, the stereoscopic image 6 is expanded with the plane position of the fingertip 701 as a center. Thus, it is possible to avoid the button that is selected as an operation target by the fingertip 701 before expanding from being shifted to a position spaced apart from the fingertip 701 after expanding. For example, after pressing the button 645, the operator 7 may move the fingertip 701 in the vicinity of the display surface of the stereoscopic image 6 in order to press another button. In this case, if the display size of the entire stereoscopic image 6 is expanded, all other buttons are also expanded, such that it is possible to avoid the button from being hidden by the fingertip 701 moving in the vicinity of the display surface. Therefore, the alignment of the button and the fingertip before pressing the button, in other words, in a stage where the input state is “non-selection” is facilitated.

In addition, when expanding the display size of the button, for example, as illustrated in (a) and (b) of FIG. 42, without changing the display size of the entire stereoscopic image 6, only the display size of each button may be expanded. In this case, since the display size of the entire stereoscopic image 6 is not changed but all buttons are enlarged and displayed, it is possible to avoid the button from being hidden by the fingertip 701 moving in the vicinity of the display surface. Therefore, the alignment of the button and the fingertip before pressing the button, in other words, in a stage where the input state is “non-selection” is facilitated.

### Third Embodiment

In the present embodiment, a description will be given on another procedure of the process that the information processing device 4 according to the second embodiment performs.

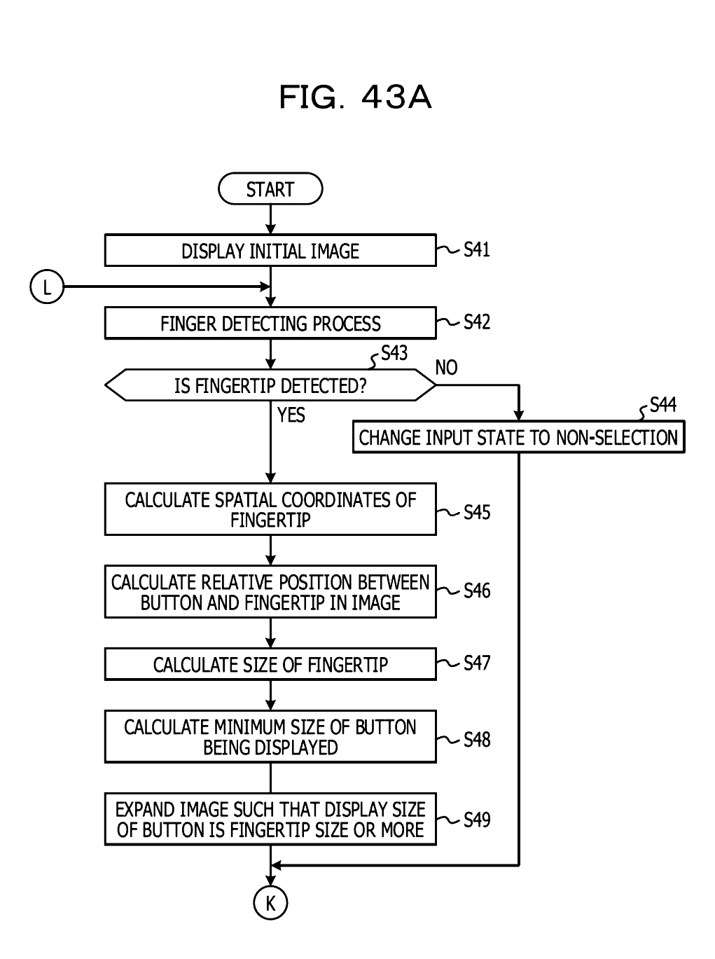

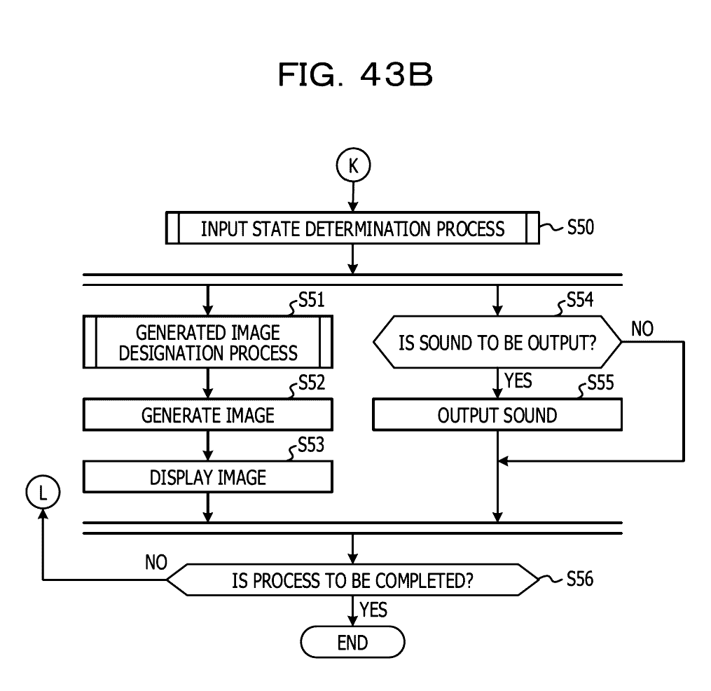

FIG. 43A is a flowchart illustrating a process that the information processing device according to the third embodiment performs (Part 1). FIG. 43B is a flowchart illustrating a process that the information processing device according to the third embodiment performs (Part 2).

As illustrated in FIG. 43A, first, the information processing device 4 according to the present embodiment displays an initial image (step S41). In step S41, in the information processing device 4, the initial image designation unit 403a of the generated image designation unit 403 designates information for generating the stereoscopic image 6 in a case where the input state is “non-selection”, and the image generation unit 404 generates display data of the stereoscopic image 6. The initial image designation unit 403a designates the information for generating the stereoscopic image 6 by using an operation display image data group of the storage unit 407. The image generation unit 404 outputs the generated display data to the display device 2, and displays the stereoscopic image 6 on the display device 2.

Next, the information processing device 4 acquires data that the distance sensor 3 outputs, and performs a finger detecting process (step S42). The finger detection unit 401 performs steps S42. The finger detection unit 401 checks whether or not the finger of the operator 7 is present within a detection range including a space in which the stereoscopic image 6 is displayed, based on the data acquired from the distance sensor 3. After step S42, the information processing device 4 determines whether or not the finger of the operator 7 is detected (step S43). In a case where the finger of the operator 7 is not detected (step S43; No), the information processing device 4 changes the input state to “non-selection” (step S44), and successively performs the input state determination process illustrated in FIG. 43B (step S50).

In a case where the finger of the operator 7 is detected (step S43; Yes), next, the information processing device 4 calculates the spatial coordinates of the fingertip (step S45), and calculates the relative position between the button and the fingertip (step S46). The finger detection unit 401 performs steps S45 and S46. The finger detection unit 401 performs the process of steps S45 and S46 by using a spatial coordinate calculation method and a relative position calculation method, which are known. The finger detection unit 401 performs, for example, a process of steps S601 to S607 illustrated in FIG. 13, as step S46.

After steps S45 and S46, the information processing device 4 calculates the size of the fingertip (S47), and calculates the minimum size of the button that is displayed (step S48). The fingertip size calculation unit 408 performs steps S47 and S48. The fingertip size calculation unit 408 calculates the width of the fingertip in the display space, based on the detection information which is input from the distance sensor 3 through the finger detection unit 401. Further, the fingertip size calculation unit 408 calculates the minimum size of button in the display space, based on image data for the stereoscopic image 6 being displayed, which is input through the control unit 406.

After steps S47 and S48, the information processing device 4 expands the stereoscopic image such that the display size of the button is the fingertip size or more (step S49). The display size designation unit 403g of the generated image designation unit 403 performs step S49. The display size designation unit 403g determines whether or not to expand the display size, based on the fingertip size which is calculated in step S47 and the display size of the button which is calculated in step 48. In a case of expanding the display size, the information processing device 4 generates, for example, a stereoscopic image 6 in which buttons are expanded by the expansion methods illustrated in FIG. 41 or FIG. 42, and displays the expanded stereoscopic image 6 on the display device 2.

In a case where the finger of the operator 7 is detected (step S43; Yes), if the process of steps S45 to S49 is completed, as illustrated in FIG. 43B, the information processing device 4 performs the input state determination process (step S50).

The input state determination unit 402 performs the input state determination process of step S50. The input state determination unit 402 determines the current input state, based on the immediately preceding input state and the result of the process of steps S45 to S49. The input state determination unit 402 of the information processing device 4 according to the present embodiment determines the current input state, by performing, for example, the process of steps S701 to S721 illustrated in FIG. 17A to FIG. 17C.

If the input state determination process (step S50) is completed, next, the information processing device 4 performs a generated image designation process (step S51). The generated image designation unit 403 performs the generated image designation process. The generated image designation unit 403 designates information for generating the stereoscopic image 6 to be displayed, based on the current input state. The generated image designation unit 403 of the information processing device 4 according to the present embodiment designates information for generating the stereoscopic image 6, by performing, for example, the process of steps S801 to S812 illustrated in FIG. 18A to FIG. 18C.

If the generated image designation process of step S51 is completed, the information processing device 4 generates display data of the image to be displayed (step S52), and displays the image on the display device 2 (step S53). The image generation unit 404 performs steps S52 and S53. The image generation unit 404 generates the display data of the stereoscopic image 6, based on the information designated by the generated image designation unit 403, and outputs the generated image data to the display device 2.

Further, after the input state determination process (step S50), the information processing device 4 determines whether or not to output the sound in parallel with the process of steps S51 and S52 (step S54). For example, the control unit 406 performs the determination of step S54, based on the current input state. In a case of outputting the sound (step S54; Yes), the control unit 406 controls the audio generation unit 405 so as to generate sound data, and controls the sound output device 5 to output the sound (step S55). For example, in a case where the input state is “input determination” or “key repeat”, the control unit 406 determines to output the sound. In contrast, in a case of not outputting the sound (step S54; No), the control unit 406 skips the process of step S55.

If the process of steps S51 to S53 and the process of steps S54 and S55 are completed, the information processing device 4 determines whether to complete the process (step S56). In a case of completing the process (step S56; Yes), the information processing device 4 completes the process.

In contrast, in a case of continuing the process (step S56; No), the process to be performed by the information processing device 4 returns to the process of step S42. Hereinafter, the information processing device 4 repeats the process of steps S42 to S55 until the process is completed.

In this way, in the process that the information processing device 4 according to the present embodiment performs, in a case where the fingertip 701 of the operator 7 is detected, the button is expanded and displayed such that the display size of the button becomes equal to or greater than the fingertip size, irrespective of the input state. Therefore, even in a case where the input state is neither a state of “provisional selection” nor “during press”, it becomes possible to expand and display the button. Thus, for example, even in a case where the operator 7 presses a button and thereafter the moves the fingertip 701 in the vicinity of the display surface of the stereoscopic image 6 to press another button, it is possible to avoid the button from being hidden by the fingertip 701 which is moved in the vicinity of the display surface. This facilitates the alignment between the fingertip and the button before being pressed, in other words, when the input state is “non-selection”.

### Fourth Embodiment

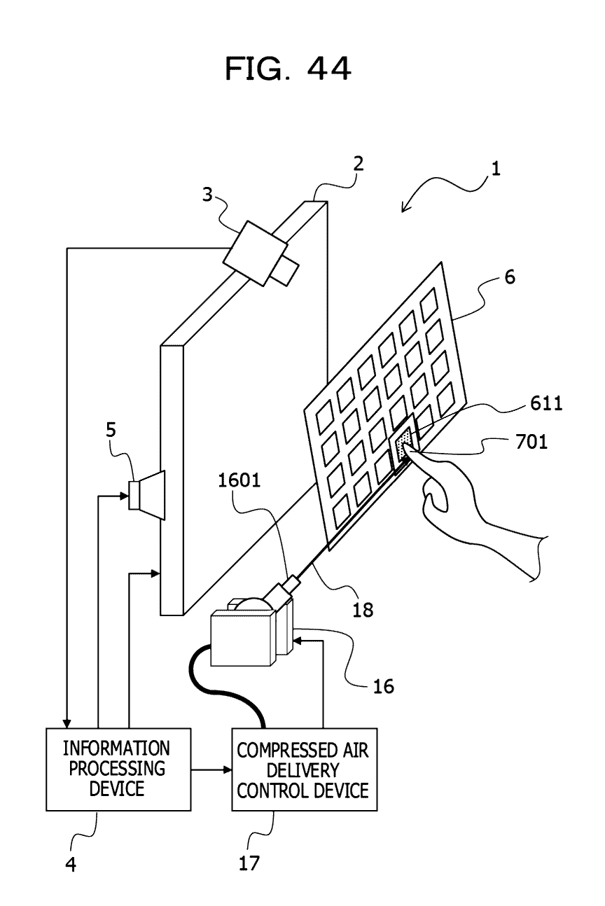

FIG. 44 is a diagram illustrating a configuration example of an input device according to a fourth embodiment.

As illustrated in FIG. 44, an input device 1 according to the present embodiment includes a display device 2, a distance sensor 3, an information processing device 4, a sound output device (speaker) 5, a compressed air injection device 16, and a compressed air delivery control device 17. Among them, the display device 2, the distance sensor 3, the information processing device 4, and the sound output device 5 have respectively the same configurations and functions as those described in the first embodiment to the third embodiment.

The compressed air injection device 16 is a device that injects compressed air 18. The compressed air injection device 16 of the input device 1 of the present embodiment is configured to be able to change, for example, the orientation of an injection port 1601, and is possible to return the injection direction as appropriate toward the display space of the stereoscopic image 6 when injecting the compressed air 18.

The compressed air delivery control device 17 is a device that controls the orientation of the injection port 1601 of the compressed air injection device 16, the injection timing, the injection pattern or the like of the compressed air.

The input device 1 of the present embodiment displays an input determination frame around the button to be pressed, when detecting an operation that the operator 7 presses the button 601 in the stereoscopic image 6, similar to those described in the first embodiment to the third embodiment.

Furthermore, in a case where there is a button of which the input state is other than “non-selection”, the input device 1 of this embodiment blows compressed air 18 to the fingertip 701 of the operator 7 by the compressed air injection device 16. This makes it possible to give the fingertip 701 of the operator 7 a similar sense of touch, that is, a sense as if the user presses the button of a real object.

The information processing device 4 of the input device 1 of this embodiment performs the process described in each embodiment described above. Further, in a case where the current input state is determined to be other than “non-selection” in the input state determination process, the information processing device 4 outputs a control signal including the current input state and the spatial coordinates of the fingertip which is calculated by the finger detection unit 401, to the compressed air delivery control device 17. The compressed air delivery control device 17 controls the orientation of the injection port 1601, based on the control signal from the information processing device 4, and injects the compressed air in the injection pattern corresponding to the current input state.

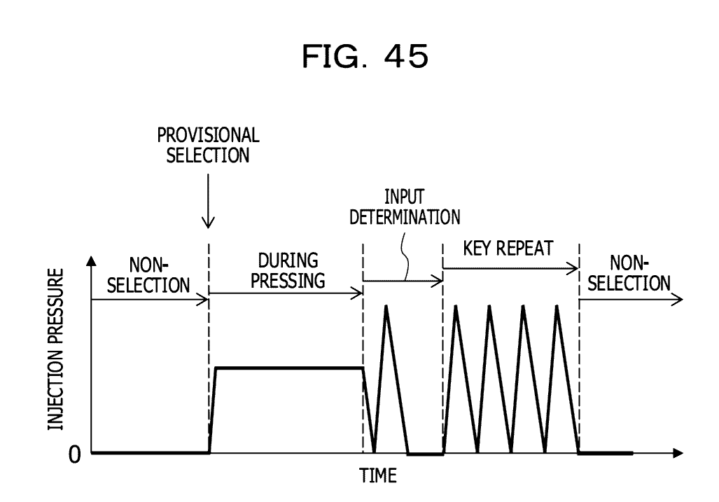

FIG. 45 is a graph illustrating the injection pattern of the compressed air. In the graph illustrated in FIG. 45, a horizontal axis represents time, and a vertical axis represents the injection pressure of the compressed air.

When the operator 7 of the input device 1 performs an operation to press the button 601 of the stereoscopic image 6, the input state for the button 601 starts from “non-selection”, changes in order of “provisional selection”, “during press”, “input determination”, and “key repeat”, and returns to “non-selection”, as illustrated in FIG. 45. In a case where the input state is “non-selection”, since the button 601 is not touched with the fingertip 701 of the operator 7, it does not have to give the sense of touch by the compressed air. Therefore, the injection pressure in a case where the input is “non-selection” is set to 0 (no injection). Thereafter, if the button 601 is touched with the fingertip 701 of the operator 7 and the input state becomes “provisional selection”, the compressed air delivery control device 17 controls the compressed air injection device 16 to inject compressed air having a low injection pressure in order to give a sense of touching the button 601. If the fingertip 701 of the operator 7 is moved in the pressing direction and the input state becomes “during press”, the compressed air delivery control device 17 controls the compressed air injection device 16 so as to inject the compressed air having a higher injection pressure than at the time of “provisional selection”. Thus, the sense of touch having a resistance similar to the resistance when pressing the button of the real object is given to the fingertip 701 of the operator 7.

If the fingertip 701 of the operator 7 moving in the pressing direction reaches the input determination point and the input state becomes “input determination”, the compressed air delivery control device 17 controls the compressed air injection device 16 to lower once injection pressure, and instantaneously injects the compressed air having a high injection pressure. Thus, the sense of touch similar to click sense when pressing the button of the real object and determining the input is given to the fingertip 701 of the operator 7.

If a state where the input state is “input determination” continues for a predetermined time and the input state becomes “key repeat”, the compressed air delivery control device 17 controls the compressed air injection device 16 to intermittently inject the compressed air having a high injection pressure. If the operator 7 performs an operation to separate the fingertip 701 from the button and the input state becomes “non-selection”, the compressed air delivery control device 17 controls the compressed air injection device 16 to terminate the injection of the compressed air.

In this way, it is possible to give a sense of touch as when pressing the button of the real object to the operator 7, by injecting the compressed air in the injection pressure and the injection pattern corresponding to the sense of touch obtained in the fingertip 701 when pressing the button of the real object.

In addition, the injection pattern of the compressed air illustrated in FIG. 45 is only an example, and it is possible to change the injection pressure and the injection pattern as appropriate.

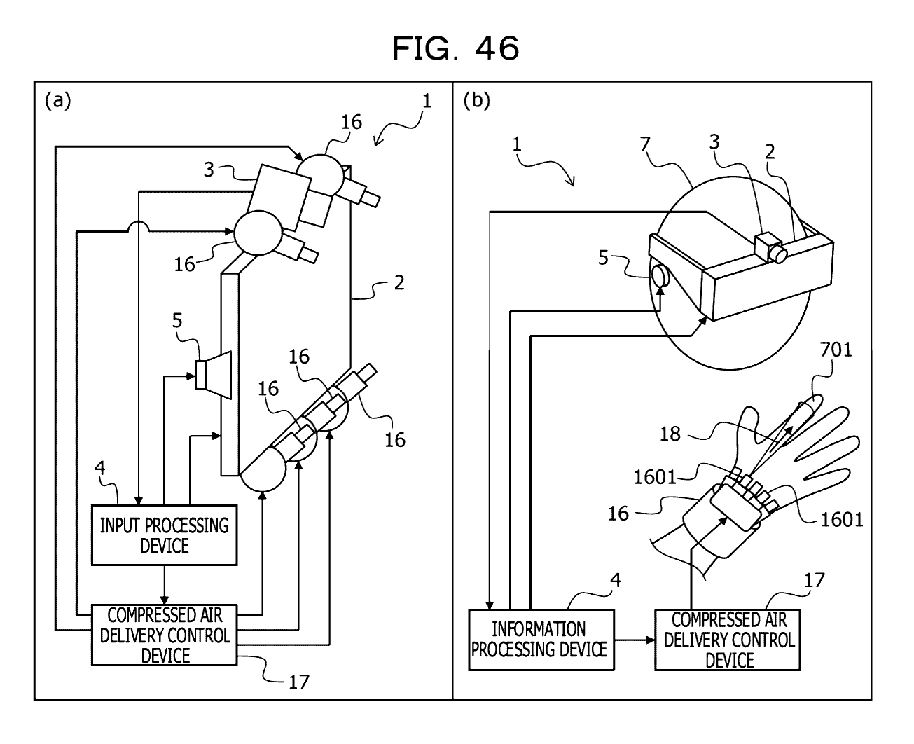

FIG. 46 is a diagram illustrating another configuration example of the input device according to the fourth embodiment.

In the input device 1 according to the present embodiment, it is possible to change the configuration the compressed air injection device 16 and the number thereof as appropriate. Therefore, for example, as illustrated in (a) of FIG. 46, a plurality of compressed air injection devices 16 can be provided in each of the upper side portion and the lower side portion of the display device 2. Since the plurality of compressed air injection devices 16 are provided in this way, it becomes possible to inject the compressed air 18 to the fingertip 701 from the direction close to the opposite direction of the movement direction of the fingertip 701 pressing the button. This enables giving the operator 7 a sense of touch closer to when pressing the button of the real object.

Further, the compressed air injection device 16 may be, for example, a type being mounted on the wrist of the operator 7, as illustrated in (b) of FIG. 46. This type of compressed air injection device 16 includes, for example, five injection ports 1601, and it is possible to individually inject the compressed air 18 from each injection port 1601. If the compressed air injection device 16 is mounted on the wrist in this way, it is possible to inject the compressed air to the fingertip from the position closer to the fingertip touching the button. Therefore, it becomes possible to give the fingertip 701 a similar sense of touch, with the compressed air having a lower injection pressure, as compared with the input devices 1 illustrated in FIG. 45 and (a) of FIG. 46. Since the position of the injection port becomes close to the fingertip 701, it is possible to suppress the occurrence of situation in which the injection direction of the compressed air 18 is deviated and the compressed air 18 does not reach the fingertip 701.

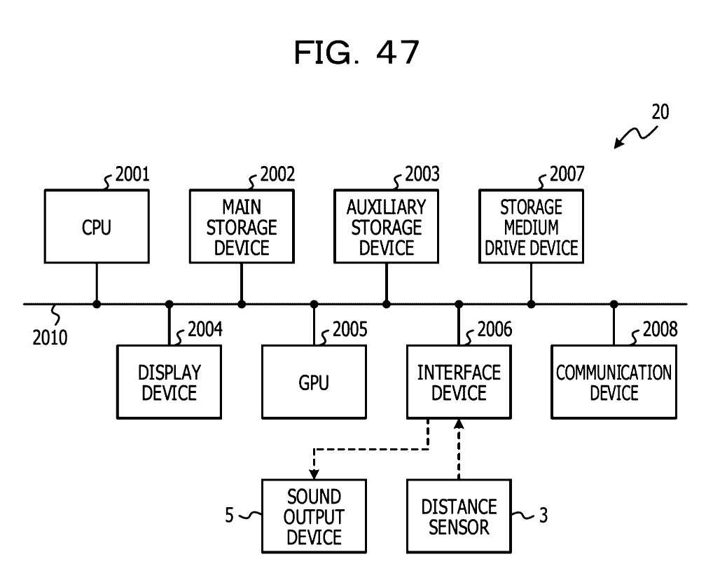

It is possible to implement the input devices 1 described in the first embodiment to the fourth embodiment by using a computer and a program to be executed by the computer. Hereinafter, the input device 1 which is implemented using a computer and a program will be described with reference to FIG. 47.

FIG. 47 is a diagram illustrating a hardware configuration of a computer. As illustrated in FIG. 47, the computer 20 that operates as the input device 1 includes a central processing unit (CPU) 2001, a main storage device 2002, an auxiliary storage device 2003, and a display device 2004. Further, the computer 20 further includes a graphics processing unit (GPU) 2005, an interface device 2006, a storage medium drive device 2007, ad a communication device 2008. These elements 2001 to 2008 in the computer 20 are connected to each other through a bus 2010, which enables transfer of data between the elements.

The CPU 2001 is an arithmetic processing unit that controls the overall operation of the computer 20 by executing various programs including an operating system.

The main memory device 2002 includes a read only memory (ROM) and a random access memory (RAM), which are not illustrated. For example, a predetermined basic control program, or the like that the CPU 2001 reads at the startup of the computer 20 is recorded in advance in the ROM. Further, the RAM is used as a working memory area if it is desired, when the CPU 2001 executes various programs. The RAM of the main storage device 2002 is available for temporarily storing, for example, operation display image data (see FIG. 8) about the stereoscopic image that is currently displayed, the immediately preceding input state, or the like.

The auxiliary storage device 2003 is a storage device having a larger capacity compared to a main storage device 2002 such as a hard disk drive (HDD) and a solid state drive (SSD). It is possible to store various programs which is executed by the CPU 2001 and various data in the auxiliary storage device 2003. Examples of the program stored in the auxiliary storage device 2003 include a program for generating a stereoscopic image. In addition, examples of the data stored in the auxiliary storage device 2003 include an operation display image data group, an output sound data group, and the like.

The display device 2004 is a display device capable of displaying the stereoscopic image 6 such as a naked eye 3D liquid crystal display, a liquid crystal shutter glasses-type 3D display. The display device 2004 displays various texts, a stereoscopic image or the like, according to the display data sent from the CPU 2001 and the GPU 2005.

The GPU 2005 is an arithmetic processing unit that performs some or all of the processes in the generation of the stereoscopic image 6 in response to the control signal from the CPU 2001.

The interface device 2006 is an input output device that connects the computer 20 and other electronic devices, and enables the transmission and reception of data between the computer 20 and other electronic devices. The interface device 2006 includes, for example, a terminal capable of connecting a cable with a connector of a universal serial bus (USB) standard, or the like. Examples of the electronic device connectable to the computer 20 by the interface device 2006 include a distance sensor 3, an imaging device (for example, a digital camera), or the like.

The storage medium drive device 2007 performs reading of program and data which are recorded in a portable storage medium which is not illustrated, and writing of the data or the like stored in the auxiliary storage device 2003 to the portable storage medium. For example, a flash memory equipped with a connector of the USB standard is available as the portable storage medium. As the portable storage medium, an optical disk such as a compact disk (CD), a digital versatile disc (DVD), a Blu-ray Disc (Blu-ray is a registered trademark) is also available.

The communication device 2008 is device that communicably connects the computer 20 and the Internet or a communication network such as a local area network (LAN), and controls the communication with another communication terminal (computer) through the communication network. The computer 20 can transmit, for example, the information that the operator 7 inputs through the stereoscopic image 6 (the operation screen) to another communication terminal. Further, the computer 20 acquires, for example, various data from another communication terminal based on the information that the operator 7 inputs through the stereoscopic image 6 (the operation screen), and displays the acquired data as the stereoscopic image 6.

In the computer 20, the CPU 2001 reads a program including the processes described above, from the auxiliary storage device 2003 or the like, and executes a process of generating the stereoscopic image 6 in cooperation with the GPU 2005, the main storage device 2002, the auxiliary storage device 2003, or the like. At this time, the CPU 2001 executes the process of detecting the fingertip 701 of the operator 7, the input state determination process, the generated image designation process, and the like. Further, the GPU 2005 performs a process for generating a stereoscopic image.

Incidentally, the computer 20 which is used as the input device 1 may not include all of the components illustrated in FIG. 47, and it is also possible to omit some of the components depending on the application and conditions. For example, in a case of the high throughput of the CPU 2001, the GPU 2005 may be omitted, and the CPU 2001 may perform all of the arithmetic processes described above.

Further, the computer 20 is not limited to a generic type computer that realizes a plurality of functions by executing various programs, but may be an information processing device specialized for the process for causing the computer to operate as the input device 1.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An input system for performing a plurality of operations on a stereoscopic image displayed on a three-dimensional space, the input system comprising:
a display device configured to display the stereoscopic image including a display surface having a plurality of buttons in the three-dimensional space, the plurality of buttons being associated with the plurality of operations;
a detector configured to detect an object inputting on the stereoscopic image; and
an information processing device comprising a memory and a processor configured to:
notify a user, who performs an inputting operation on the stereoscopic image, of an amount in a depth direction of the display surface, from when an input state by the object is a provisional selection state to when the input state by the object is a determination state,
wherein the amount is an additional numerical value indicating how much the object has to move in the depth direction to set the input state to be the determination state,
wherein the provisional selection state is set when the object is in contact with a button among the plurality of buttons, and
wherein the determination state is set when the object is moved by the amount.

2. The input system according to claim 1, wherein the processor is further configured to:
determine an initial position of the object in the three-dimensional space,
determine whether the input state by the object is the provisional selection state based on a positional relationship between the initial position and a display position of the button in the three-dimensional space,
determine whether the input state by the object is the determination state based on a detection result by the detector, and
perform an operation associated with the button when the input state is the determination state.

3. The input system according to claim 1, wherein the processor is further configured to:
determine whether the input state by the object is a pressing state, in which the object continues to press the button among the plurality of buttons, and
designate a display size of the button such that an outer periphery of the button becomes closer to an input determination frame as the amount becomes closer to specific amount for setting the input state to be the determination state,
wherein the input determination frame is designated with a predetermined size surrounding the button.

4. The input system according to claim 1, wherein the processor is further configured to:
calculate a size of the object based on a detection result by the detector, and
designate a display size of the button in the stereoscopic image to be displayed on the three-dimensional space based on the calculated size of the object and a predetermined display size of the button on the three-dimensional space.

5. The input system according to claim 4, wherein the calculated size of the object and the display size of the button on the three-dimensional space are viewed from a predetermined point of view.

6. The input system according to claim 3, wherein the processor is further configured to designate a color of the button to be displayed within the input determination frame to a color scheme that changes from a center of the button.

7. The input system according to claim 3, wherein the processor is further configured to change a display of other buttons adjacent to the button, which is included in the input determination frame, when the input determination frame is displayed.

8. The input system according to claim 2, wherein the stereoscopic image includes a movement button, which moves the stereoscopic image within the display surface,
wherein the processor is further configured to designate a display position of the stereoscopic image based on a movement amount of the object when the input state of the movement button is a movement during input determination state, and
wherein the movement during input determination state is a state, in which the stereoscopic image having the button in the determination state is continuously moved.

9. The input system according to claim 1, wherein the stereoscopic image is an image, in which a plurality of operation screens are arranged in the depth direction of the display surface, and
wherein the processor is further configured to change displays of the plurality of operation screens other than the operation screen including the button.

10. The input system according to claim 3, wherein the processor is further configured to make a range of the position of the object larger than the input determination frame when the input state is the pressing state.

11. The input system according to claim 1, further comprising:
a compressed air injection device that injects compressed air to the object.

12. An input method for performing a plurality of operations on a stereoscopic image displayed on a three-dimensional space executed by a computer, the input method comprising:
displaying the stereoscopic image including a display surface having a plurality of buttons in the three-dimensional space, the plurality of buttons being associated with the plurality of operations;
detecting an object inputting on the stereoscopic image; and
notifying a user, who performs an inputting operation on the stereoscopic image, of an amount in a depth direction of the display surface, from when an input state by the object is a provisional selection state to when the input state by the object is a determination state,
wherein the amount is an additional numerical value indicating how much the object has to move in the depth direction to set the input state to be the determination state,
wherein the provisional selection state is set when the object is in contact with a button among the plurality of buttons, and
wherein the determination state is set when the object is moved by the amount.

13. The input method according to claim 12, further comprising:
determining an initial position of the object in the three-dimensional space;
determining whether the input state by the object is the provisional selection state based on a positional relationship between the initial position and a display position of the button in the three-dimensional space;
determining whether the input state by the object is the determination state based on a detection result by the detecting; and
performing an operation associated with the button when the input state is the determination state.

14. The input method according to claim 12, further comprising:
determining whether the input state by the object is a pressing state, in which the object continues to press the button among the plurality of buttons; and
designating a display size of the button such that an outer periphery of the button becomes closer to an input determination frame as the amount becomes closer to specific amount for setting the input state to be the determination state,
wherein the input determination frame is designated with a predetermined size surrounding the button.

15. The input method according to claim 12, further comprising:
calculating a size of the object based on a detection result by the detecting; and
designating a display size of the button in the stereoscopic image to be displayed on the three-dimensional space based on the calculated size of the object and a predetermined display size of the button on the three-dimensional space.

16. The input method according to claim 15, wherein the calculated size of the object and the display size of the button on the three-dimensional space are viewed from a predetermined point of view.

17. The input method according to claim 14, further comprising:
designating a color of the button to be displayed within the input determination frame to a color scheme that changes from a center of the button.

18. The input method according to claim 14, further comprising:
changing a display of other buttons adjacent to the button, which is included in the input determination frame, when the input determination frame is displayed.

19. The input method according to claim 14, further comprising:
making a range of the position of the object larger than the input determination frame when the input state is the pressing state.

20. A non-transitory computer readable medium storing a program for performing a plurality of operations on a stereoscopic image displayed on a three-dimensional space, the program causing a computer to execute a process, the process comprising:
displaying the stereoscopic image including a display surface having a plurality of buttons in the three-dimensional space, the plurality of buttons being associated with the plurality of operations;
detecting an object inputting on the stereoscopic image; and
notifying a user, who performs an inputting operation on the stereoscopic image, of an amount in a depth direction of the display surface, from when an input state by the object is a provisional selection state to when the input state by the object is a determination state,
wherein the amount is an additional numerical value indicating how much the object has to move in the depth direction to set the input state to be the determination state,
wherein the provisional selection state is set when the object is in contact with a button among the plurality of buttons, and
wherein the determination state is set when the object is moved by the amount.
